(19) United States
(12) Patent Application Publication
(10) Pub. No.: US 2026/0171745 A1
(43) Pub. Date: Jun. 18, 2026

(54) REDUCING OPTICAL LOSS IN HIGH POWER LASER APPLICATIONS

(71) Applicant: The Regents of the University of California, Oakland, CA (US)

(72) Inventor: Jonathan Richardson, Claremont, CA (US)

(21) Appl. No.: 19/529,866

(22) Filed: Feb. 4, 2026

Related U.S. Application Data
(63) Continuation-in-part of application No. PCT/US2024/040972, filed on Aug. 5, 2024.
(60) Provisional application No. 63/517,783, filed on Aug. 4, 2023.

(51) Int. Cl. H01S 3/04; G02B 7/02; G02B 7/18

(52) U.S. Cl. CPC H01S 3/0401; G02B 7/028; G02B 7/1815

(57) ABSTRACT

An apparatus includes a frame structure forming a circumference around an opening, a receptacle along the circumference, wherein the receptacle is configured to allow a secure placement of an optical element such that electromagnetic waves traveling from the opening impinge upon the optical element; N heating elements attached to the frame structure substantially along entirety of the circumference, where N is a positive integer; and a radiation reflector disposed along the circumference of the frame.

### CROSS-REFERENCE TO RELATED APPLICATION

This patent document is a continuation-in-part and claims priority to International Application No. PCT/US2024/040972, filed on Aug. 5, 2024, which claims priority to U.S. Provisional Application No. 63/517,783, filed Aug. 4, 2023, the disclosure of which is hereby incorporated by reference herein in its entirety.

### STATEMENT REGARDING FEDERALLY SPONSORED RESEARCH

This invention was made with government support under Grant No. 2110348 awarded by the National Science Foundation. The government has certain rights in the invention.

### TECHNICAL FIELD

This patent document relates to systems, devices, and processes for optical processing of laser signals.

### BACKGROUND

Laser sources are used in many industrial and research applications. One beneficial advantage of a laser source is the ability to achieve high precision control over characteristics of the laser source.

### SUMMARY

Methods, apparatus and systems for reducing optical loss in a high power laser application are disclosed.

In one example aspect, an apparatus is disclosed. The apparatus includes a frame structure forming a circumference around an opening, a receptacle along the circumference, wherein the receptacle is configured to allow a secure placement of an optical element such that electromagnetic waves traveling from the opening impinge upon the optical element; N heating elements attached to the frame structure substantially along entirety of the circumference, where N is a positive integer; and a radiation reflector disposed along the circumference of the frame.

In another example aspect, a method of reducing thermal distortion in an optical element is disclosed. The method includes providing a heating apparatus comprising: a frame structure forming a circumference around an opening, wherein a receptacle along the circumference, wherein the receptacle is configured to allow a secure placement of the optical element such that electromagnetic waves traveling from the opening impinge upon the optical element; N heating elements attached to the frame structure substantially along entirety of the circumference, where N is a positive integer; and a radiation reflector disposed along the circumference of the frame; and operating a heat source to supply heating energy to the N heating elements.

In another example aspect, a method of fabrication includes fabricating the apparatus described herein is disclosed.

Those and other aspects and associated implementations and benefits of the disclosed technology are described in greater detail in the drawings, the description and the claims.

### BRIEF DESCRIPTION OF THE DRAWINGS

FIG. 1 shows an example of front surface type irradiator (FROSTI) 3-D rendered concept showing an annular heating element.

FIG. 2 shows an example of design of reflectors and heaters.

FIG. 3 shows examples of prototype reflectors and heaters.

FIG. 4 depicts a cross section of an example ring heater.

FIG. 5 shows parameters for reflector geometry optimization.

FIG. 6 shows an example embodiment of a heater element.

FIG. 7 shows an example embodiment of a reflector.

FIG. 8 shows an example assembly.

FIG. 9 shows an example of mounting.

FIG. 10 shows design details of a ring heater design example.

FIG. 11 shows an example two-dimensional cross section of a ring heater.

FIG. 12 shows an example of optical behavior of a ring heater.

FIG. 13 shows an example of a FROSTI cross-section.

FIG. 14 shows an example of a prototype ring heater.

FIG. 15 is a zoomed rendition of an example of a FROSTI cross-section.

FIG. 16 shows an assembly where FROSTI ring heater may be used.

FIG. 17 shows an example of a slim embodiment of FROSTI in front of a test mass.

FIG. 18 shows a brace configured to act as an earthquake stop on the mount used for mounting FROSTI.

FIG. 19 shows positioning of wiring configured to carry power for the heat elements.

FIG. 20 shows some details of an embodiment of a lens.

FIG. 21 shows graphs for squeezing loss and misrotation examples.

FIG. 22 shows an example of an idealized CO2 profile to correct for substrate thermal lens.

FIG. 23 shows another example of arm power and squeezing loss performances.

FIG. 24 is a graph of an example of required power.

FIG. 25 shows examples of simulation results for 7th order resonance effect.

FIG. 26 shows an example of sensitivity according to one embodiment.

FIG. 27 shows graphs of examples of irradiation and distortion performances.

FIG. 28 shows graphs that depicts various results of FROSTI physical characteristics.

FIG. 29 shows a graph of impact of a compensation scheme.

FIG. 30 shows graphs of actuator power as a function of HR coating.

FIG. 31 shows a schematic diagram of test mass for noise calculation.

FIG. 32 shows an example of displacement spectrum caused by flexure noise.

FIG. 33 is a graph of apparent displacement noise caused by flexure-induced defocus noise.

FIG. 34 pictorially depicts example requirement on FROSTI relative intensity noise.

FIG. 35 is a graph of example of cavity power as a function of round trip phase offset.

FIG. 36 shows graphs of idealized residual distortion.

FIG. 37 shows graphs of performance of IFO.

FIG. 38 shows an example of shifting higher order modulation (HOM).

FIG. 39 shows an example of generation of a target heating profile.

FIG. 40 shows example results for irradiance.

FIG. 41 shows example results for RIN.

FIGS. 42A and 42B show setups for in-vacuum optical testing.

FIG. 43 shows an example of high power operation results.

FIG. 44 shows example graphs for surface deformation performance.

FIG. 45 shows example effect of deformation on irradiation.

FIG. 46 shows example results of irradiance profile of a ring heater.

FIG. 47 shows impact of surface deformation.

FIG. 48 shows results of compensation at 500 mW absorption.

FIG. 49 graphically depicts impact of shifting the SOM resonance.

FIG. 50 depicts examples of consistency of resistance of a heater element.

FIG. 51 are graphs showing results for deformation uniformity.

FIG. 52 shows example results obtained using a test mass.

FIG. 53 shows example of a target heating pattern.

FIG. 54 shows graphs of an example of surface distortions.

FIG. 55 shows graphs of surface deformation and optical path difference (OPD) responses to annular heat segments.

FIG. 56 shows graphs of intensities and deformation examples.

FIG. 57 shows graphs of power requirement and deformation examples.

FIG. 58 shows graphs of impact of CO2 projections.

FIG. 59 shows an irradiance profile to correct for 750 mW absorption.

FIG. 60 shows example results for optical responses.

FIG. 61 shows a graphical example of arm power build up as a function of input power.

FIG. 62 shows strain sensitivity curves under different TCS scenarios for one example embodiment.

FIG. 63 is a flowchart of an example method of a fabrication method.

FIG. 64 shows a test configuration with positioning of FROSTI relative to a test mass.

FIG. 65 shows measured surface temperature map with associated radial average surface temperature.

FIG. 66 shows an FEA-generated optical path difference map compared to a measured OPD map.

FIG. 67 shows the experimental limit placed by the cross-spectral density (CSD) measurement on the RIN of the FROSTI prototype.

FIG. 68 shows the total projected noise due to laser light backscattering.

FIG. 69 shows the measured outgassing rate spectrum of the prototype, in comparison to a reference measurement of the empty chamber indicating the background sensitivity limit.

FIG. 70 shows an embodiment of a FROSTI actuator which superposes radiation from multiple heater rings.

FIG. 71 shows a cross-sectional geometry of a reflector.

FIG. 72 show the relative intensity noise limits of a reflector and dark noise background.

### DETAILED DESCRIPTION

The present document discloses various techniques and apparatus that, in some embodiments, allows for use of a reflector or a lens that reflects, refracts or allows to pass through a high energy laser beam, while at the same time, minimizes or eliminates wavefront distortions caused by uniform or non-uniform heating of the optical element (reflector or lens).

Although various embodiments are disclosed with reference to application of such technology in Laser Interferometry Gravitational-wave Observatory (LIGO) system, it will be appreciated that these techniques can be used for other applications where high precision, high power laser beams are used.

### 1. Initial Discussion

In applications, such as LIGO, a high energy laser beam may be reflected by, and or transmitted through, an optical element such as a mirror, a lens or a splitter. The impinging laser beam may result in thermal expansion and a change in the refractive index of the material of the optical element, causing deformation of the optics and thermal lensing, which may create imbalance in alignment and other properties of the reflected laser beam. Some applications may find this distortion inconvenient. For Example, LIGO attempts to measure spatial variations of sub-atomic dimensions, and distortions introduced by unevenly heated optical elements degrade the sensitivity to these variations. Same undesirable distortions may be observed in other industrial laser applications where a laser beam with power of megawatts such as 1.5 MW or more may be used.

The embodiments described in the present application solve the above-discussed technical problems, among others. For example, external temperature control elements may be used to achieve a very precise temperature control of the optical element, which therefore minimizes the noise/distortions described above. In effect, such a scheme may behave as using black body radiation to achieve the heating. The heating elements may be selected to have extremely low outgassing rate (e.g., a suitable ceramic material such as aluminum nitride). Simulations and results have shown that the disclosed technique enable (1) operation with extremely low noise, high intensity stability of the heating pattern and (2) operate in an ultra-high vacuum (UHV) environment. These two requirements are challenging in practice and cannot be achieved by conventional techniques such as a conventional 10 μm laser as the heating beam source). The unique low-noise properties may also be used for high-precision metrology applications due to the UHV compatibility.

Specifically, in order to mitigate thermally-induced losses arising in the operational system in which the mirror/lens operates (e.g., inside LIGO's high-power arm cavities), there is currently no viable alternative to applying a corrective heating profile directly to the highly-reflective front surface of each test mass optic. However, projecting a corrective heating pattern onto bulk test masses (e.g., LIGO's 40 kg suspended test masses), the most displacement-sensitive optics which couple directly to gravitational waves, poses a major experimental challenge. Intensity fluctuations of the incident heating beams will displace the test masses through a range of optomechanical and photothermal couplings, thus coupling the intensity noise of the wavefront actuators directly to the interferometer's readout signal. The low-noise requirements exclude the use of traditional heating beam sources such as the conventional 10.6 um CO2 lasers. Blackbody radiation is the only source with sufficient intensity stability to meet LIGO's stringent low-noise requirements. Blackbody emitters can radiate with an intensity stability approaching the shot noise limit of a non-thermal source of equivalent power.

As further described in greater details in the various sections in the present document, some embodiments may include an annular ringlike structure that surrounds the optical element (e.g., a reflector or a mirror or a splitter). For high power laser applications, optical elements often have high dimensions (e.g., 10 inches or greater diameter). In such cases, to achieve uniformity of omnidirectional heating around the circumference of the ring, the heating elements may be organized in several independently heated elements, which are controlled by an external heat source to provide a desired thermal profile.

As further described in greater details in the sections in the present document, the heat generated by the heat elements may be radiatively focused towards the optical element by heat reflecting structures such as elliptical or asymmetrical elliptical groove structed around the circumference of the annular frame.

The above ideas are further described using some specific embodiments and structural features and results of testing performed based on a prototype the LIGO application.

### A.1. Introduction to an Embodiment of a Front Surface Type Irradiator (FROSTI)

The Front Surface Type Irradiator (FROSTI) is a new ring heater in the thermal compensation system. FROSTI provides additional actuation capabilities to the existing thermal compensation system (namely barrel ring heater and CO₂ laser). FROSTI provides additional operational advantages including reducing arm cavity loss caused by point absorbers by breaking co-resonance of the 7^{th} and flattening residual deformation in central region of a mirror lens. This document discloses various design principles for designing a ring heater that is suitable for high precision applications such as LIGO and other industrial applications. The embodiments may be generally called “ring heater” with various FROSTI features disclosed throughout the present document providing specific design examples.

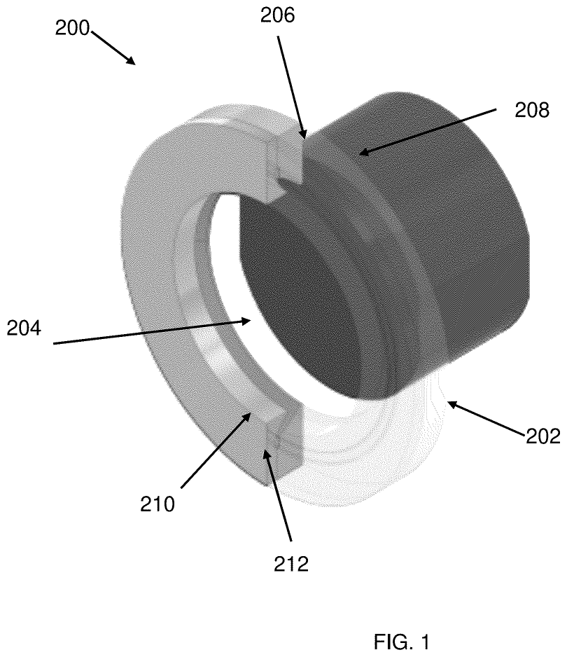

As further disclosed herein, in some embodiments, an apparatus (e.g., apparatus 200, FIG. 1) may include a frame structure (202 forming a circumference around an opening (204). A receptacle (206) may be disposed along the circumference such that the receptacle is configured to allow secure placement of an optical element (208) such that electromagnetic waves traveling from the opening impinge upon the optical element. The apparatus may further include N heating elements (210) attached to the frame structure substantially along the entirety of the circumference. Some examples are N=4 or N=8. The apparatus may further include a radiation reflector (212) that is disposed along the circumference.

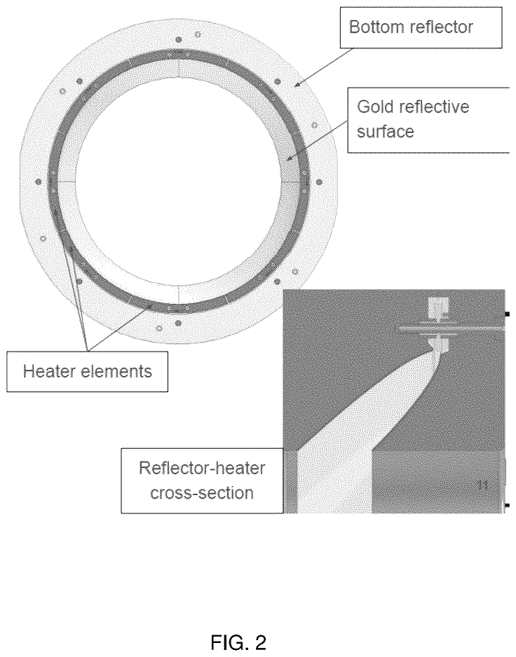

FIG. 2 shows an example of reflectors and heaters. In some embodiments, more than one reflectors may be used. One reflector may be called the bottom reflector and the other may be the top reflector, with the heater ring (or heater elements forming the ring heater) disposed between the two reflectors. In some embodiments, each reflector may be made up of multiple pieces that are attached together. For example, the two halves of reflectors may be machined from aluminum (e.g. 6061 aluminum). The reflective surface may be produced with diamond-turning and may be finished with a gold coating. For example, 340 mm inner diameter and 520 mm outer diameter may be used, which results in approximately 15 to 30 kg mass. In some embodiments, heaters may be built using aluminum nitride (total 8 in number, as an example). Dimension may be 2 mm×15 mm×162 mm, with a 2 mm separation gap between the heaters. There may be a sensor integrated into the heaters to monitor temperature of each element.

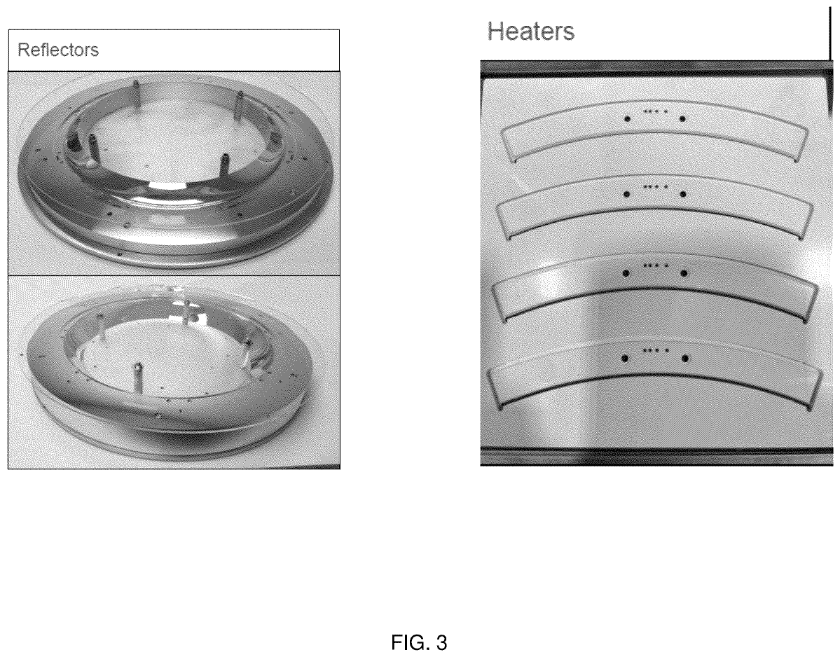

FIG. 3 shows examples of prototypes reflectors and heaters. The heater elements in this embodiment are equisized and have receptacles for receiving heating coil contacts.

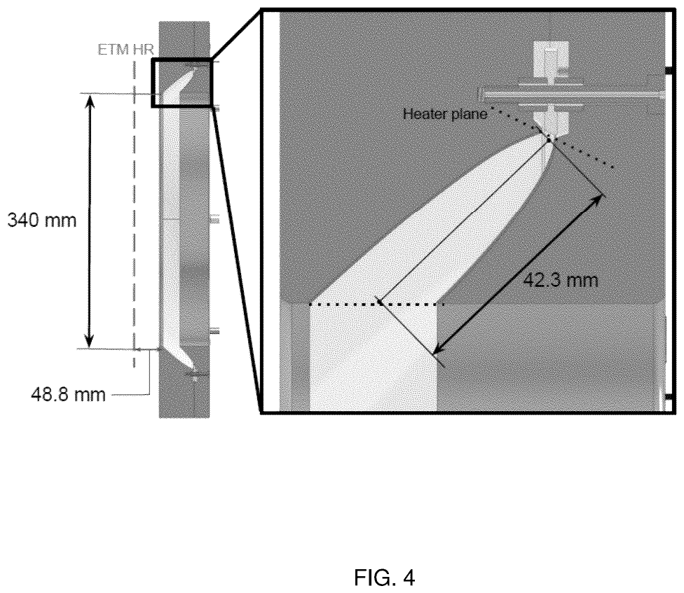

FIG. 4 depicts a cross section of an example ring heater embodiment. This reflector is a truncated asymmetric compound elliptical reflector. One embodiment was constructed using a non imaging edge ray technique for maximum delivery efficiency to a target from a source of finite destination.

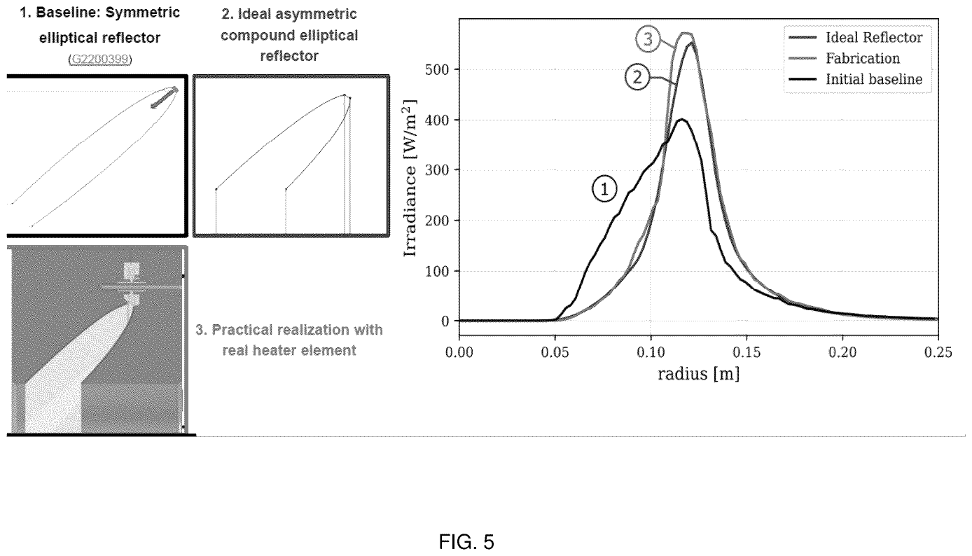

FIG. 5 shows parameters for reflector geometry optimization. A baseline symmetric elliptical reflector is shown in top left drawing. An ideal asymmetric compound elliptical reflector is shown in the top middle drawing. A practical realization with a real heater element is shown in the bottom drawing (see also FIG. 4). The relative irradiance of these three designs as function of radius is shown in the graph on right.

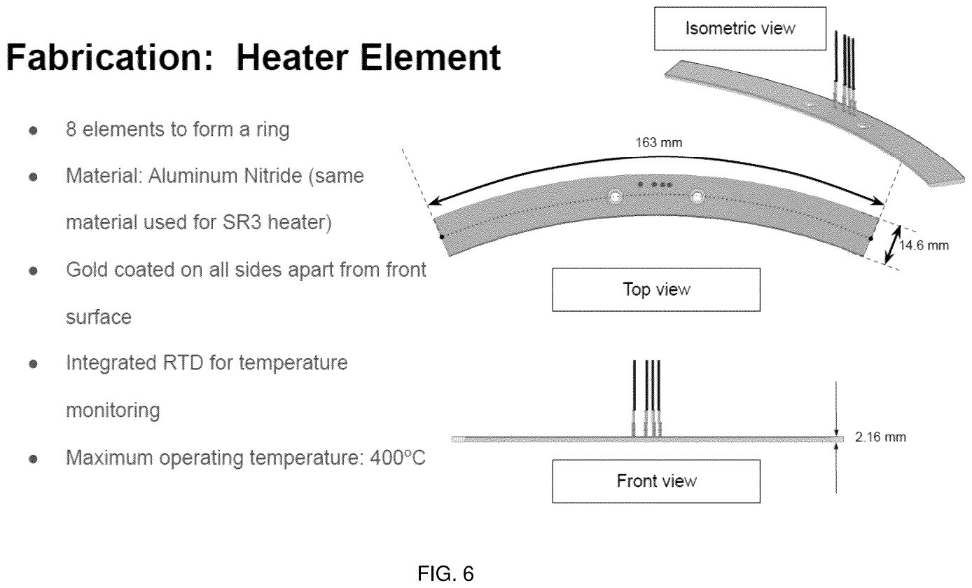

FIG. 6 shows an example embodiment of a heater element. In the depicted embodiment, an isometric view of a heater element is provided. As an example, eight such elements may be used to form the heating ring. Each element may be 163 mm long, with 14.6 mm width. Aluminum nitride is used as the material and is gold coated on all sides apart from the front surface. For applications such as LIGO, a design target may be that the maximum operating temperature is 400 degrees Celsius. Top and front views are also shown with contact points for connectors.

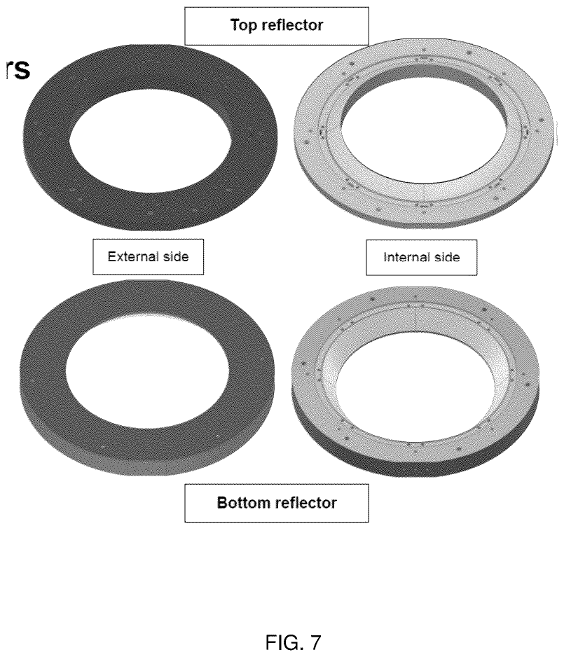

FIG. 7 shows an example embodiment of a reflector. The reflector includes a top reflector portion and a bottom reflector portion. The top reflector is defined by an internal side and an external side. The internal side of the top reflector is configured to form a secure connection with the internal side of the bottom reflector, while leaving a gap for the heater to be fitted within the gap. The bottom reflector is also defined with the internal side and an external side. Each of the top and bottom reflector may be made of Al material. Reflector surface may be produced with diamond turned machining and thin-film gold coating. External facets may be sand blasted to increase emissivity and reduce backscatter. Other coating, such as black nickel, may also be used for fabrication, in order to reduce backscattering. The internal side of the top reflector may include an annular protrusion defining opening that has a diameter that allows it to be fitted within a corresponding annular receptacle of the bottom reflector that is tapered along the annular surface to allow placement of the top reflector into the bottom reflector.

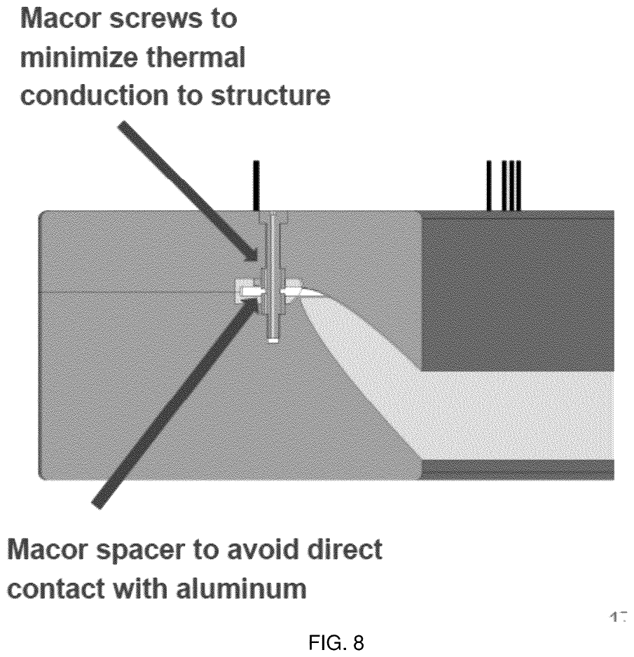

FIG. 8 shows an example assembly where the heater/reflector are installed. Macor screws may be used to minimize thermal conduction to the structure with spacers used to avoid direct contact with aluminum.

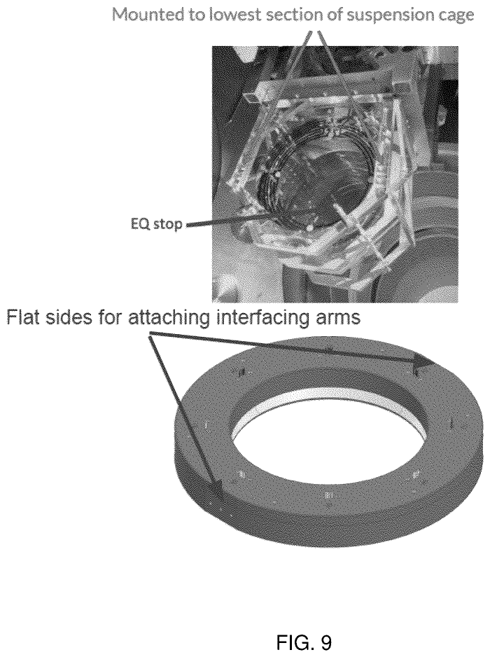

FIG. 9 shows an example of mounting used for mounting the assembly of heater/reflectors. The mounting may be at the bottom of a quad suspension cage. In a typical operational scenario, the weight of the heating element may be approximately 42 to 45 lbs, which may be reduced to around 20 lbs with additional design techniques. In the lower drawing, a flat side in the ring is shown for facilitating attachment to the interfacing arms.

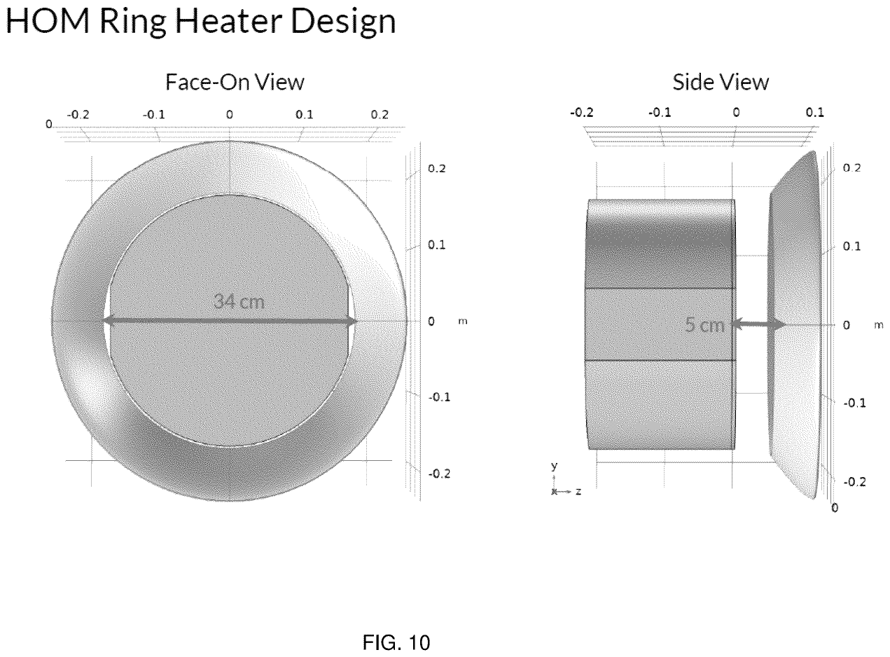

FIG. 10 shows design details of a ring heater design example. This embodiment shows a ring heater having 34 cm inner diameter. Here, the tapering annular opening defined by the bottom reflector is visible in the side view.

FIG. 11 shows an example two-dimensional cross section of a ring heater in which a Lambertian heater element having a strip shape is used. The heater element is placed inside a cavity having an asymmetric elliptical shape allowing uniform heat radiation, as disclosed in the present document.

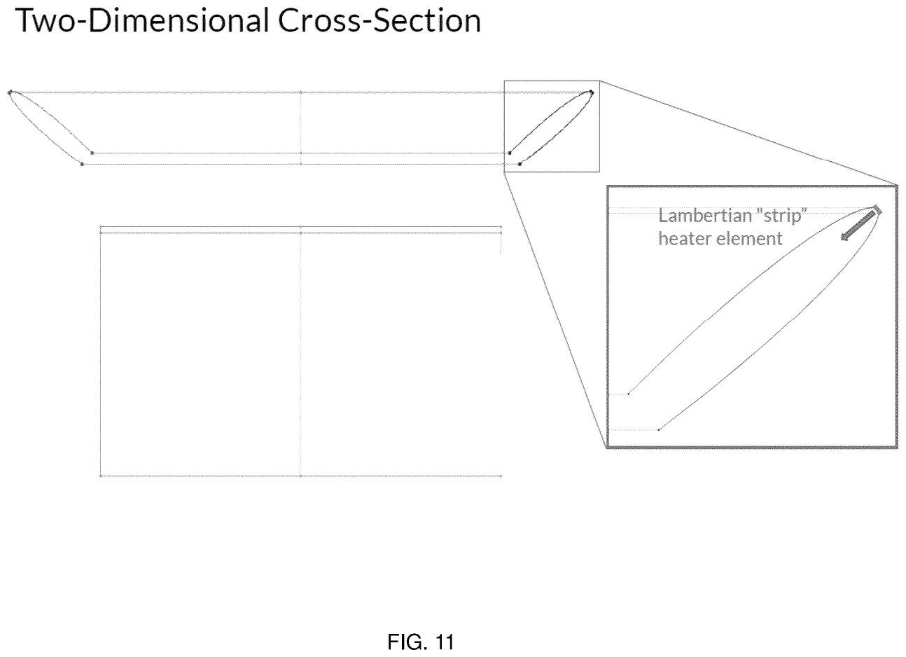

FIG. 12 (further described in detail later on) shows an example of optical behavior of a ring heater. As depicted, a test mass surface may be on the left, with the heater element on the right. Reflector surfaces may be arranged such that the optical signals are captured without loss using the design principle of an elliptical concentrator.

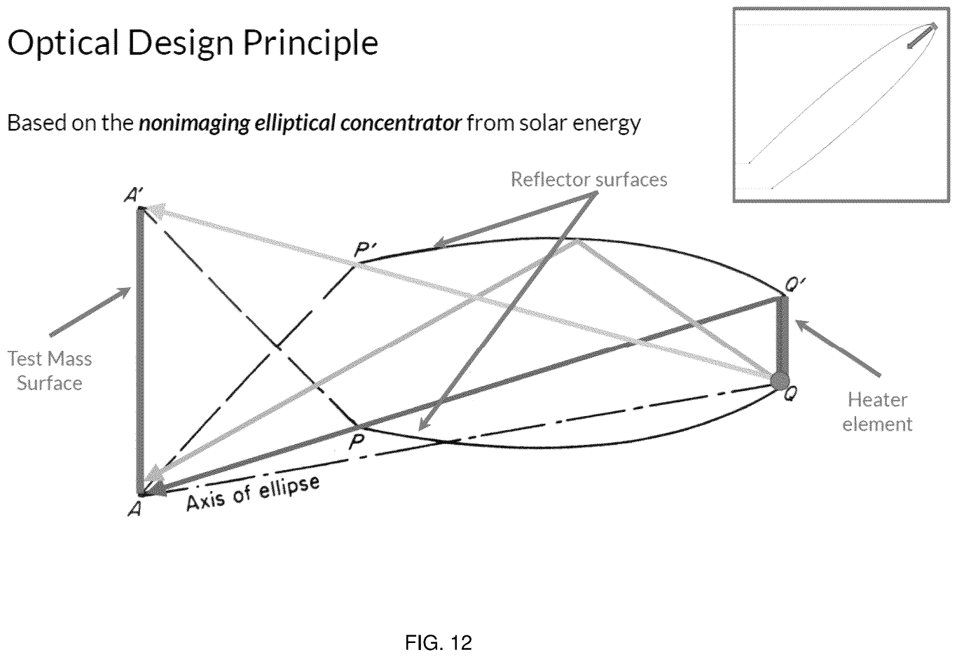

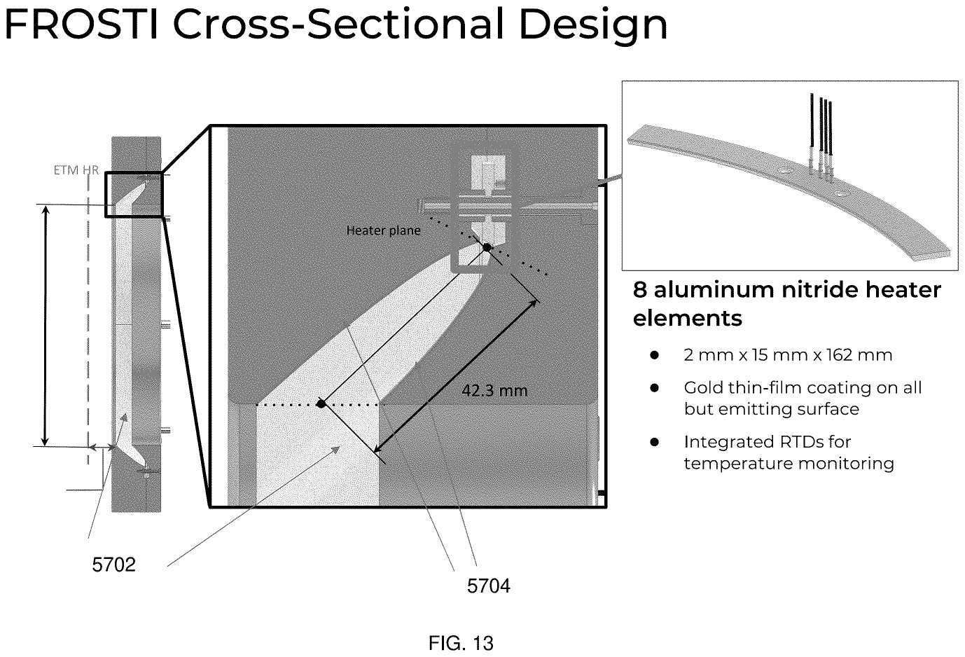

FIG. 13 shows an example of a FROSTI cross-section. It can be seen from the left view that a gap is formed when the bottom reflector (leftmost part of the figure) receives the top reflector surface (shown to the right of the heating cavity 5702. At the seam where the bottom and top reflectors touch (as shown in the exploded view in the middle), a heater element may be placed, with external connectivity from through holes for electrical connections to receive power and for temperature sensors (right inset). The coupling of bottom and top reflectors defines the gap, which causes heat to be propagated due to the asymmetric elliptical reflector walls (5704) such that the heater plane is generally at an almost perpendicular angle to the direction in which the gap is positioned towards the opening of the ring heater.

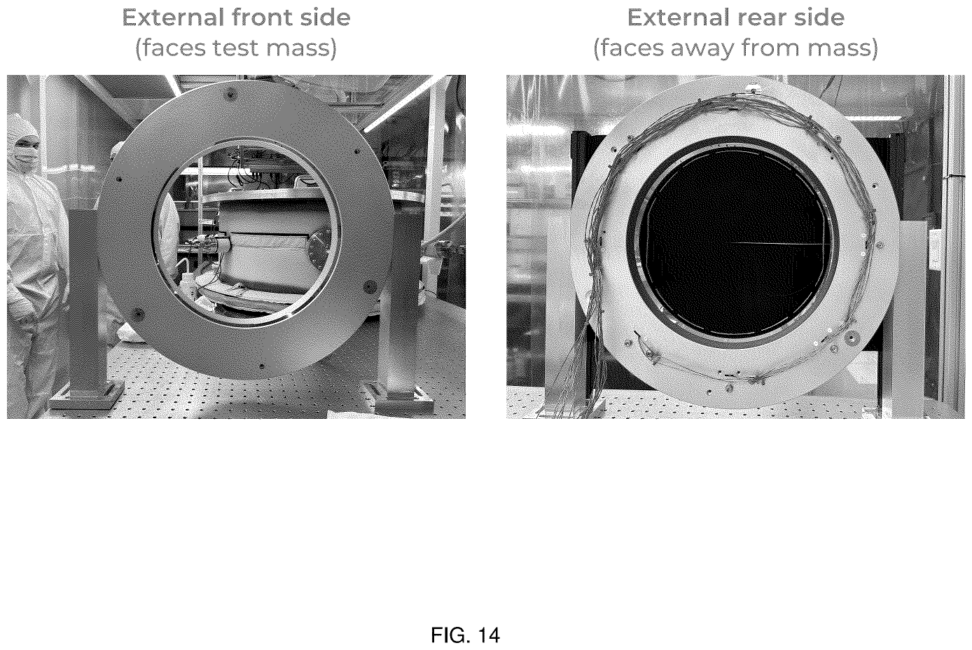

FIG. 14 shows an example of a prototype ring heater in a front and back view. From the front side, the reflector surface around the opening in the middle is partly visible. From the back view, the electrical wiring for heating power and sensors is visible.

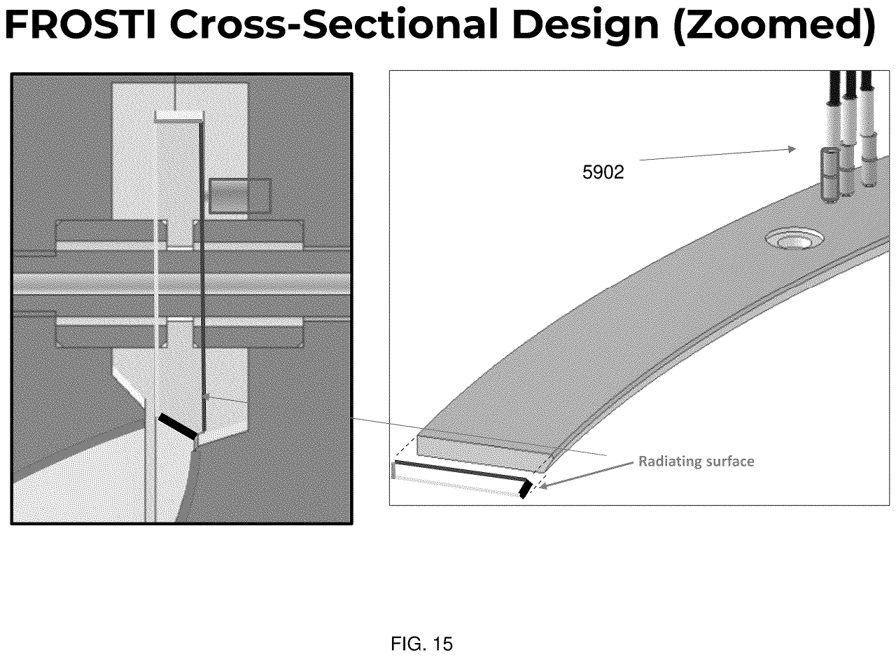

FIG. 15 is a zoomed rendition of an example of a FROSTI cross-section. The left figure shows a side view, and the right figure shows a top view of the heater/reflector arrangement showing the radiating surface and heater/sensor connections 5902.

FIG. 16 shows an assembly where FROSTI ring heater may be used in an application such as the LIGO application. Here, the entire ring heater assembly 6000 is placed within a telescope system showing les (to the left) and other mechanical portion such as gyros to the right.

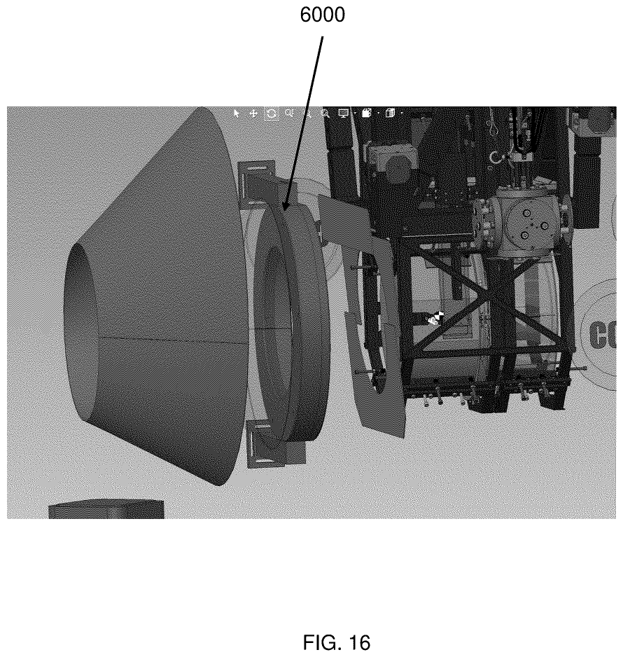

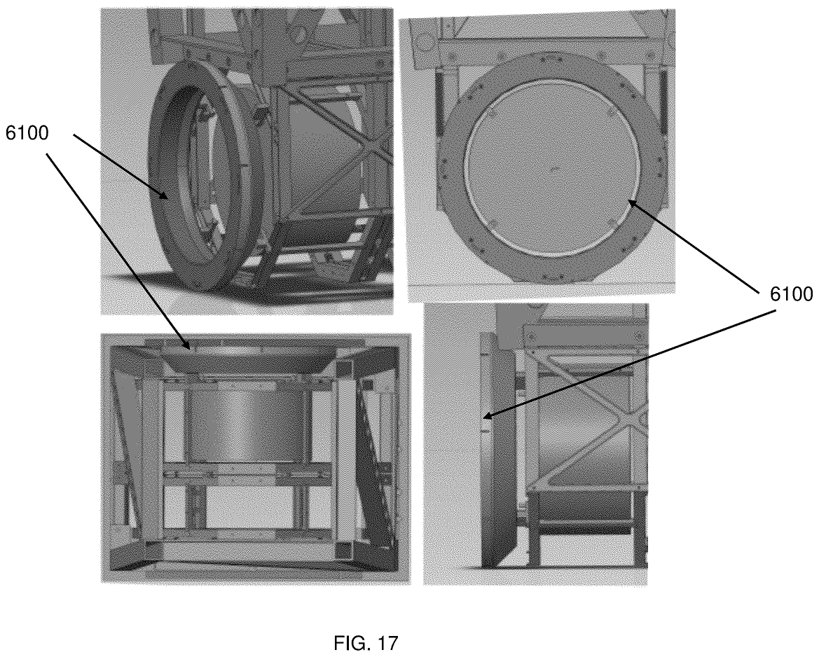

FIG. 17 shows an example of a slim embodiment of FROSTI (6100) in front of a test mass. Left view, front view, side view and elevation view are shown respectively, in a clockwise direction.

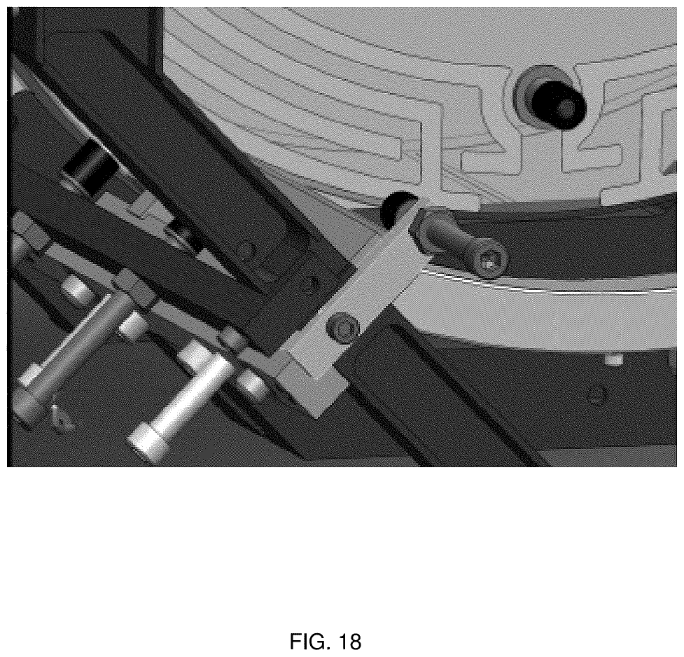

FIG. 18 shows a brace configured to act as an earthquake stop on the mount used for mounting FROSTI.

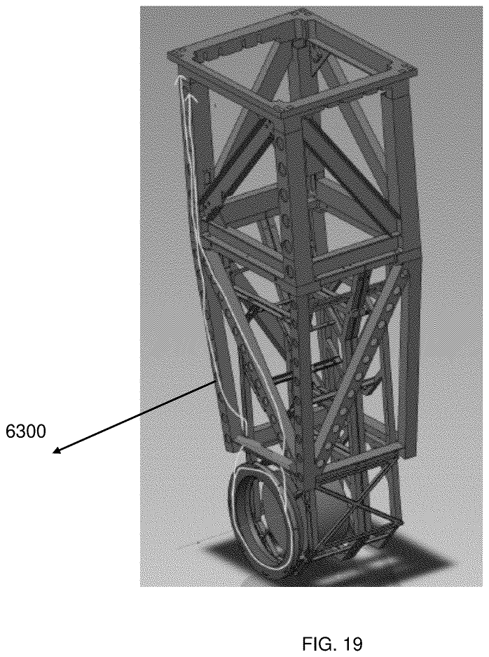

FIG. 19 shows positioning of wiring configured to carry power for the heat elements. The wiring is disposed to fit along the circular surface of the ring heater and then be pulled along an existing support arm of a telescope to the source of electric power or a sensor readout computer.

In the sections that follow, general design principles and other practical considerations used for building various embodiments are disclosed. For example, some of the practical considerations and design goals include designing the ring heater such that the lens or mirror experiences uniform power absorption, causing least possible surface deformation, which therefore maintains the fidelity of captured images. Another design consideration includes being able to mitigate the effect of lensing caused to due heating of atmospheric carbon dioxide CO2. Another goal of the design is the mitigate or eliminate the distortions causes by point absorbers, e.g., thermoelastic deformations created by nanoscale level imperfections in the surface of reflector and other surfaces. Yet another design goal is to build a system where heater elements are heated in a manner that eliminates or suppresses noise caused to due to fluctuations in the applied heat, which then may result in changes in the thermos-refractive index of the lens/mirror material.

The modeling, simulation and actual prototype results presented in this document demonstrate that the disclosed techniques may be used to build ring heaters for high precision imaging and other applications by eliminating or mitigating thermal distortions in the surface of the lens or mirror used to capture images.

### A.2. General Description of FROSTI Embodiments

FROSTI consists of a ceramic annular heater enclosed within a reflector frame made from aluminum. The interior of the aluminum frame is made from diamond-turning and polished to less than 10 nm_{RMS} (e.g. 5 nm_{RM}). This surface is also thin-film gold-coated. The ring heater will be placed with its opening aperture facing towards the test mass to project an annular heating pattern onto the test mass highly reflective (HR) surface. FIGS. 1-19 show various embodiments and concepts of FROSTI.

FIG. 1 shows an example of FROSTI 3-D rendered concept showing an annular heating element enclosed inside a reflector to project infrared (IR) irradiance onto the test mass HR surface.

### A.2.1 Examples of FROSTI Functions

FROSTI functions encompass two main goals: reducing arm cavity round trip loss caused by point absorbers on test masses and correction of deformation caused by uniform coating absorption at high power operation.

### A.2.1.1 Uniform Absorption Correction Examples

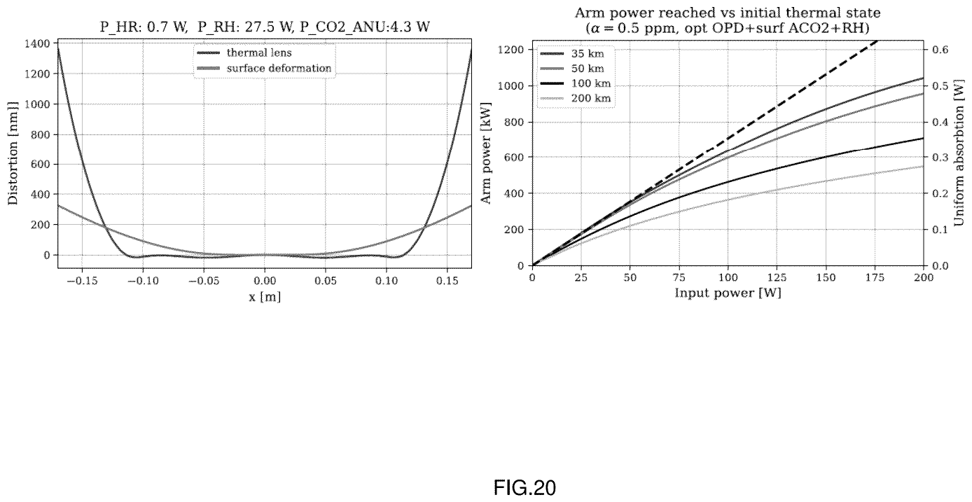

In some embodiments, arm cavity power of up to 1.5 MW may be used. Given existing HR coating absorption is 0.5 ppm to 0.3 ppm for the end test mass (ETM), the absorption can be as high as 750 mW. Such absorption induces mirror surface deformation and substrate thermal lens. The existing thermal compensation system (TCS) system, which consists of CO₂ heating of the compensation plate (CP) and barrel ring heater (RH) would not be sufficient to correct optical distortion from coating absorption. FIG. 20 shows the arm power builder assuming the optimal compensation with the existing TCS. The existing scheme actuates on the test mass surface with RH and radiative coupling of heat flow from CP under CO2 heating; both of which causes the test mass surface more concave (positive). At high absorption power, a large amount of heat from RH and CO2 is required to compensate for the thermal lens, resulting in large change in mirror radius of curvature and effectively reduces the power recycling gain (PRG). This results in the deviation of arm power from the ideal line in FIG. 20. Overall, depending on the initial cold state lens, the maximum arm power buildup can be well below 1 MW.

FIG. 20 shows Left: optimal cross-section profiles of compensated substrate lens and surface distortion at 0.7 W input test mass (ITM) coating absorption. Right: Arm power build-up at different initial cold state lens status as functions of ITM coating absorption (ETM absorption is assumed to be 3/5 of ITM's). Compensation scheme is assumed to include the existing annular CO2 profile and the barrel ring heaters.

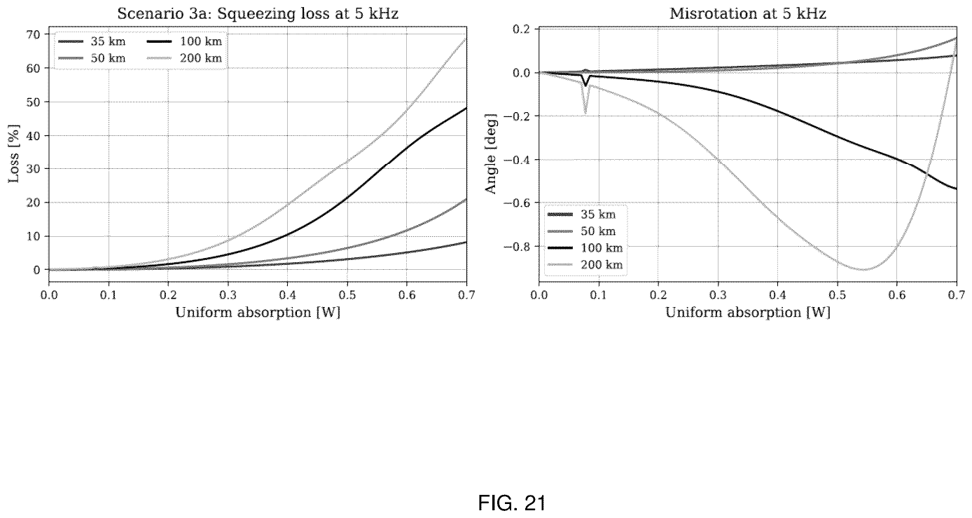

The existing TCS is also only designed to correct for the thermal lens OPD weighted by the interferometer (IFO) beamsize. As seen in FIG. 20 (left), the substrate distortion is only flattened out to around 100 mm radius, beyond which there is a steep rise in the residual OPD. Such distortion results in excess of loss of squeezed fields at frequencies greater than the signal recycling cavity (SRC-)Arm cavity pole (approximately 400 Hz) due to the lack of phase conjugation that would otherwise suppress mode-mismatch loss. FIG. 21 shows the squeezing loss and misrotation of squeezing quadrature at 5 kHz (squeezing loss at 1 KHz is approximately half of that at 5 kHz).

FIG. 21 shows relationship between squeezing loss (left) and misrotation (right) of the squeezed field quadrature as functions of absorbed power after corrected by existing TCS at different initial cold state lenses.

While the impact on misrotation is small, the residual thermal lens causes a significant amount of loss in effective squeezing. Depending on the initial state, this can be as high as 60% or as low as 10% at 0.7 W absorption, which is still too high for our target (approx. 1-2%). The thermal lens correction thus needs significant improvement to reduce this loss.

### “Idealized” Annular CO2 Profile.

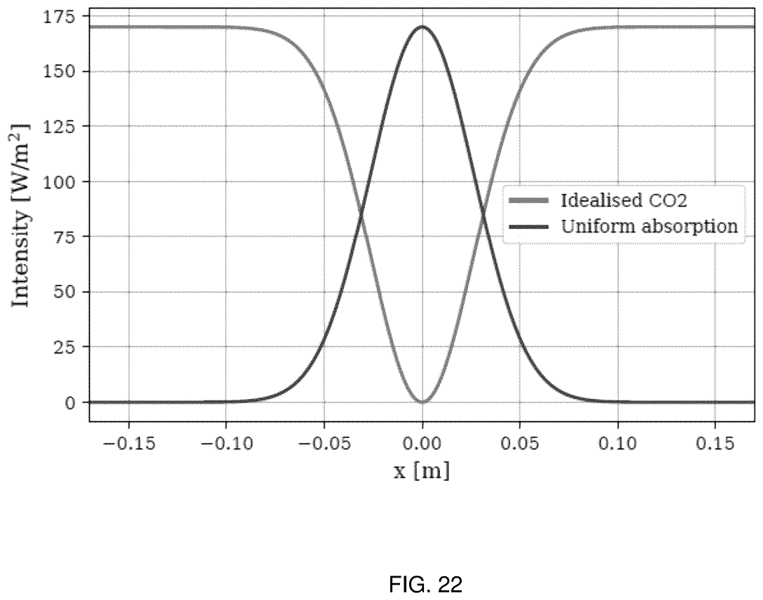

An option to improve substrate lens correction is to use an “idealized” annular CO2 correction profile. This profile complements the absorption profile, see FIG. 22.

FIG. 22 shows an example of an idealized CO2 profile to correct for substrate thermal lens.

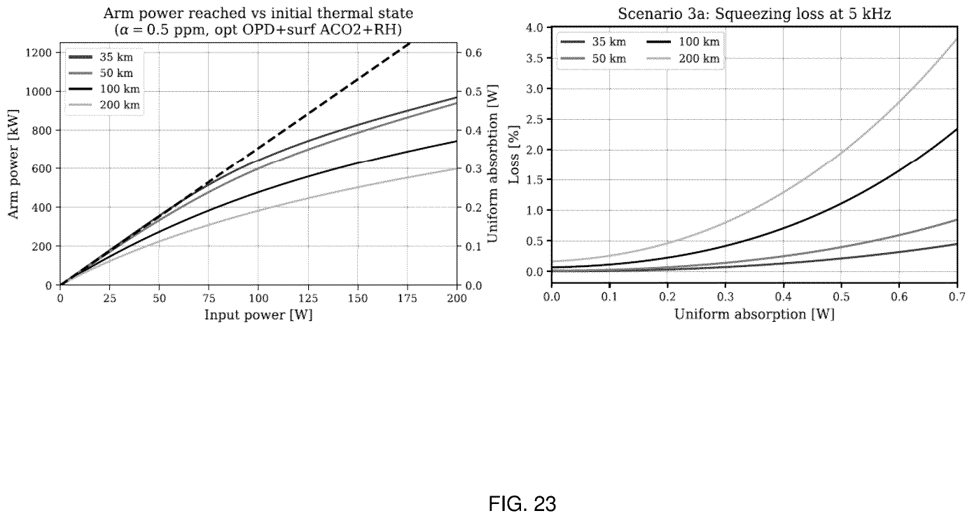

The idealized CO2 intensity above can correct the thermal lens and improve the squeezing loss significantly, as shown in the right plot of FIG. 23. In the best case scenario, the loss is reduced to below 1%, budget can be as high as 4%, depending on the cold state lens. However, the left plot shows the arm power remains below 1 MW at 200 W input laser power. This is mainly due to ITM surface deformation uncorrected with the ideal CO2.

FIG. 23 shows arm power and squeezing loss performance using TCS with the “idealized” CO2 intensity shown in FIG. 21.

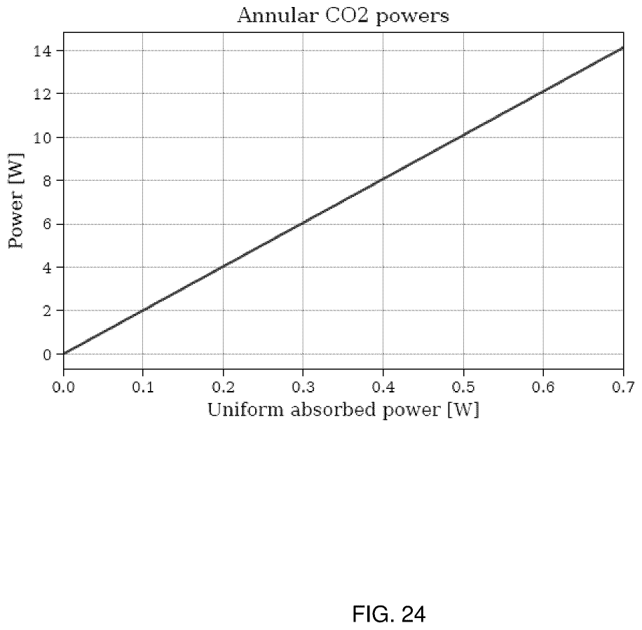

FIG. 24 shows the power required to be delivered to CP as a function of ITM surface absorption using the “idealized” profile. At 0.7 W absorption, the amount of power required is 14 W. Using the current CO2 projection system efficiency, which is approximately 15%, the required power output by the CO2 laser is around 100 W. This figure will most likely increase with a larger optics. Using the CO2 laser alone is therefore not practical option.

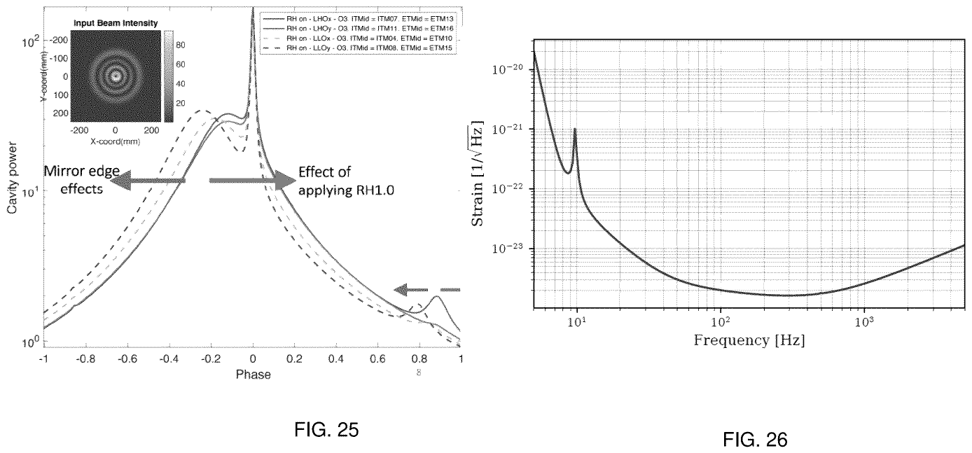

FIG. 25 shows required delivered CO2 laser power to CP to compensate for uniform absorption, using idealized annular CO2 profile.

These highlight the three main functions of the new FROSTI actuator:
Minimize substrate thermal lens across full aperture to reduce higher-order-mode loss of squeezed fields
Minimize surface deformation across full aperture to maintain high power gain in PRC and arm cavities
Offload the power required from the CO2 projection system

### A.2.1.2 Point Absorbers Loss Reduction

Presence of highly absorbing points on the surface of test masses results in nanometer-scale thermo-elastic deformation of the test mass surface. This deformation caused arm cavity beam incident on the mirror surface scattered in high-order-modes. This coupling into high order modes (HOMs) can be described by coupling coefficients aₘₙ, in which m,n denote the Hermite-Gaussian mode indices. The magnitudes of these coupling coefficients are only dependent on the geometry of the deformation. However, these higher modes also see gain factors g_{m,n} due to the cavity response. This resonant gain is dependent on the round-trip phase accumulation of that mode. In particular, the 7th order mode resonance is close to that of the fundamental mode (FIG. 25), thus resulting in an enhancement in loss. The overall loss Aₘₙ to a mode is therefore given by Aₘₙ=aₘₙgₘₙ

FIG. 25 shows results of a simulation of arm cavity scan showing the 7th order mode resonance close to that of the fundamental model and the effect of the existing barrel ring heater.

The existing barrel ring heater pushes the resonance of the 7^{th}-order mode towards the fundamental mode resonance and thus further increases scattering loss. It also produces a purely quadratic deformation, therefore affecting all modes equally. The goal of FROSTI is to induce an edge roll-off effect, which shifts the 7^{th}-order mode resonance away from the fundamental mode, thereby reducing loss through decreasing gₘₙ.

### A.2.2 Assumptions and Dependencies

### A.2.2.1 Core Optics Parameters

Reduction of HOM loss from point absorbers is to be achieved with inducing edge effect on the optics. The geometry of test mass, and especially the surface profile of the test mass is crucial in modelling the impact of FROSTI on the arm cavity mode structure.

### A.2.2.2 Material Parameters

The amount of thermal distortion induced by FROSTI is dependent on materials properties of fused silica, in particular low OH fused silica Heraeus Suprasil 3001, which is used for the test mass. The following materials are assumed in modelling of FROSTI performance as well as noise coupling:

TABLE 1
Materials properties of fused silica

| Parameter | Symbol | Value | |
|---|---|---|---|
| Young's modulus | E | 7.0 | GPa |
| Poisson ration | ν | 0.17 | |
| Thermal expansion coefficient | α | 5.5□10⁻⁶ K⁻¹ | |
| Thermal conductivity | κ | 1.38 | Wm⁻¹ K⁻¹ |
| Density | ρ | 2202 | kgm⁻³ |
| Specific heat | Cₚ | 772 | Jkg⁻¹ K⁻¹ |

| | | |
|---|---|---|
| Thermo-refractive coefficient | dndT | 8.6□10⁻⁶ K⁻¹ |
| Emissivity | ò | 0.91 |

### A.2.2.3 Interferometer Design Parameter

FROSTI design consideration assumes IFO configuration of one embodiment. FIG. 26 shows the sensitivity, which will be used to impose noise requirement on FROSTI.

### A.3.1 General Constraints

### A.4. Design Considerations

This section describes the design of FROSTI under consideration for the heating element and reflector design of FROSTI.

### A.4.1. Actuator Consideration

FROSTI actuates on the ITM HR surface, thus a coherent heating source such as CO2 laser is too noisy. FROSTI employs infra-red radiative ceramic heater made from aluminum nitride. Ceramic heaters have been previously used to actuate on the curvature of SR3 mirror.

### A.5. Functional and Performance Requirements

### A.5.1. Overall Performance Targets

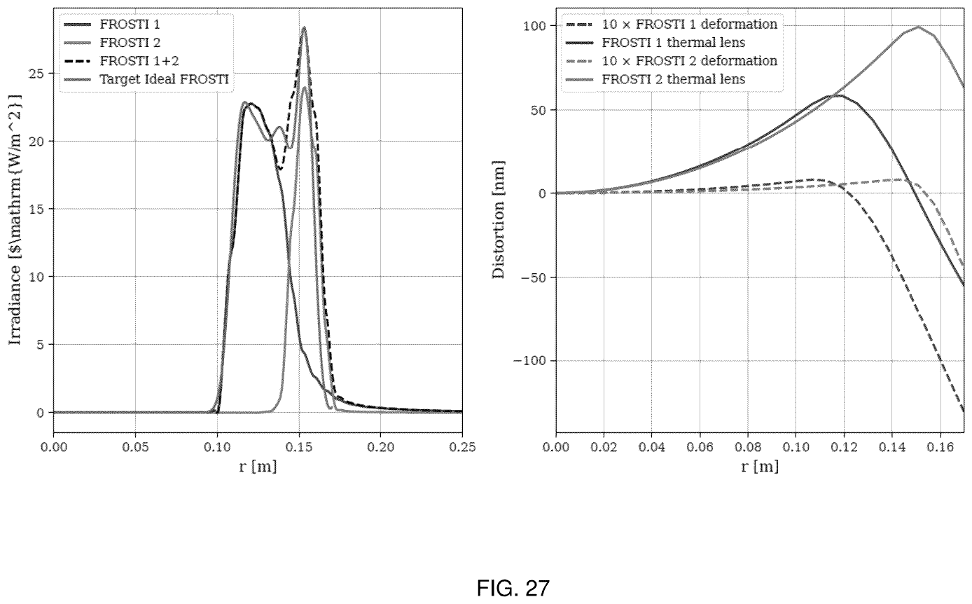

As briefly discussed in section A.2.1, FROSTI needs to correct for surface deformation of the ITM and ETM, as well as the substrate thermal lens. Under the assumption that there is no major upgrade of other TCS actuators (same CO2-CP and RH correction), FROSTI must be able to generate a particular heating profile in order to correct for both substrate lensing and surface deformation. The optimized profile is explained in detail in T2300029. FIG. 27 shows the required irradiance pattern from the FROSTI.

FIG. 27 shows: Left: Optimized FROSTI profile (green) to correct for ITM substrate thermal lens and surface deformation. This profile can be constructed using two irradiance profile that are more pragmatic for realization (blue and red traces). The optical responses, including thermal lens and surface deformation from 1 W of each of these profiles are shown in the right plot.

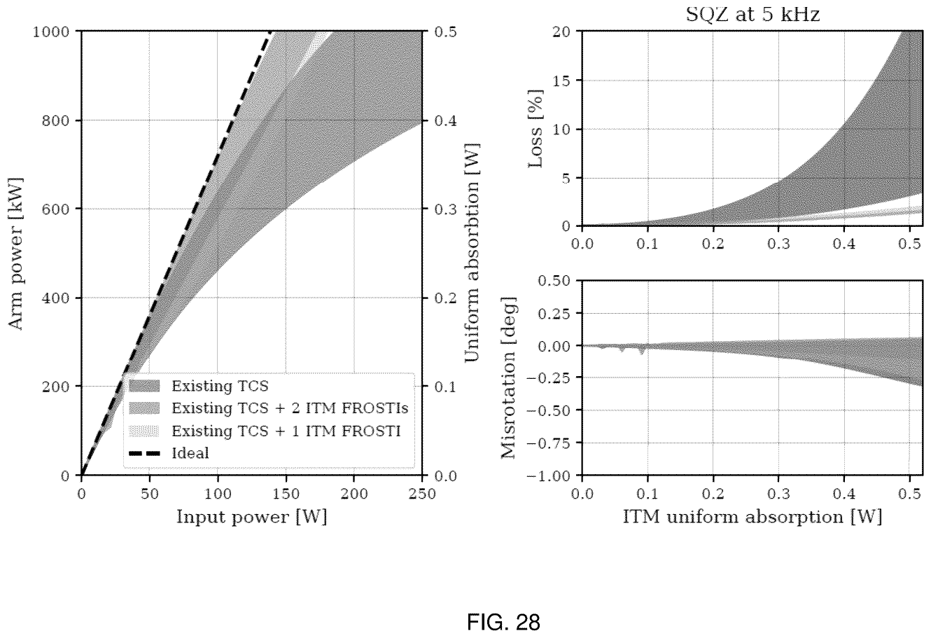

The optimized FROSTI irradiance profile can be realized by generating two separate profiles (shown in blue and red in the left plot of FIG. 27). The optical responses including ITM substrate lens and deformation are used for studying arm power build-up and frequency-dependent squeezing loss to evaluate their performance. FIG. 28 benchmarks these figure of merits for three scenarios: using existing TCS, existing TCS+2 FROSTI on ITM, 1 FROSTI on ETM. The key takeaways from these plots are:

FIG. 28 shows: Left: Arm power buildup as a function of the injected power under different TCS scenarios. The shaded regions correspond to the impact of uncertainty in the initial static lens. Right: Squeezing performance at high frequency, including squeezing loss and misrotation as functions of ITM HR uniform absorption.
Addition of FROSTI reduce the uncertainty in the IFO performance due to uncertainty of the initial cold lens
FROSTI improves the likelihood of reaching the target arm power with 125 W injected laser power
FROSTI allows better correction of the ITM substrate thermal lens, thereby reduce squeezing loss at high frequency
The difference in improvement between using a single FROSTI and two FROSTI on ITM is not significant

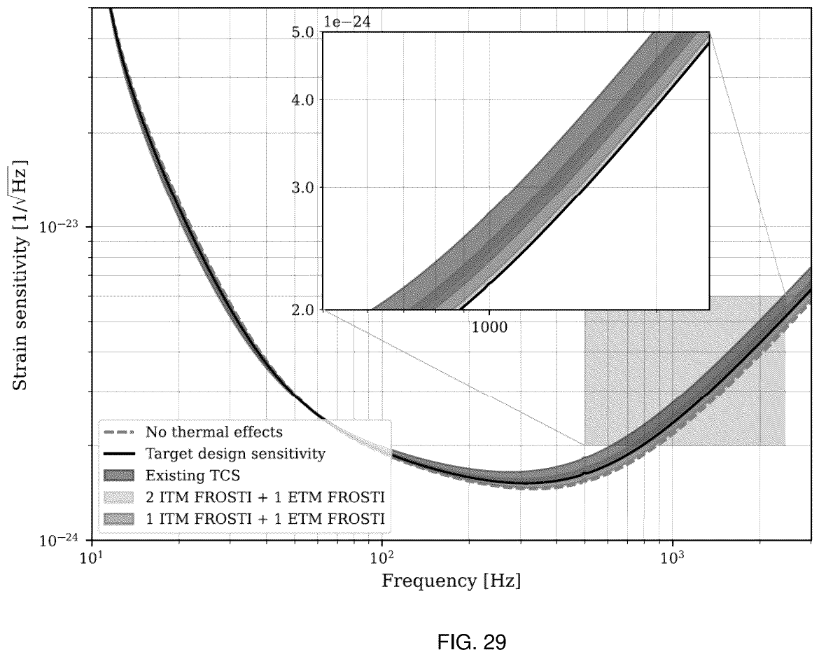

Using the arm power achieved and the residual thermal lens HOMs scattering loss, we can project the improvement in differential arm length of the interferometer (DARM) sensitivity budget, which is shown in FIG. 29 for 125 W injected laser power. Inclusion of FROSTI, which addresses the power build-up problem, makes a large impact in the high frequency region (>100 Hz). Here we can again see that the use of a single FROSTI on the ITM is sufficient to get us to design sensitivity.

FIG. 29 depicts projected impacts of compensation scheme using realistic FROSTIs on DARM sensitivity budget of the system.

### A.5.1.1. Actuators Powers

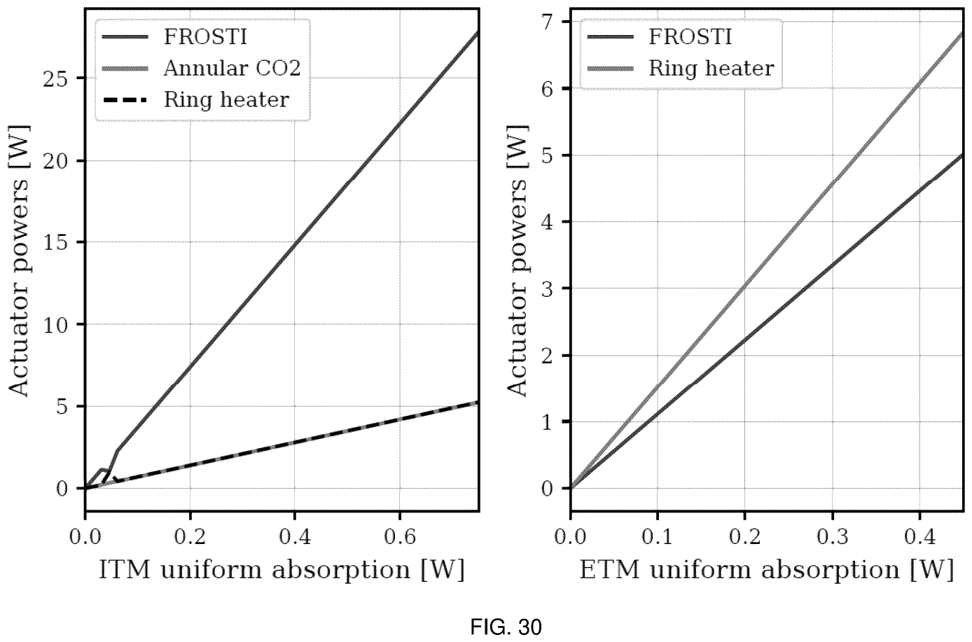

FIG. 30 shows the optimized powers required from each actuator (FROSTI, Annular CO2 and Ring Heater) the HR uniformly absorbed powers increase, assuming one FROSTI on each test mass, which generates the inner-radial-position pattern shown in FIG. 10.

FIG. 30 depicts optimized actuator powers as functions of HR coating uniform absorption for ITM (left) and ETM (right).

From FIG. 30, the maximum power required from FROSTI to correct for thermal distortion at 750 kW arm power are 14 W for ITM and 2.5 W for ETM (assuming 0.5 ppm and 0.3 ppm absorption respectively). Thus, FROSTI should be designed to provide a minimum of 15 W directly on the test mass. Also from these plots, the maximum power that the RH should be able to provide is 3.5 W, which is readily achieved with the existing RH. The maximum annular CO2 power needed to deliver to the compensation plate is about 2.5 W. Given the approximately 15% power delivery efficacy of the existing CO2 projection system and the 50 W CO2 laser source, this level of annular CO2 power is achievable.

### A.5.2. Example Design Consideration for Mitigation of Noise

There are several pathways through which noise FROSTI can injects noise into the IFO. This includes noises due fluctuation in heat injected by FROSTI, backscattered noise, acoustic and electromagnetic noise from FROSTI components. In this section, details on requirements for mitigating noise ingress from these noise sources will be discussed.

Noise from Heat Injection Fluctuation

FROSTI induces phase changes in optical field by injecting heat. Thus, any rapid fluctuations in heat source can inject phase noise into the IFO. The coupling mechanisms include local thermal expansion, thermo-refractive index change, thermal flexure and radiation pressure. The following subsections will detail with each coupling separately. These couplings are computed following previous TCS noise calculations. Assumed parameters for materials used in noise computation are given in Table 1.

Radiation pressure noise. Fluctuation in intensity of the projected heat results in fluctuation in radiation pressure, which causes the test mass to recoil. The displacement noise resulted from this is given by:

$$Δ {z}_{R P , recoil} = \frac{P}{c {{m}_{T M} ( 2 π f )}^{2}} R I N = 3.17 \times 1 {0}^{- 13} [ m ] {( \frac{10 [ Hz ]}{f} )}^{2} ( \frac{P}{15 [ W ]} ) RIN \qquad ( 1 )$$

The effect of recoil due to RPN is non-negligible at low frequencies but fall off quickly due to 1/f² behavior.

Another effect is RPN is changing the optical depth of the ITM by compressing it. This effect is independent of frequency:

$$Δ {z}_{RP , compress} = \frac{π}{2 F} ( n - 1 ) \frac{{h}_{TM}}{E A c} RIN = RIN \times 1.6 \times 1 {0}^{- 22} [ m / W ] \qquad ( 2 )$$

Thermoelastic noise. Fluctuation in optics temperature caused it to expand, result in two main effects:
Changing Fabry-Perot cavity length
Changing ITM optical thickness when FROSTI is applied to ITM, thus fluctuation in PRC cavity length

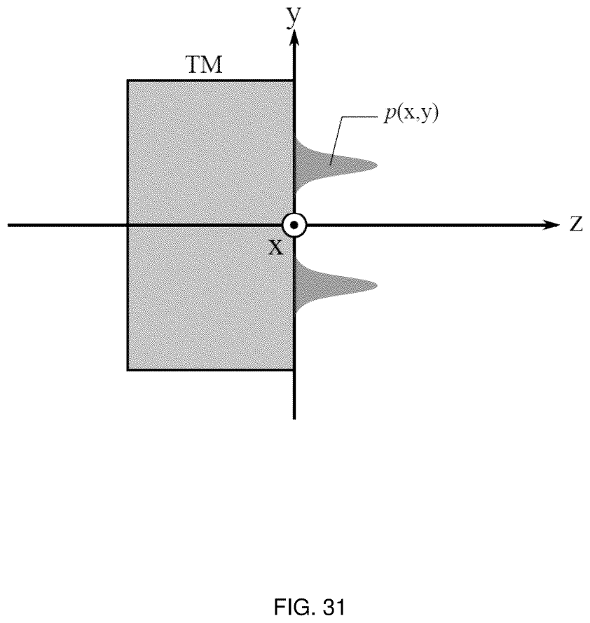

Consider the test mass in a Cartesian coordinate system (x,y,z) with the optical axis along the z-axis, as shown in FIG. 31. The heat pattern incident on the optics is given by p(x,y) and it is oscillating at frequency f, inducing fluctuation in the optics temperature profile T(x,y,z) The local temperature of heating region is governed by the heat diffusion equation:

$$\frac{dT}{dt} = \frac{κ}{{C}_{p} ρ} Δ T \qquad ( 3 )$$

FIG. 31 is a schematic diagram of test mass for noise calculation.

Taking the Laplace transform and solve the spatial temperature distribution gives us an expression for penetration depth dₜₕ:

$${d}_{t h} = \sqrt{\frac{κ}{2 π {fC}_{p} ρ}} = 36 [ μm ] \sqrt{\frac{100 [ Hz ]}{f}} \qquad ( 4 )$$

which is significantly smaller than the scale of variation in the irradiance pattern. Thus, heat flow is essentially one dimensional, along the optical axis in this thin layer. The energy density in this thin layer is given by E(x,y)=ρCᵥ∫T(x, y,z)dz. Since the energy is related to the heating by

$$\frac{d E ( x , y )}{d t} = p ( x , y ) ,$$

we have:

$$p ( x , y ) = 2 π if ρ {C}_{p} \int T ( x , y , z ) d z \qquad ( 5 )$$

The heated surface layer thermoelastically expands by an amount (1+v)α∫T(x,y,z) This goes into changing the effective length of the arm cavity. The displacement contributed by this effect is thus:

$$Δ z ( x , y ) = ( 1 + v ) α \frac{p ( x , y )}{2 π i f ρ {C}_{v}} \qquad ( 6 )$$

The thermal expansion also causes change in optical path length through the ITM (if FROSTIs are considered for ITM):

$$Δ z ( x , y ) = ( n - 1 ) ( 1 + v ) α \frac{p ( x , y )}{2 π i f ρ {C}_{v}} \qquad ( 7 )$$

Since this effect is outside of the arm cavity, it is reduced by a factor of

$$\frac{π}{2 F} ,$$

where F is the arm cavity finesse, which is 450 for some typical embodiments.

To get the average displacement noise seen by the IFO, Δz(x, y) are averaged over the main laser beam:

$$Δ z = \frac{\int I ( x , y , w ) Δ z ( x , y ) dxdy}{\int I ( x , y , w ) d x d y} \qquad ( 8 )$$

where W is the beam radius at the optics (nominally 53 mm on ITM and 62 mm on ETM). Thus, the average displacement is dependent on the overlap integral between the IFO beam and FROSTI heating profile. This overlap quantity can be computed numerically for the inner FROSTI profile shown in FIG. 26. Assuming the maximum 15 W delivery, the overlap integrals are 0.12 W/m² and 0.99 W/m² for ITM and ETM respectively. We'll pick 0.99 W/m² here to impose a more stringent requirement. The total displacement noise due to thermal elastic coupling is:

$$Δ {z}_{T E} = ( 1 + v ) ( 1 - \frac{π}{2 F} ) α \frac{0.99 [ W / {m}^{2} ]}{2 π i f ρ {C}_{v}} RIN \qquad ( 9 )$$

Thermorefractive noise. The refractive index of the thin surface also changes with fluctuation in temperature, giving rise to additional thermo-refractive change Δz_{TR}. This effect occurs outside the arm cavity and thus is reduced by a factor of π/2F:

$$Δ {z}_{T R} = - \frac{π}{2 F} \frac{d n}{d T} \frac{0.99 [ W / {m}^{2} ]}{2 π if ρ {C}_{v}} RIN \qquad ( 10 )$$

Flexure noise. FROSTI irradiates one face of the test mass. The deposited heat curls the optic in a similar way to a bimetallic trip. While this effect is small for TCS on compensation plate, it is the dominant effect in test mass compensation, it is the motion of the HR surface relative to the center of gravity that determines this coupling.

To estimate flexure noise effect, we introduce harmonic thermal perturbation to the heat source (FROSTI) profile in a COMSOL model of the test mass. This can be done using COMSOL Frequency Domain, Prestressed solver, which consists of 2 step study:
1. Steady state study: Solve for the static thermal profile, as well as thermal stress and strain of the test mass heated by the FROSTI
2. Frequency domain study: The FROSTI heating at HR boundary is set to harmonic perturbation. The frequency of the perturbation is set between 1 and 1000 Hz.

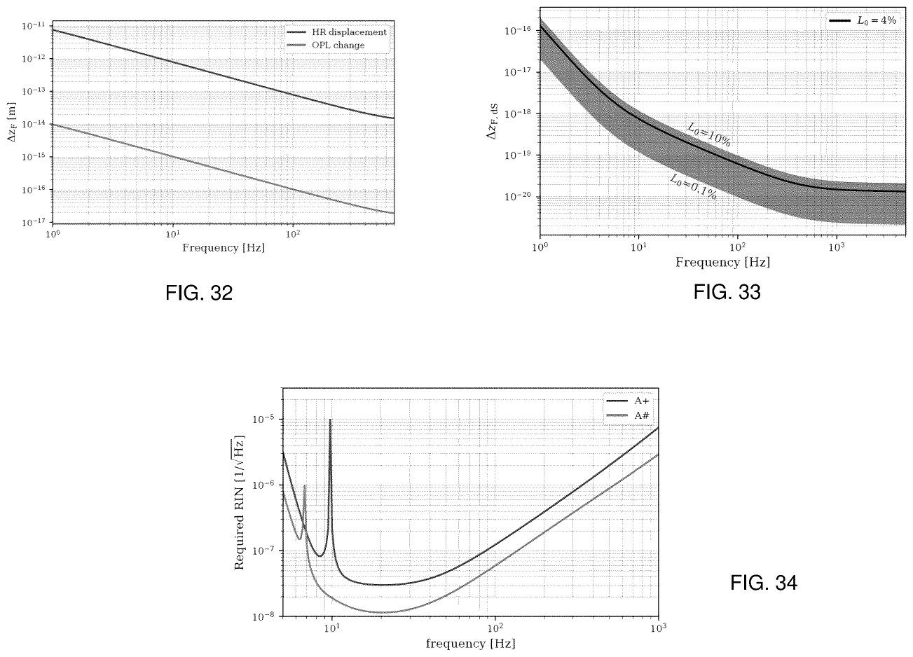

The displacement from the COMSOL solution is extracted from COMSOL to compute displacement noise. FIG. 32 also shows the 1/f behavior of the flexure noise, as expected from heat diffusion equation. As seen in this figure, the HR displacement due to bending of the optics is the dominant effect.

FIG. 32 shows displacement spectrum caused by flexure noise, including displacement of the HR surface and the change in optical path length of the ITM substrate caused by 15 W FROSTI fluctuation.

The total flexure noise is at 15 W of FROSTI is given by:

$$Δ {z}_{F} = ( 5.21 \times 1 {0}^{- 14} [ m ] + \frac{π}{2 F} ( n - 1 ) 4.34 \times 1 {0}^{- 14} [ m ] ) \frac{10 [ Hz ]}{f} \frac{P}{1 [ W ]} RIN \qquad ( 11 )$$

Flexure-induced mode matching noise. The flexure effect also changes the radius of curvature of the test mass, thus resulting in mode mismatch loss, which couples to fluctuation in the arm power, and therefore appears as displacement noise Δz_{F,dS}. Under the assumption that the fluctuation on the radius of curvature (RoC) due to flexure noise is small

$$Δ {z}_{F , d S} ( f ) = \frac{{P}_{0}}{G ( f )} Δ L ( f ) \qquad ( 12 )$$

where P₀ is the LO power on the photodetector, G(f) is the optical gain of the interferometer, δL(f) is the mode-matching loss (MML) fluctuation. Both P₀ and G(f) can be obtained from Finesse simulation. In general, the MML is given by:

$$L = {( \frac{k S {w}^{2}}{4} )}^{2} \qquad ( 13 )$$

where S is the defocus. The fluctuation in MML δL(f) is then given by:

$$Δ L ( f ) = 2 {( \frac{k {w}^{2}}{4} )}^{2} {S}_{0} Δ S ( f ) \qquad ( 14 )$$

where S₀ is some DC offset in mode-matching due to imperfect mode overlap. The apparent displacement noise is then given by:

$$\begin{matrix}Δ {z}_{F , d S} ( f ) = \frac{{P}_{0}}{G ( f )} \frac{{k}^{2} {w}^{4}}{8} {S}_{0} Δ S ( f ) \\ = \frac{{P}_{0}}{G ( f )} \frac{k {w}^{2}}{2} \sqrt{{L}_{0}} Δ S ( f )\end{matrix} \qquad ( 15 )$$

From the same COMSOL FEM results, we can compute the flexure-induced defocus noise, which is given by:

$$Δ S = 9.96 \times 1 {0}^{- 12} [ D ] \frac{P}{1 [ W ]} \frac{10 [ Hz ]}{f} RIN \qquad ( 16 )$$

Combine equations 15 and 16, and approximately 20 mW LO incident on AS PD, we have:

$$Δ {z}_{F , d S} ( f ) = \frac{{P}_{0}}{G ( f )} \frac{k {w}^{2}}{2} \sqrt{{L}_{0}} 9.96 \times 1 {0}^{- 12} [ D ] \frac{P}{1 [ W ]} \frac{10 [ Hz ]}{f} RIN \qquad ( 17 )$$

Assuming 20 mW incident on PD, 4% MML target, FIG. 33 shows the apparent displacement noise from curvature noise for RIN=1, and 15 W FROSTI, assuming ETM beamsize (62 mm). From this plot, it's clear that the apparent displacement resulted from flexure-induced defocus noise is much smaller than the flexure-induced displacement noise.

FIG. 33 shows apparent displacement noise caused by flexure-induced defocus noise for 15 W FROSTI on ETM, with RIN=1.

Elasto-optic noise. Once that finite element model has been solved for the flexure noise above, the strain solution ò(r,z) can also be extracted and we can apply fused-silica elasto-optic coefficients and integrate along the optics to obtain elasto-optic noise. Following Ryan Lawrence's thesis (P030001), the fluctuation in the optical path for p-polarized light across the transverse plane is:

$$Δ {z}_{EO} ( x , y ) = - \frac{{n}^{3}}{2} \frac{2 π}{λ} {\int }_{0}^{{h}_{TM}} {\sum }_{m = 1}^{3} {p}_{1 m} {ò}_{m} ( x , y , z ) d z \qquad ( 18 )$$

where P₁ₘ are the elasto-coefficients of fused silica. For isotropic material like fused silica, p₁₂=p₁₃. Here corresponds to normal strains òₓ,ò_{y},ò_{z} in Cartesian coordinates, which need to be converted in cylindrical coordinate to use results from FEA solutions. Eq. 18 then becomes:

$$Δ {z}_{EO} ( x , y ) = - \frac{{n}^{3}}{2} {\int }_{0}^{{h}_{TM}} d z [ ( {p}_{11} {cos}^{2} ϕ + {p}_{12} {sin}^{2} ϕ ) {ò}_{r r} + ( {p}_{11} {sin}^{2} ϕ + {p}_{12} {cos}^{2} ϕ ) {ò}_{ϕϕ} + {p}_{12} {ò}_{z z} ]$$

where φ is the azimuthal coordinate. The displacement noise can then be computed as the overlap between this profile and the IFO Gaussian beam.

$$Δ {z}_{EO} = \frac{π}{2 F} \frac{〈 {U}_{00} \vert Δ {z}_{EO} ( x , y ) \vert {U}_{00} 〉}{〈 {U}_{00} \vert {U}_{00} 〉} R IN = 8.78 \times 1 {0}^{- 17} [ m ] \frac{10 [ Hz ]}{f} \frac{P}{1 [ W ]} RIN \qquad ( 20 )$$

The elasto-optic noise is thus much smaller than the bending noise.

Requirement on relative intensity noise (RIN). Combining all displacement noises caused by RIN of the irradiator and using target DARM budget, including a factor of 10 by which the combined noise has to be lower, the requirement for RIN noise for FROSTI (with the same irradiation pattern) is shown in FIG. 34.

FIG. 34 shows design considerations on FROSTI RIN for some embodiments given all displacement noise sources caused by RIN, for irradiation pattern shown in FIG. 27.

In addition to displacement noise, there may be jitter noise, which may cause motion-induced fluctuations in the spatial overlap of intensity distribution, with the interferometer beam.

### A.6. Interface Examples

### Mechanical Interfaces

The FROSTI heater will, nominally, be mounted to the quad cage structure immediately in front of the test mass, as shown in FIG. 17. This image shows the mounting concept and position but not the actual mounting points. There are several mounting options for FROSTI. The most obvious is to reconfigure the mounting brace for the front earthquake stops, as depicted in FIG. 18.

### Electrical Interfaces

FROSTI will require 8-16 independent heater drivers. Each heater driver will require 4-6 wires (2 for voltage supply, 2-4 for resistance temperature detector, RTD, readout). Therefore, a single-FROSTI actuator may require up to 96 wires to run. The cabling from FROSTI will be run to a local pair of 25-pin Dsub connectors, near the base of the quad cage, followed by in-vacuum cabling from the base of the cage to the flange, as illustrated in in FIG. 19.

### Optical Interfaces

There is direct line of sight from the heater surface, and the interior reflector surface, to the surface of the test mass. However, there is no laser optical interface between FROSTI and the test mass.

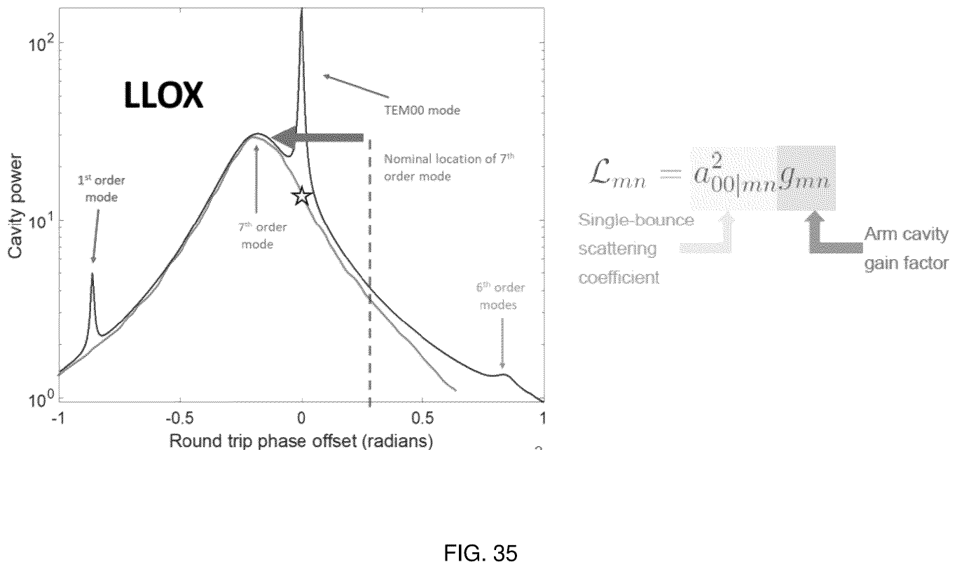

FIG. 35 is a graph of example of cavity power as a function of round trip phase offset. One of the technical problems addressed by the ring heater design is to mitigate non-uniform loss induced by point absorbers that scatter TEM00 mode into higher order modes. Specifically, the 7th order mode scattering loss is resonantly enhanced due to cavity degeneracy. FIG. 35 also depicts an equation for loss of power from TEM00 to TEMmn mode, which is a multiplication of a single bounce scattering coefficient and an arm cavity gain factor. The various curves depict cavity power as a function of round trip phase offset.

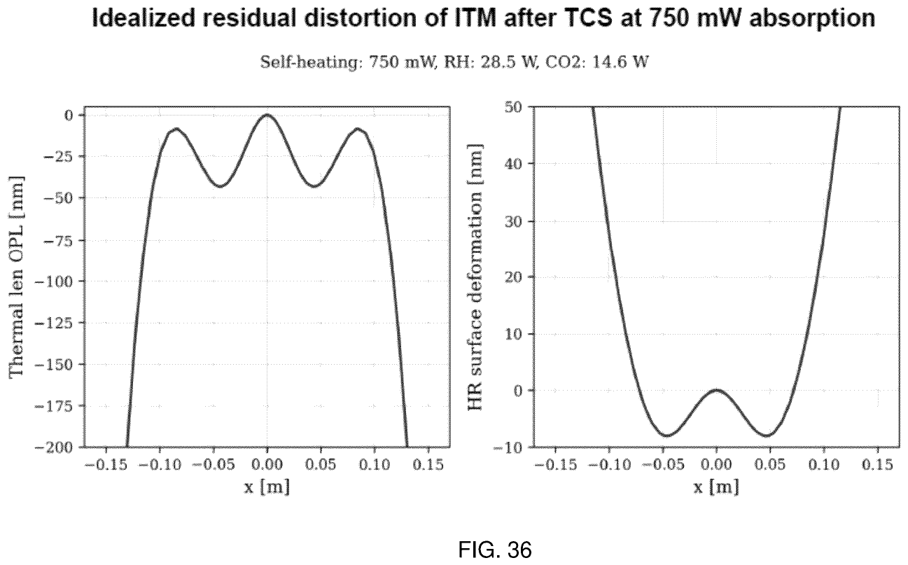

FIG. 36 shows graphs of idealized residual distortion. This graph highlights a second technical solution feature of the disclosed embodiment, which relates to correcting high levels of uniform absorption. In embodiments that operate at 1.5 MW and above, residual surface deformation after optimal correction with barrel ring heater (RH) has a steep edge rise, which results in large residual distortions (20 nano meter RMS), as depicted in the graphs.

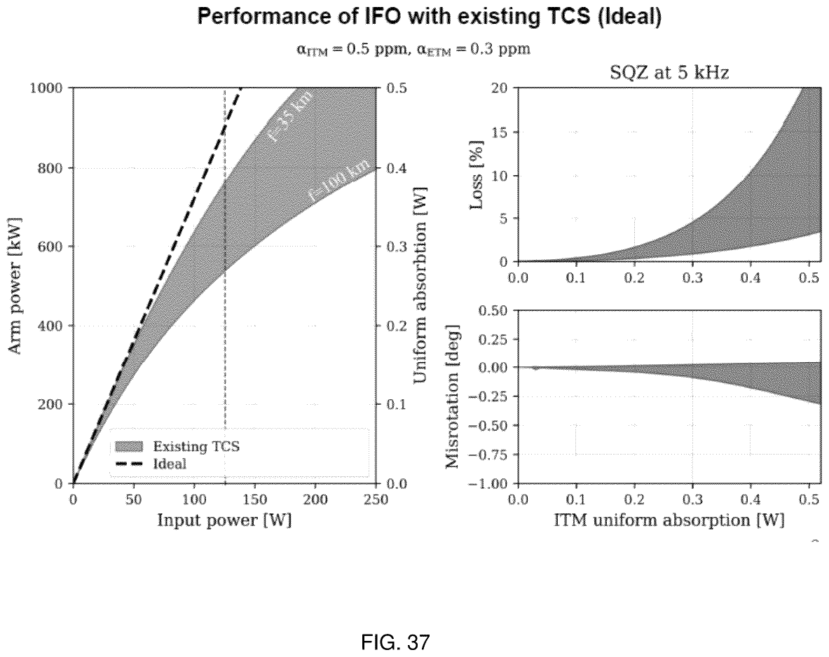

FIG. 37 shows graphs of performance of IFO. The graphs show that the distortion causes drop in PRG, and hence arm power. It was found that use of an ideal TCS only supported up to 750 kW power. Residual thermal lens causes significant squeezing (SQZ) loss at high frequencies above 400 Hz. The three graphs show arm power as a function of input power (left), loss percent (top) and misrotation (bottom) as a function of ITM uniform absorption.

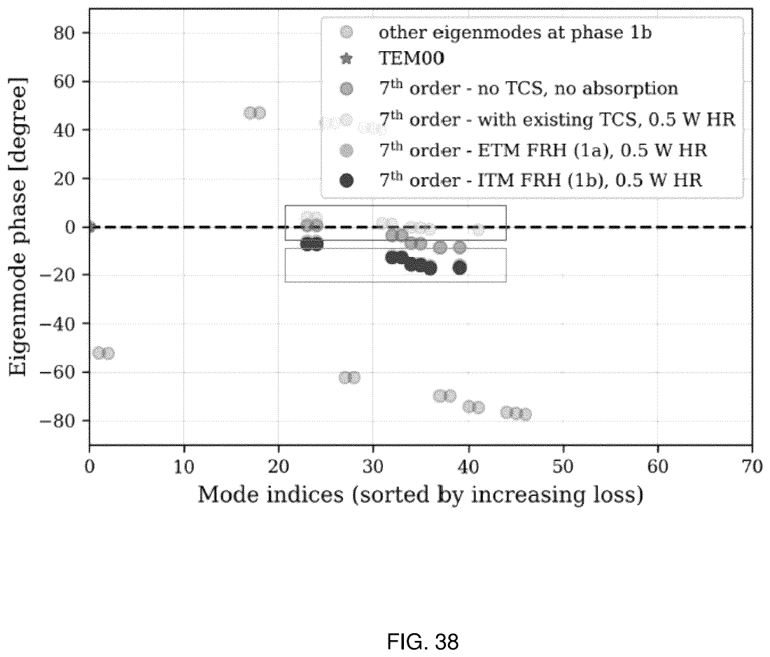

FIG. 38 shows an example of shifting higher order modulation (HOM) that may be achieved by FROSTI embodiments. Simulations showed that FROSTI embodiments can shift HOM7 (seventh order modulation distortion) by around 8% FSR. The graph shows eigenmode phase as a function of mode indices.

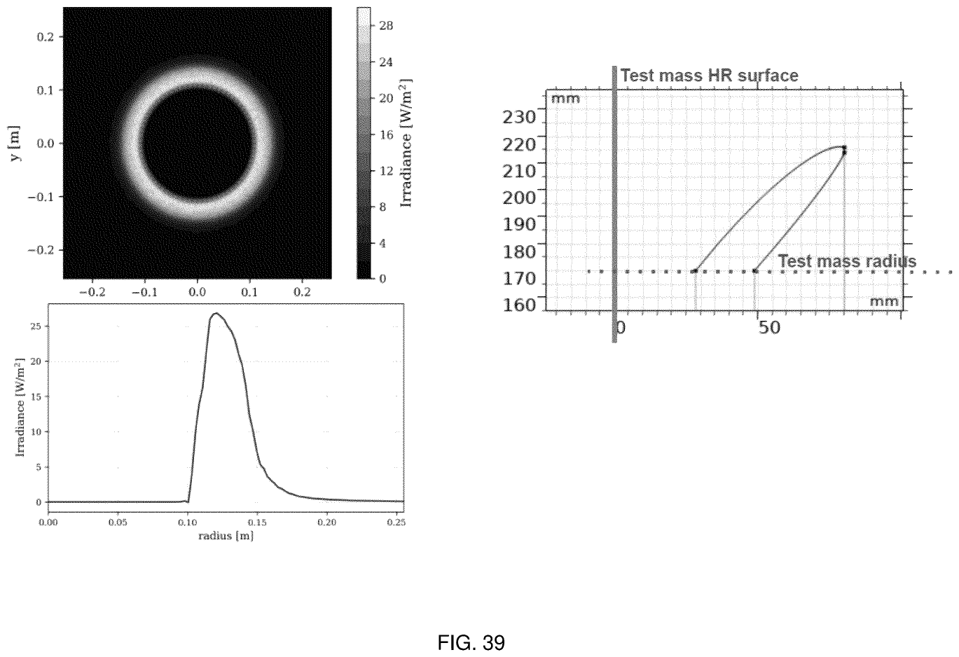

FIG. 39 shows an example of generation of a target heating profile. Here, non-imaging optics using elliptical surface reflectors were used to achieve target irradiation pattern. Results were verified using a ray tracing technique. The graphs show irradiance as a function of radius (bottom) and the irradiation pattern (top right).

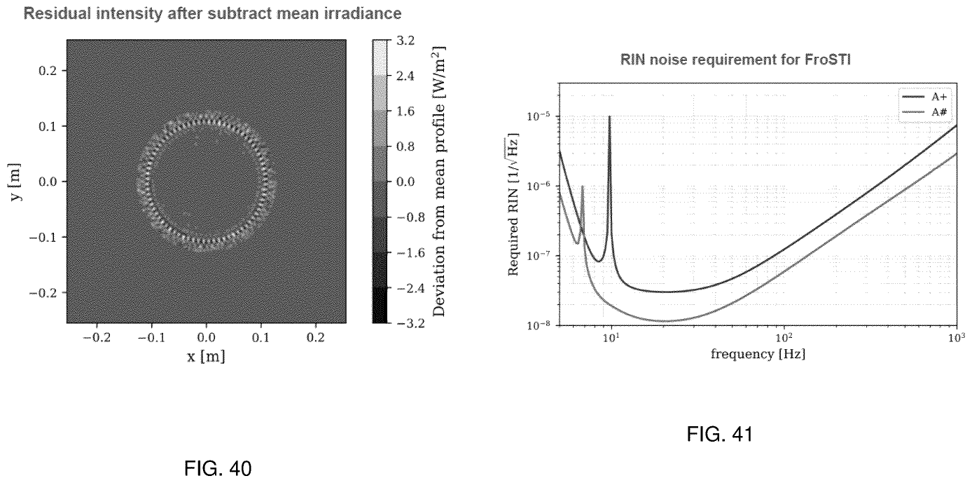

FIG. 40 shows example results for irradiance uniformity that may be achieved. In one experiment, subtraction of mean profile showed approximately 1% intensity fluctuation with spatial wavelengths between 8-9 mm. One of the features for the heaters is that the resistance of the heater elements is maintained to be within 8% of nominal across the entire temperature operating range.

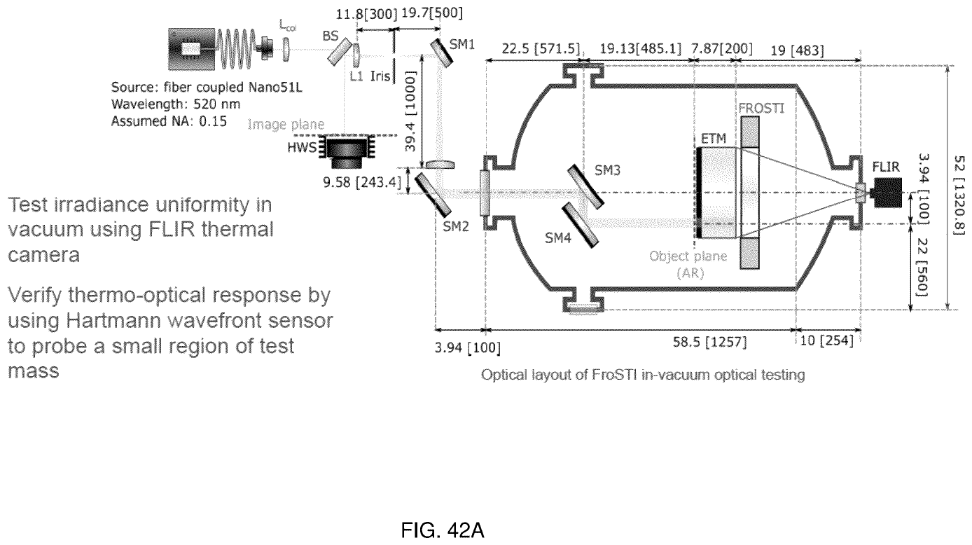

FIG. 41 shows example results for RIN requirements. During operation, FROSTI actuates were used on test mass to determine that the bending or flexure noise is the dominant displacement noise, which is maintained to be within 1e-8 (1/sqrt (Hz) at around 20 Hz.

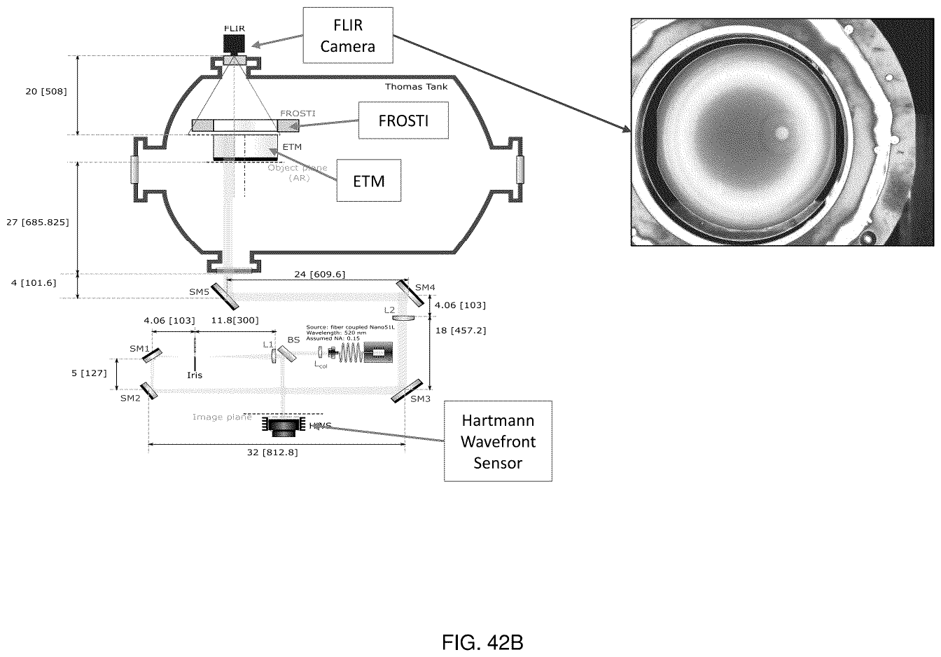

FIG. 42A shows a setup for in-vacuum optical testing. A light source was used to feed the in-vacuum FROSTI testing. An FLIR thermal camera was used for the testing. The thermos-optical response was measured by using a Hartmann wavefront sensor to probe a small region of the test mass.

FIG. 42B shows another setup for testing demonstrating how the disclosed ring heater may be used in practice. In this particular set-up, the ring heater irradiance profile was applied to a 40-kg test mass in vacuum for imaging of entire surface. Hartmann wavefront sensing of a smaller region (probe beam can be translated across ETM surface) was performed. Here, ETM refers to the external test mass. The intensity plot on the right shows an example of a test image collected during the experiment.

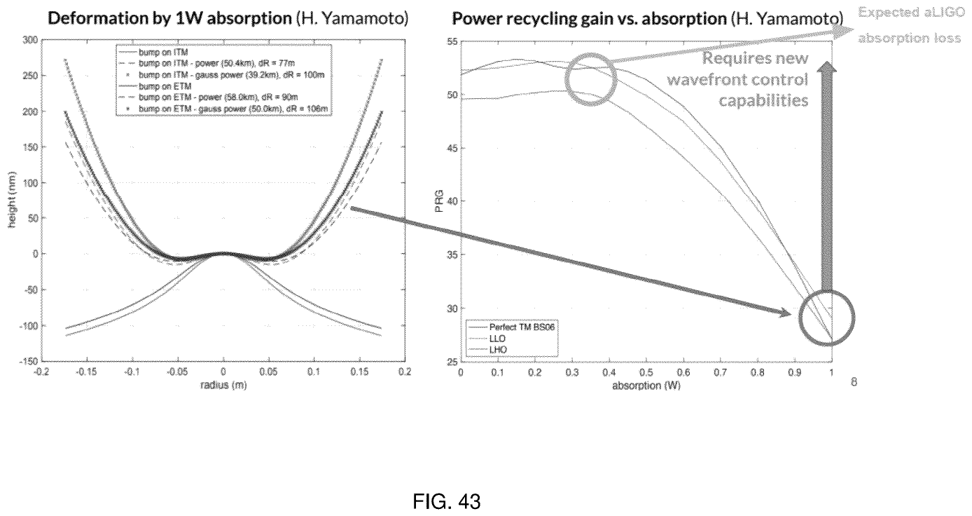

FIG. 43 shows an example of high power operation results. The graphs highlight a technical issue for high power operation that shows that uniform coating absorption cannot be fully compensated with existing techniques, which tend to increase PRG (power recycling gain) loss. Left graph shows height vs radius deformation characteristics and right graph shows power recycling gain as a function of absorption.

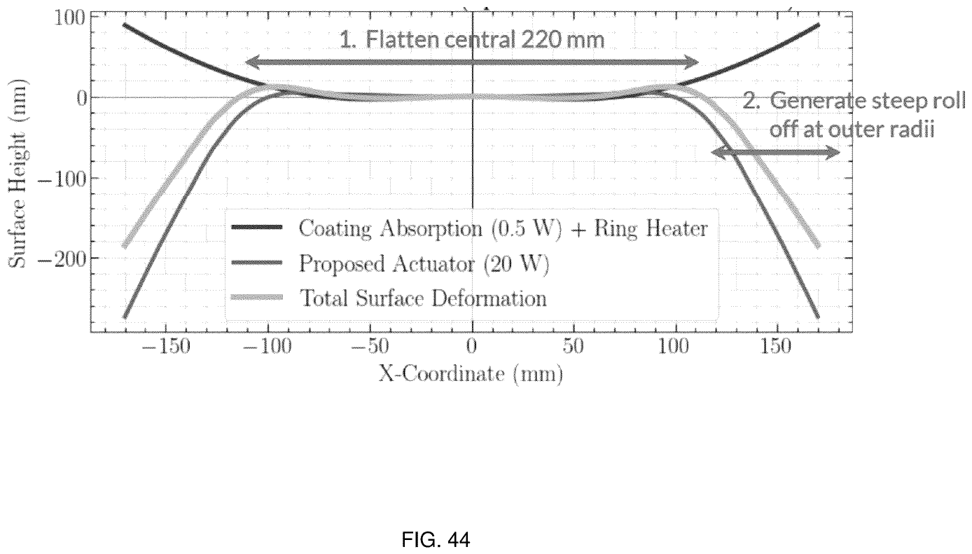

FIG. 44 shows example graphs for surface deformation technical problem that may be overcome with the new design. A target design criterion is to flatten the central 220 mm surface height distortion in the middle area, and then generate steep roll off at outer radii. The three curves are for coating absorption+ring heater (upper), total surface deformation (middle) and proposed actuator (lower).

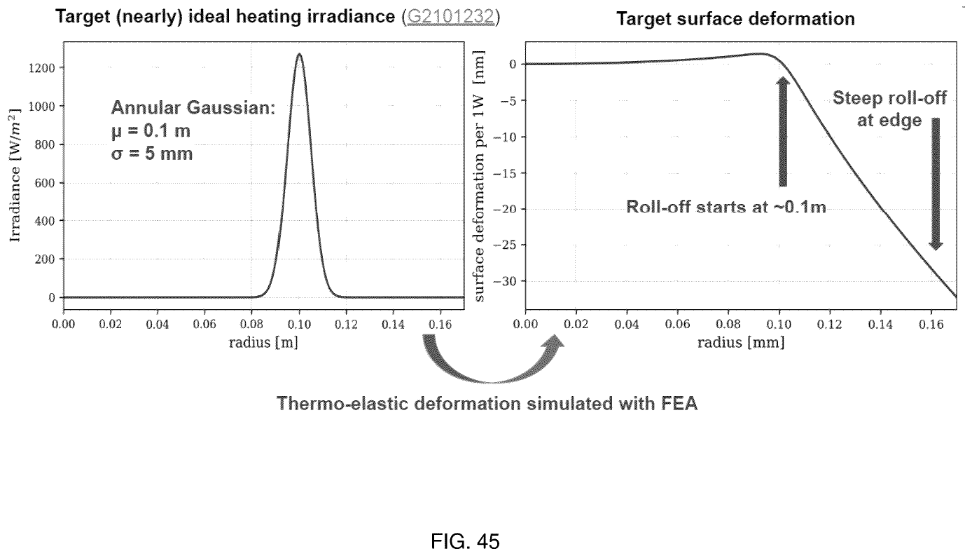

FIG. 45 shows example graphs of how the right deformation can be obtained. The left graph shows irradiance as a function of radius, which results in the target surface deformation as a function of radius, as shown in the right graph.

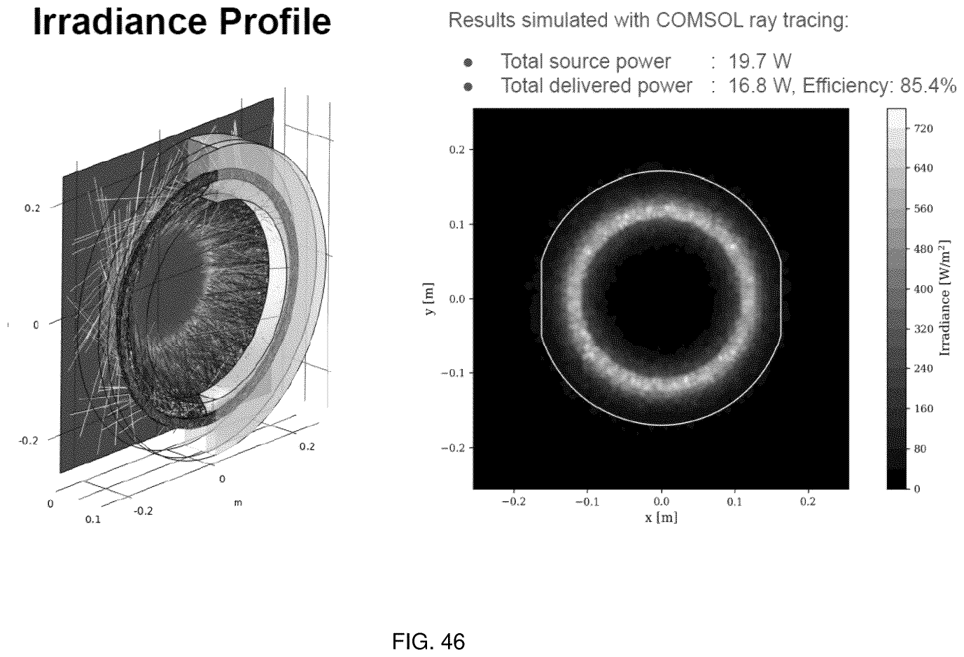

FIG. 46 shows example results of irradiance profile of a ring heater obtained using a ray tracing technique.

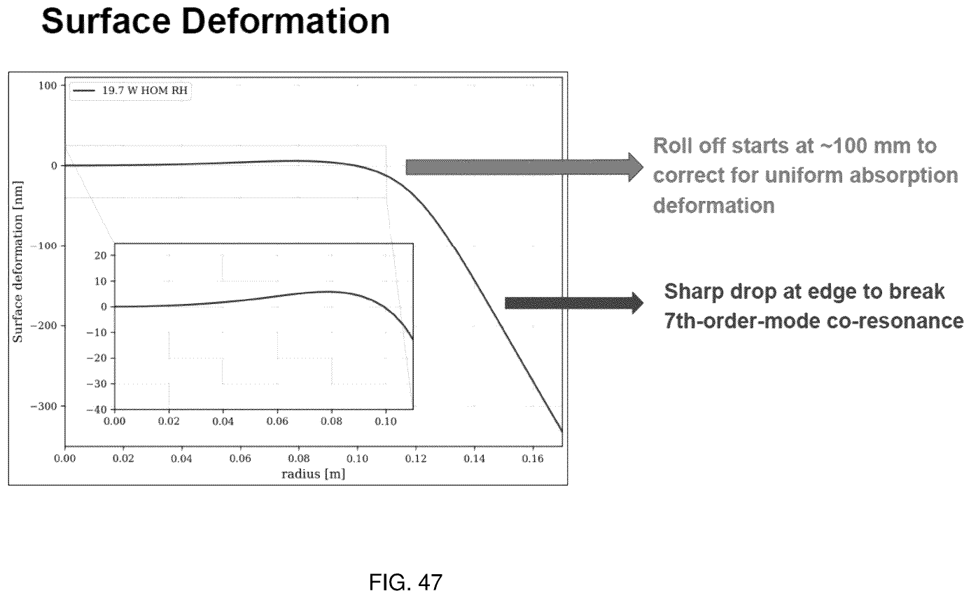

FIG. 47 shows impact of surface deformation. Here, deformation is shown as a function of radius. It can be seen that roll off starts around 100 mm to correct the uniform absorption deformation. A sharp drop is introduced at the edge to break the 7th order mode co-resonance.

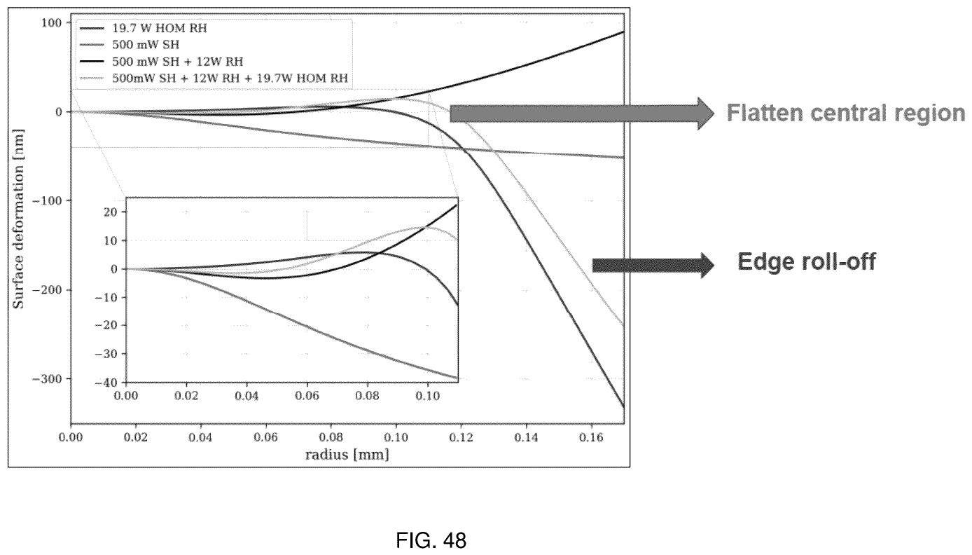

FIG. 48 shows results of compensation at 500 mW absorption. Here, surface deformation as a function of radius is shown with four curves.

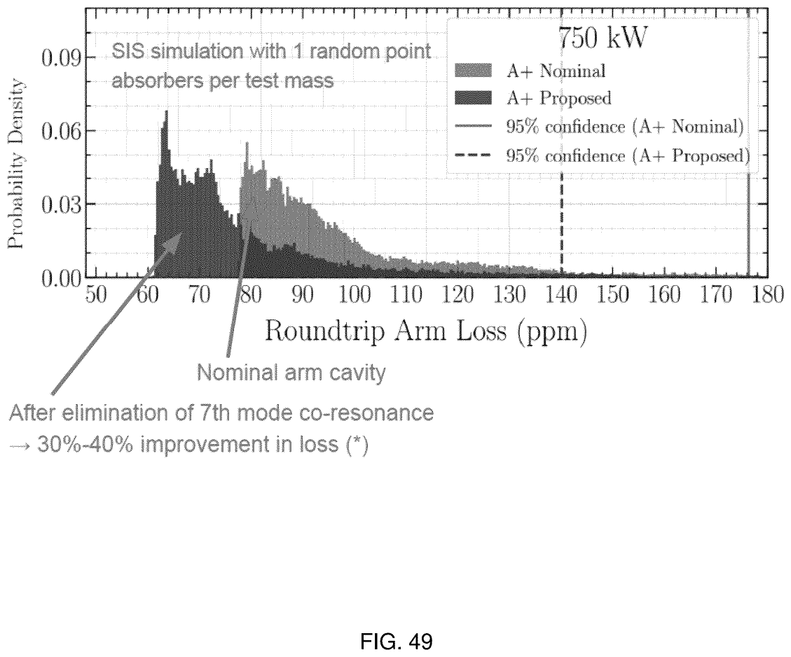

FIG. 49 graphically depicts impact of shifting the SOM resonance. Here, probability density is plotted as a function of roundtrip arm loss. The graph on right shows nominal arm cavity performance. The graph on left shows performance after elimination of the 7th mode co-resonance. It can be seen that a 30 to 40 percent improvement in loss may be obtained.

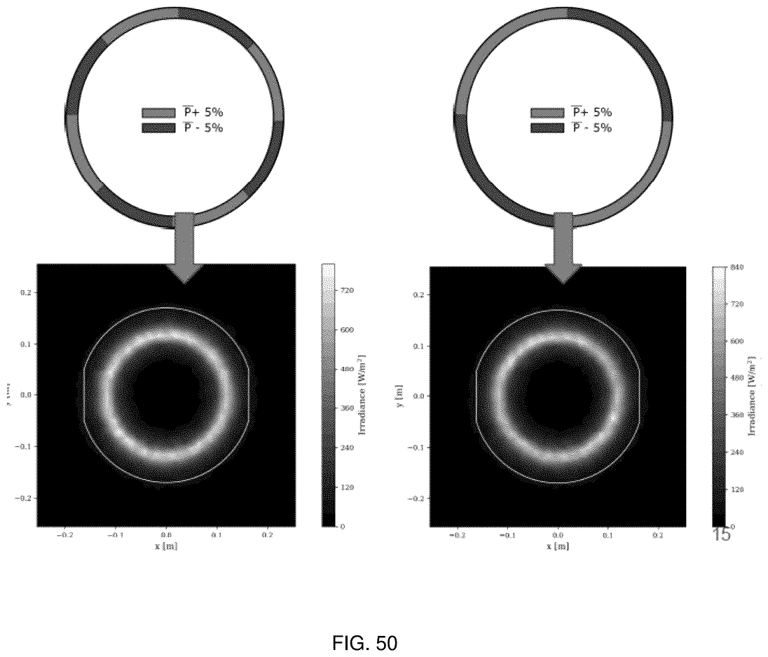

FIG. 50 depicts examples of consistency of resistance of a heater element. In the depicted example, right heat elements are arranged around a circular circumference. A design target is to keep the resistance variation between different branches to between plus minus 20% (e.g., 63.2 to 94.8 Ohm). Some variation in the power radiated from each element was seen due to the resistance variation, which is shown in the graphs for 4 element and 8 element embodiments.

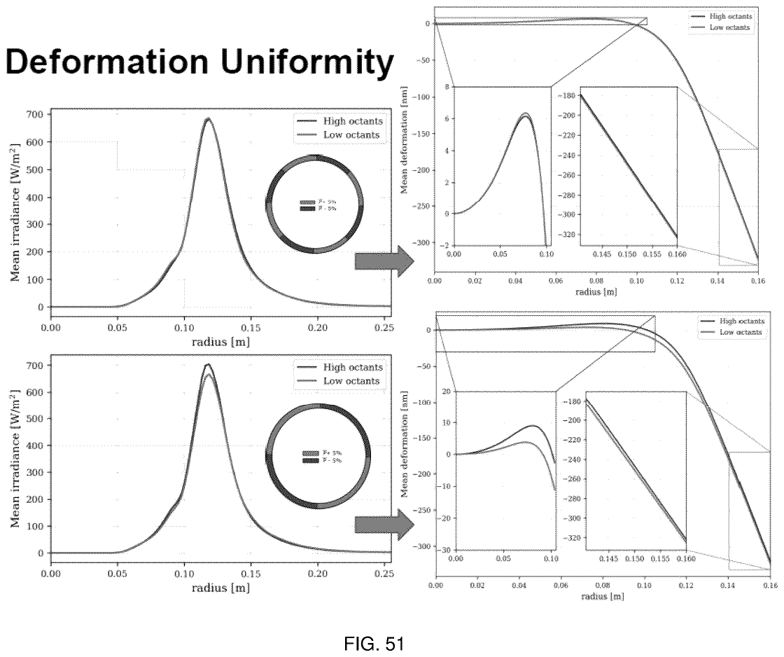

FIG. 51 are graphs showing results for deformation uniformity. The graphical results were obtained by ray tracing technique for 4-heating element and 8-heating element embodiments (bottom and top, respectively). With the design target of keeping variations in resistance below 8 percent, it was seen that heater elements can be power by off-the-shelf existing direct current (DC) power supplies.

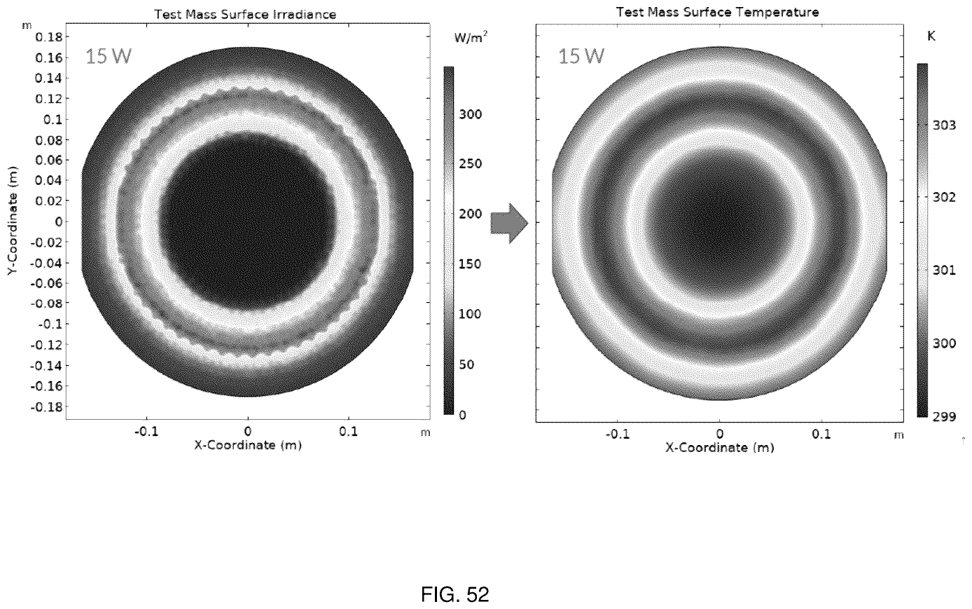

FIG. 52 shows example results obtained using a test mass in which intensities are plotted as functions of X and Y coordinates.

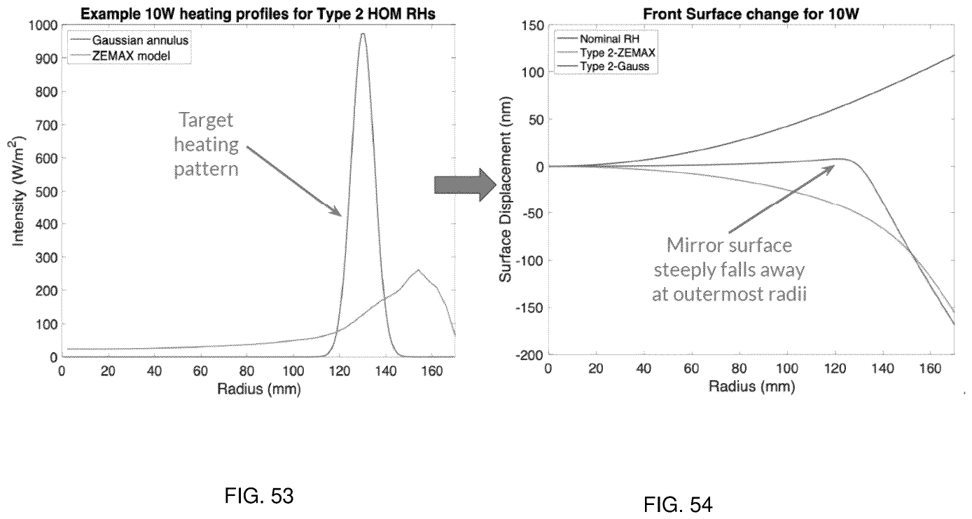

FIG. 53 shows target heating pattern example and FIG. 54 shows graphs of example of surface distortions for an embodiment that uses 10 W heating.

### B. Design Optimization of CO2 Projection and Irradiance Profiles

### B.1. Introduction

With 1.5 MW of higher power use, thermal compensation system is required to compensate for strong distortion caused by large absorption in test mass coating. This section describes the method to obtain the “ideal” irradiance profiles to be used for annular CO2 projection and FROSTI projection on the testmass front surface.

### B.2. Optimization Procedure

Software simulations were performed to simulate and validate results.

1. Generating responses form segmented ring on actuated surface: Apply annular Heat Flux boundary condition to either the ITM-HR surface (for FROSTI) or CP-AR surface (towards the BS) (for CO2) of either following forms:

### Rectangular Heating Function:

$$\dot{Q} = \frac{1 [ W ]}{π ( {r}_{o}^{2} - {r}_{i}^{2} )} [ H ( x - {r}_{i} ) - H ( x - {r}_{o} ) ] \qquad ( 21 )$$

where H(x) is the step heaviside function, rₒ and rᵢ are inner and outer radii. Two sets of data were simulated, one with δr=rₒ−rᵢ=2.5 [mm] and one with δr=5 [mm].

### Gaussian Heating Function:

The FEA couples Heat transfer in solid, Surface-to-surface Radiative Heat transfer and Solid Mechanics and solve for the temperature field and displacement field of the CP and ITM. Thus, for each annular heat element at radius rₖ=rᵢ+[1−δ(rᵢ)]½δr with rᵢ∈{kδr|k=0, 1, . . . , floor (a/δr)−1}, where a=0.170 [m], there is an ITM HR surface deformation and total OPD responses as function of radial distance: w(r;rₖ) and OPD(r;rₖ). These responses to heating from the ITM HR surface are shown in FIG. 54.

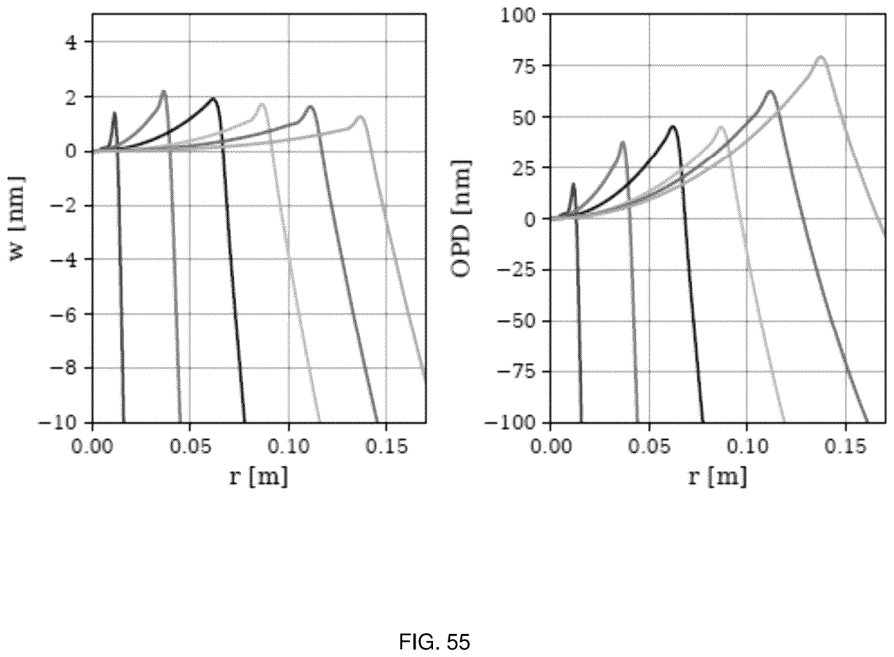

FIG. 55 shows an example of surface deformation and OPD responses to annular heat segments on ITM HR surface at some selected radii. A similar set of responses exists for heating from CP side.

These data are exported and save under npz format as a dictionary. Once loading these dictionaries, the users can find the following keys:
“r”: radial coordinates of deformation response—[256,] ndarray
“deformation”: HR surface deformation response—[256,] ndarray
“opd”: substrate OPD distortion response—[256,] ndarray
“ring-radius”: radial position of annular heating element—[N_{ring},] ndarray
“ring-area”: area of annular heating element—[N_{ring},] ndarray

The ring-area values are used to convert power to intensity after optimization.

2. Construct matrix to calculate total OPD/deformation: Once the responses have be obtained, we construct matrix to compute OPD and deformation such that it can be used for optimization in the next step. This matrix is constructed in functions ITM_deformation and ITM_OPD. The input parameters of these functions include:
P_ACTS: power of actuator elements (*array to optimize)
P_HR: HR coating absorbed power
rTransition: radial position at which CO2 heating (on CP) transitions to FROSTI heating (ITM HR surface).
nOverlap: Number of elements around transition region that heating with FROSTI and heating with CO₂ Overlap.
rStop: Radial position at which the power by that annular element is forced to be zero. Default value is 0.16, this is to avoid generation of pattern that is not realistic at the edge.

The rTransition (rₜᵣ), nOverlap (n_{O}) determine the number of elements (and therefore the size of P_ACTS). The number of CO2 and FROSTI elements are:

$${N}_{C O 2} = int ( \frac{{r}_{t r}}{δ r} ) + {n}_{O} \qquad ( 22 )$$

$${N}_{F R H} = int ( \frac{{r}_{s t o p}}{δ r} ) - ( \frac{{r}_{t r}}{δ r} ) + 1 + {n}_{O} \qquad ( 23 )$$

The final response matrix R will have the size {Nₜₒₜ×M} where M=256 is the number of radial points describing OPDs/deformations, and Nₜₒₜ=N_{CO2}+N_{FROSTI}+1, with the last row the response to 1 W of barrel ring heater:

$${R}_{w} = [ \begin{matrix}w CO {2}_{0 , 0} & w CO {2}_{0 , 1} & … & w CO {2}_{0 , M} \\ w CO {2}_{1 , 0} & w CO {2}_{1 , 1} & … & w CO {2}_{1 , M} \\ ⋮ & ⋮ & ⋱ & ⋮ \\ w CO {2}_{{N}_{CO 2} + {n}_{O} , 0} & w CO {2}_{{N}_{CO 2} + {n}_{O} , 1} & … & w CO {2}_{{N}_{CO 2} + {n}_{O} , M} \\ {wFRH}_{{N}_{CO 2} - {n}_{O} , 0} & {wFRH}_{{N}_{CO 2} - {n}_{O} , 1} & … & {wFRH}_{{N}_{CO 2} - {n}_{O} , M} \\ ⋮ & ⋮ & ⋱ & ⋮ \\ {wFRH}_{⌊ {r}_{stop} / δ r ⌋ , 0} & {wFRH}_{⌊ {r}_{stop} / δ r ⌋ , 1} & … & {wFRH}_{⌊ {r}_{stop} / δ r ⌋ , M} \\ {wRH}_{0} & {wRH}_{1} & … & {wRH}_{M}\end{matrix} ] \qquad ( 24 )$$

The total distortion is then given by:

$$\begin{matrix}{w}^{T} = [ \begin{matrix}{w}_{0} & {w}_{1} & … & {w}_{M}\end{matrix} ] = {P}_{A C T S}^{T} {R}_{w} \\ = [ \begin{matrix}{P}_{C O 2 , 0} & {P}_{C O 2 , 1} & … & {P}_{F R H , {N}_{C O 2} - {n}_{O}} & … & {P}_{RH}\end{matrix} ] {R}_{w}\end{matrix}$$

3. Define cost function: Once the OPD/deformation have been obtained, these can used to compute a cost function to for optimization. A metric that is reasonable for cost function to maximize both PRG and minimize squeezing loss is the full aperture residual RMS (see T2200310). Let W(r) denotes the function describes either deformation or OPD, the full aperture RMS is computed as:

$${W}_{RM S} = \sqrt{{W}^{2} ( r ) - ( {\overline{W ( r )}}^{2}} \qquad ( 25 )$$

where W̅(̅r̅)̅ is the mean distortion. In the case of ITM, we have an RMS value for deformation and one for thermal lensing OPD. The cost function is taken to be the sum of these two RMS with 1:1 weighting.

$$cost = {RMS}_{O P D} + {RMS}_{deform} \qquad ( 26 )$$

In the case of the ETM, squeezing loss is significant less susceptible its surface deformation. Optimization is performed to mainly maintain power buildup. The metric for ETM is thus can be Gaussian weighted RMS:

$${W}_{R M S} = \sqrt{\frac{{\int }_{0}^{2 π} d ϕ {\int }_{0}^{a} L {G}_{00}^{*} ( r ; w ) [ {W ( r )}^{2} - \overline{W {( r )}^{2}} ] L {G}_{00} ( r ; w ) rdr}{{\int }_{0}^{2 π} d ϕ {\int }_{0}^{a} {\vert {LG}_{00} \vert}^{2} r d r}} \qquad ( 27 )$$

Only the RMS of surface deformation is considered in the cost function to optimize for FROSTI on ETM.

4. Minimization of cost function: Once the cost function has been defined, SCIPY optimzation.minimize routine is used to minimize the cost. This is implemented in function optimise_rms. Since the problem is a bounded minimization problem, with each heating element having a lower bound of 0, the default L-BFGS-B (Limited-memory Broyden-Fletcher-Goldfarb-Shannon Box-bound) routine is used. This algorithm is in the family of quasi-Newton method that approximate the inverse Hessian to determine the direction to move down the gradient.

To minimize the cost function, an initial guess is required to pass through. Here we generate a guess of a zeros array of size [1, Nₜₒₜ]. Nₜₒₜ is determined by one of the functions: get_element_num_ITM, get_element_num_ETM or get_element_num_ITM_fixedCO2. The choice of which function to be used is dependent on the value of arguments optics (string, accept ‘ITM’ or ‘ETM’), and optimize_CO2 (boolean) passed to optimise_rms.

5. Obtain a smooth irradiance profile: The result from optimization can be jagged and unrealistic to generate. To produce a more realistic profile, the outcome of optimization can be smoothed out by convolving with a Gaussian kernel. This is implemented in Ismooth_ACTS_ITM and Ismooth_ACTS_ETM. These function will separate the output of the optimizer, compute the intensities at each element and perform Gaussian kernel convolution.

### B.3. Case Study 1a: Full Optimization of CO2 and FROSTI on ITM

### B.4. Case Study 1b: Optimization of FROSTI for ETM

The deformation of ETM generally does not induce squeezing loss at high frequency but instead generally limits power build up in the arm. The optimization for ETM FROSTI therefore does not require calculation of rms across the full aperture but instead weighted by ETM nominal Gaussian beam size (62 mm). Here we explore compensation with two scenarios:
1. Ideal compensation with FROSTI projected across full aperture, including central region
2. Best compensation with FROSTI projected to a minimum radial position of 100 mm from ETM center. This corresponds to existing FROSTI design. It is also more practical to implement since projection and large angle is less efficient.

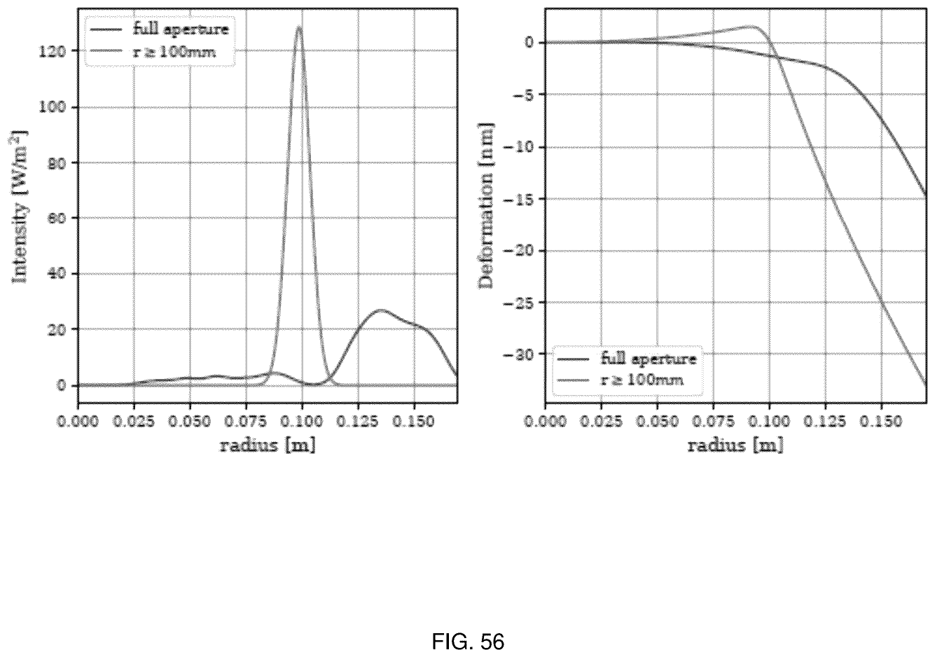

The optimization process for ETM is similar to that of ITM, with the main exception of no CO2 heating and the OPD is not considered in calculation but only surface deformation. In function optimise_rms, the optimization can be switched to ETM simply by letting optics=“ETM” and deformation=“ETM_deformation”. FIG. 56 (left) shows the two intensity profiles at 1 W for the two aforementioned optimization scenarios.

FIG. 56: Left: Intensities resulted from optimizations under two scenarios: Heating by FROSTI is optimized for minimum radial position of 100 mm (red trace) and for full aperture (blue trace). Right: Corresponding surface deformations of ETM per 1 W under the two heating profile.
Full aperture optimization: Heating starts as early as 25 mm away from optics center, and heats broad region out to 100 mm from center. This first heating region compensate for the small edge rise from ring heater. A second heating region starts at 110 mm from the center to generate a steeper edge roll-off.
Optimization from 100 mm: Simple Gaussian heating at r≈100 mm.

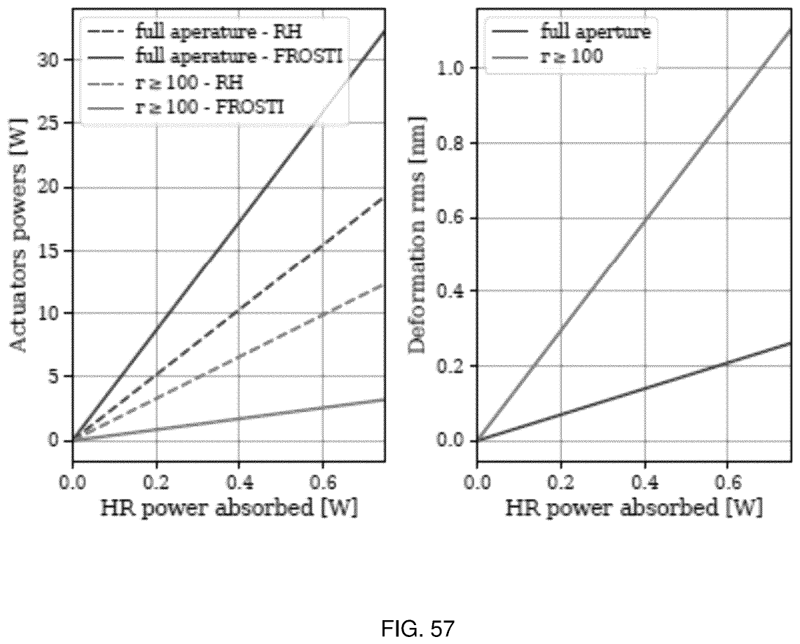

Comparison of powers required from ETM actuators in the two scenarios are shown in FIG. 57. The optimal heating across the test mass apertures requires higher power from both RH and FROSTIs. It is clear that single FROSTI cannot provide both the pattern and the power required in this optimal case (≈32 W at 0.75 W absorption). However, this profile results in a surface RMS significantly lower than that of heating at 100 mm only. This profile will give a factor of 10 head-space in case there are undesired non-uniform absorption. This will require significant engineering of FROSTI to target multiple radial regions of the test mass.

FIG. 57 shows: Left: Powers required from RH and FROSTI to compensate for HR absorption. Right: ETM surface deformation residual rms as function of HR absorbed power under the 2 optimization scenarios.

Another example embodiment: In some embodiments, to partially reduce residual rms from seal heating, heating at 100 mm from central optics may be used due to the following reasons:
At 1 MW arm target (0.5 W absorption) residual rms is still only 0.7 nm
Straight forward implementation, less modification of existing hardware
More forgiving if beam is translated from the center of optics
Generate large roll-off to control HOM7 loss

### B.5. Case Study 2: FROSTI Optimization with Minimal Change to TCS of a Target System

For a minimal change in O5 upgrade, we assume various aspect of TCS stay the same, including
Annular CO2 projection target intensity remains the same
Position of ITM barrel RH remains the same.

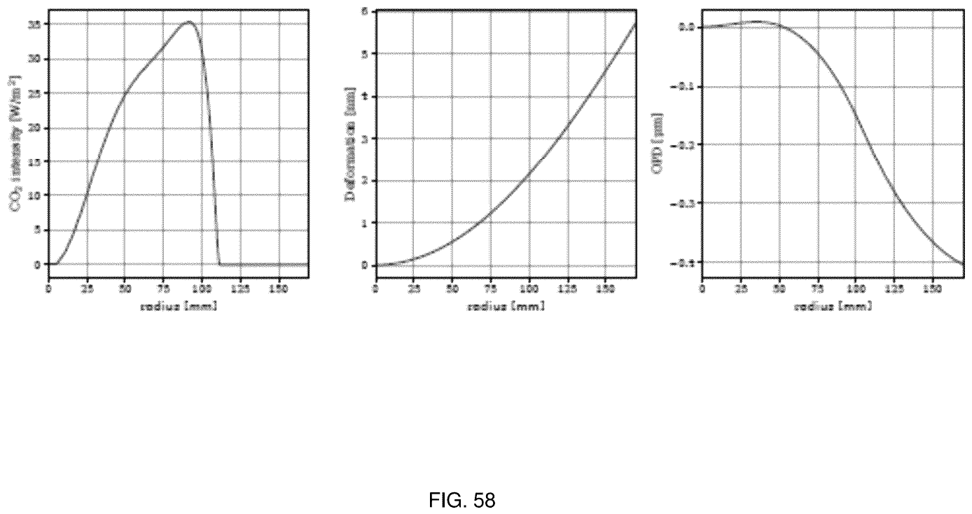

The profile of the existing annular CO2 and its optical responses are shown in FIG. 58.

FIG. 58 shows, from left to right: Intensity profile of the existing target annular CO2 projection onto compensation plate; ITM HR surface deformation response to 1 W of annular CO2; ITM-CP stationary total OPD response from 1 W of existing annular CO2.

The main difference in this optimization problem is to replace the first N_{CO2}+n_{O} rows with a single row of existing annular CO2 response. The array of guessed power now has the structure of: [P_{CO2}, P_{FRH,0}, P_{ERH,1}, . . . , P_{RH}]. The same optimise_rms function is used to perform this optimization with the following variable passed in:
optics: “ITM”
optimize_CO2: True
OPD: ITM_OPD_fixedCO2
deformation: ITM_deformation_fixedCO2

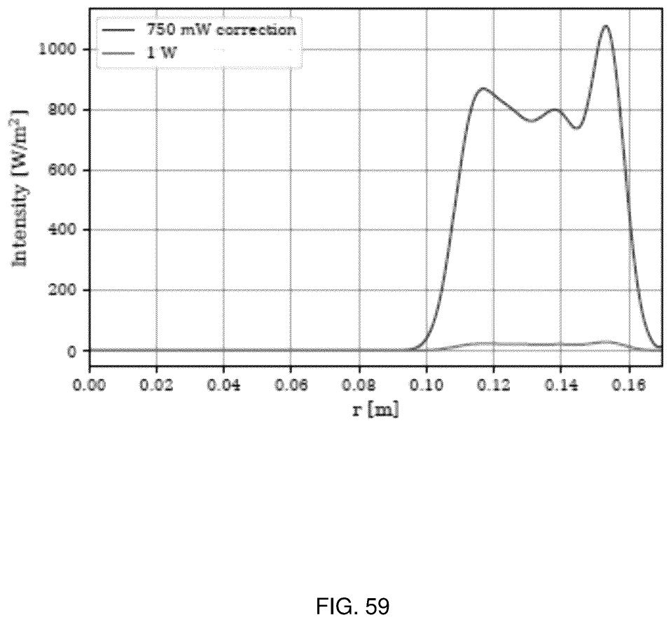

For 750 mW absorption in the coating, FIG. 59 shows the ideal FROSTI correction to 750 mW. Here the resultant profile is obtained from convolving the element-wise optimized outputs with Gaussian kernel of width σ=5 mm such that it is more practical to implement.

FIG. 59 shows an ideal FROSTI irradiance profile to correct for 750 mW of HR absorption by ITM.

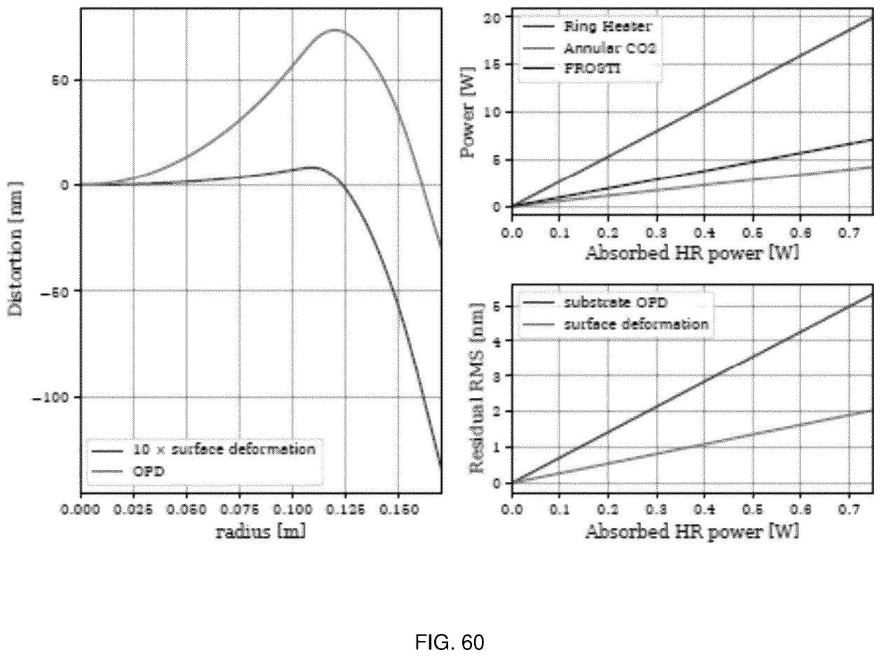

The optical response to 1 W of FROSTI with irradiance profile above is shown the left panel of FIG. 60. The upper right panel shows the power required from each actuator. At 750 mW, RH is required to provide up to 20 W, which is within the capability of existing RH. FROSTI is required to deliver at least 7 W annular CO2 is reduced to 4 W.

FIG. 60 shows: Left: Optical response of the ITM-CP system to 1 W of ideal FROSTI profile shown in FIG. 56, including surface deformation and substrate lensing OPD. Right (from top to bottom): Optimized powers required from each actuator (ring heater, annular CO2 and FROSTI) as functions of HR absorbed power; residual substrate lensing OPD and surface deformation RMS (weighted by ITM nominal beamsize of 53 mm) as functions of HR absorbed powers.

At 750 mW absorption, the residual thermal lens RMS (weighted by ITM beam size of 53 mm) is 5.5 nm and the surface deformation RMS is 2 nm.

### B.5.1. Ideal Compensation Interferometer Performance

While RMS provides a good figure of merit for ease of computation during profile optimization, the IFO performance is ultimately what we are interested in. Here the quantities of interest, which affect the sensitivity directly are:
Arm power build-up
Squeezing loss and misrotation at high frequency (5 kHz used here, loss at 1 kHz is approximately 50% of that at 5 kHz)

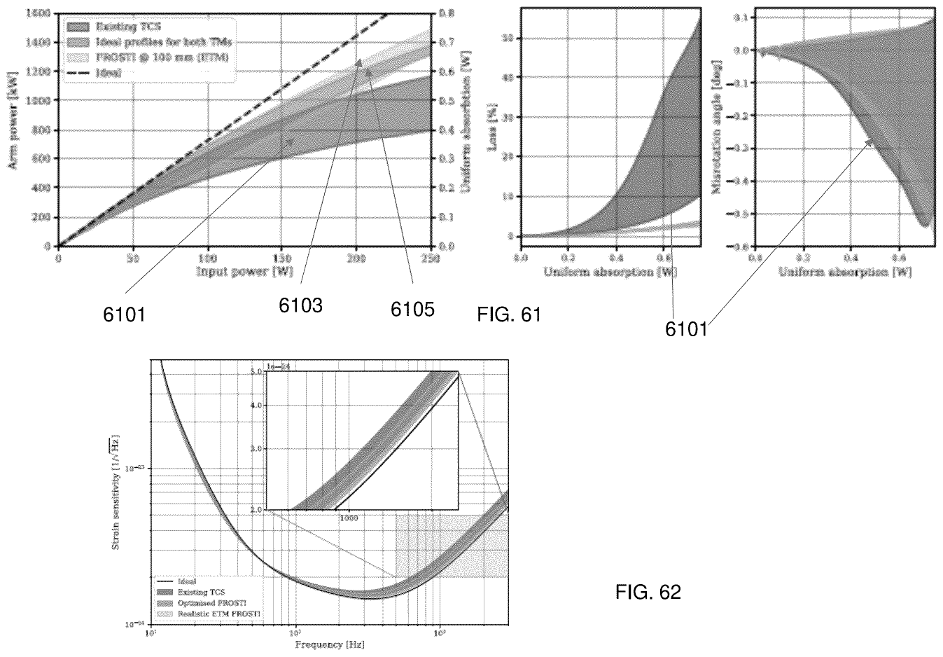

In practice, the only method to optimize the power of various actuators is to rely on the differential wavefront measured by Hartmann wavefront sensors to flatten out any thermal lens. The extent of the Hartmann probe only covers a region of approximately 110 mm in radius. FIG. 61 shows a comparison of the interferometer in three cases:
Existing TCS (6101 in FIG. 61, FIG. 62)
Optimized FROSTI irradiance profiles on both ITM and ETM (with no change to existing TCS) (6103 in FIG. 61, FIG. 62)
Optimized FROSTI optimized irradiance profile on ITM and a more realistic profile on ETM (heating from 100 mm outwards) (6105 in FIG. 61, FIG. 62)

FIG. 61 shows, from left to right: Arm power build ups as functions of input power, compared to ideal scenario of no absorption; Squeezed injection loss at 5 kHz due to thermal lens as a function of amount of absorbed power; Squeeze quadrature misrotation at 5 kHz as a function of amount of power absorbed. Each plot shows three shaded regions corresponding three scenarios of compensation. The shaded region takes into account of the initial cold state static lens with can vary with optics. The range of focal length in this static lens is between 35 km and 100 km. The 35 km lens is the nominal lens required for best most-matching into the arms.

Overall, we found that the addition of FROSTIs improves the overall performance of the interferometer:
Power build-up follows the ideal case more closely and less variation in achievable power dependent on the cold state lens of the IFO
Squeezed loss is reduced significantly, especially at higher absorption
Misrotation remains similar with a very small angle of misrotation in all cases

Effects on the arm power buildup and high frequency squeezing loss directly impact the sensitivity of the IFO, as shown in FIG. 62. These sensitivity curves assume the target operation, using 125 W input laser power and injection of 12 dB squeezing. The curves are phenomenological with the impact on squeezing computed from fractional HOM scattering loss resulted from the optimized OPD maps.

FIG. 62 shows an example of strain sensitivity curves under different TCS scenarios for one example embodiment of a ring heater.

At 125 W injection, table 2 shows the various performance metrics for the 3 scenarios. Binary Neutron Star inspiral range (BNS) is used as a sensitivity metric. Here for strain sensitivity, we introduced an integrated sensitivity S in the log frequency space:

$$\overline{S} = \int \frac{1}{{\vert \tilde{h} ( f ) \vert}^{2}} d ( ln f ) \qquad ( 28 )$$

TABLE 2
Performance metrics of one example
IFO under different TCS scenarios

| | Metrics | | | | |
|---|---|---|---|---|---|
| | Pₐᵣₘ | L_{5 kHz} | θ_{5 kHz} | BNS | S̅ |
| Scenario | [kW] | [%] | [deg] | [Mpa] | [×10⁴⁸ Hz] |
| Ideal IFO | 902 | — | — | 355 | 1.19 |
| Existing TCS | 537-761 | 1.5-3.2 | ~0.05 | 349-353 | 0.93-1.10 |
| Ideal FROSTIs | 684-832 | 0.8-0.9 | ~0.05 | 352-354 | 1.04-1.14 |
| Realistic ETM | 649-836 | 0.8-0.9 | ~0.05 | 352-354 | 1.02-1.15 |
| FROSTI | | | | | |

As shown in Table 1, the impact on squeezing loss at high frequency in the above-disclosed embodiment is small (if the existing TCS is fully optimized). The main shortcoming of the existing TCS is the arm power build-up. Under existing TCS, the deformation of the HR surface is not precisely controlled, leading the arm cavity-q changes with increased absorbed power whereas the OPD lens is flattened out, thus resulting in mainly mismatch coupling into the arm. This thus results in the wide variation in arm power dependent on the cold state lens of the IFO. FROSTIs allow correction of both surface and OPD, thus keeping the cavity q relatively constant.

### C.1. Introduction to Design Examples of the Heater/Reflector

This document outlines the design for HOM ring heater reflector from non-imaging optics design technique.

### C.2. Geometric Layout

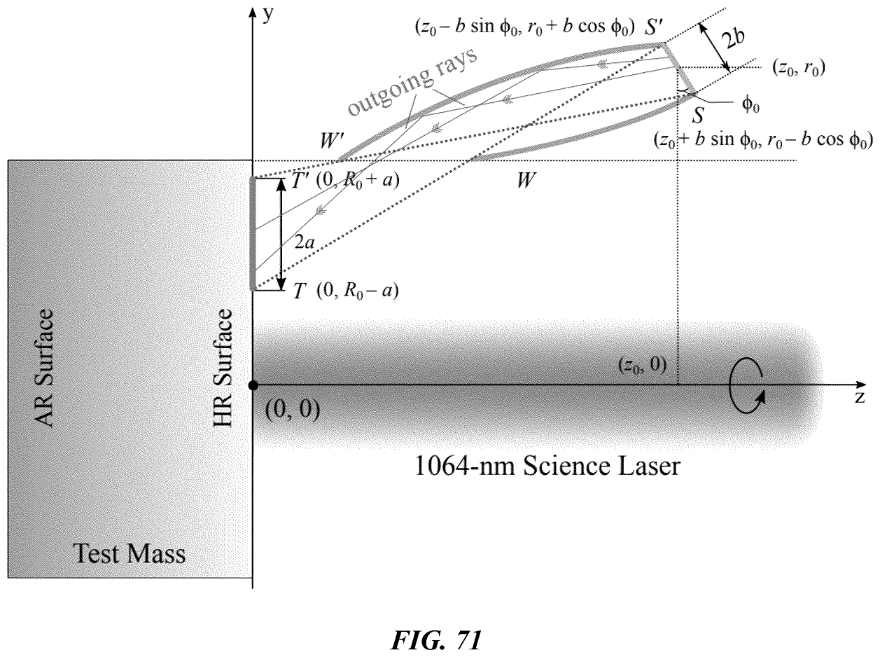

FIG. 5 shows a geometry layout of how optical signals may be acquired. FIG. 71 shows a cross-sectional geometry of a reflector.

Let the origin of Cartesian coordinate (z,r) at the mid-point of the heating region on the front surface of the test-mass. Thus z represents the longitudinal distance from the test mass surface, along the arm-cavity axis, and represents the radial distance from the test mass center. This region is centered at a radial distance from the test mass center and has a width of 2a bounded by 2 points T and T′.

$$\begin{matrix}T = ( 0 , {R}_{0} - a ) \\ {T}^{′} = ( 0 , {R}_{0} + a )\end{matrix} \qquad ( 29 )$$

The heater is a strip radiator with 2b width. It is placed at a given longitudinal and transverse distance from the test mass center and is allowed to take on any angular orientation. Its location is therefore characterized by three parameters: z₀ and r₀, the coordinates of the heater's midpoint, and φ₀, the tilt angle of the heater surface relative to the test mass surface. The heater strip is therefore bounded by two points S and S′:

$$\begin{matrix}S = ( {z}_{0} + b sin {ϕ}_{0} , {r}_{0} - b cos {ϕ}_{0} ) \\ {S}^{′} = ( {z}_{0} - b sin {ϕ}_{0} , {r}_{0} + b cos {ϕ}_{0} )\end{matrix} \qquad ( 30 )$$

Then using edge ray method, we construct an asymmetric compound elliptical concentrator (ACEC):
Draw the two crossover lines bounded by points S′ and T and points S and T′ (green).
To obtain the upper reflector curve bounded by points S′ and W′ (orange), tie the two ends of the string to S and T. Choose the length of the string such that a third movable point (located along the length of the string, between the two endpoints) just reaches point S′.
Keeping the two endpoints of the string fixed, trace out the upper curve S′W′ by sliding the movable point from S′ towards the target plane (keeping the string taut at every position).
The upper curve ends at point W′ where it intersects the crossover line ST′.
Repeat the same procedure to trace out the lower reflector curve bounded by points S and W (orange). This time, hold the endpoints of the string fixed at points S′ and T′ with S being the initial location of the movable point.
The lower curve ends at point W where it intersects the crossover line S′T.

### C.3. Reflector Profile

The edge ray method traced out two reflectors that are segments of two ellipses:

The upper ellipse curve is defined by three points: T and S form the foci of the ellipse and S′ is on the ellipse itself. Likewise, the lower elliptical curve is defined by the points S′ and T′, at the foci of the second ellipse, and point S′ on this ellipse.

The general equation for an ellipse whose center is at (h, k) and tilted by some angle Φ relative to the Z-axis φ is:

$$\frac{{[ ( z - h ) cos Φ + ( r - k ) sin Φ ]}^{2}}{{c}^{2}} + \frac{{[ - ( z - h ) sin Φ + ( r - k ) cos Φ ]}^{2}}{{d}^{2}} = 1 \qquad ( 31 )$$

where c and d are the half lengths of the major and minor axes of the ellipse. The foci coordinate for such ellipse are given by:

$$( h \pm l cos Φ , k \pm l sin Φ ) \qquad ( 32 )$$

where l is the distance from the center of the ellipse to the foci.

### C.3.1. Upper Reflector

For the upper curve, l is given by:

$$l = \frac{1}{2} \sqrt{{( {z}_{0} + b sin {ϕ}_{0} )}^{2} + {( {r}_{0} - b cos {ϕ}_{0} - {R}_{0} + a )}^{2}} \qquad ( 33 )$$

From points S and T, we have:

$$h + l cos Φ = {z}_{0} + b sin {ϕ}_{0} \qquad ( 34 )$$

$$k + l sin Φ = {r}_{0} - b cos {ϕ}_{0} \qquad ( 35 )$$

$$h - l cos Φ = 0 \qquad ( 36 )$$

$$k - l sin Φ = {R}_{0} - a \qquad ( 37 )$$

From these equations, we found that:

$$\begin{matrix}h = \frac{1}{2} ( {z}_{0} + b sin {ϕ}_{0} ) & ( 38 ) \\ k = \frac{1}{2} ( {r}_{0} - b cos {ϕ}_{0} + {R}_{0} - a ) & ( 39 )\end{matrix}$$

Also, from equations 35-37, we have:

$$2 l cos Φ = {z}_{0} + b sin θ \qquad ( 40 )$$

$$2 l sin Φ = {z}_{0} tan θ - b cos θ + a \qquad ( 41 )$$

Therefore, the tilt angle of the ellipse is given by:

$$Φ = {tan}^{- 1} ( \frac{{r}_{0} - b cos {ϕ}_{0} - {R}_{0} + a}{{z}_{0} + b sin {ϕ}_{0}} ) \qquad ( 42 )$$

For an ellipse, the sum of the distances of a point lying on the ellipse to the foci is equal to the length of the major axis 2c where 2c=|S′T|+|S'S|. Since point S′ is on the ellipse where

$$\begin{matrix}\vert {S}^{′} T \vert = \sqrt{{( {z}_{0} - b sin {ϕ}_{0} )}^{2} + {( {r}_{0} + b cos {ϕ}_{0} - {R}_{0} + a )}^{2}} , \\ \vert {S}^{′} S \vert = 2 b\end{matrix}$$

c is computed as:

$$c = \frac{1}{2} \sqrt{{( {z}_{0} - b sin {ϕ}_{0} )}^{2} + {( {r}_{0} + b cos {ϕ}_{0} - {R}_{0} + a )}^{2}} + b \qquad ( 43 )$$

d is then computed from the relation between the foci length and the major and minor axes of the ellipse

$${d}^{2} = {c}^{2} - {l}^{2} \qquad ( 44 )$$

The edge of the upper reflector is determined when the ellipse intersects the crossover line ST′ at point W′. The equation of this line is given by:

$$r = ( \frac{{r}_{0} - b cos {ϕ}_{0} - {R}_{0} - a}{{z}_{0} + b sin {ϕ}_{0}} ) z + ( {R}_{0} + a ) \qquad ( 45 )$$

By substituting this into the ellipse equation 41, we can find the coordinate (z_{W′}, r_{W′}) of the upper aperture.

### C.3.2. Lower Reflector

In similar manner, we can find the parameters that describe the lower reflector profile.

The distance from the ellipse origin to its foci:

$${l}^{′} = \frac{1}{2} \sqrt{{( {z}_{0} - b sin {ϕ}_{0} )}^{2} + {( {r}_{0} + b cos {ϕ}_{0} - {R}_{0} - a )}^{2}} \qquad ( 46 )$$

The center (h′,k′) of the ellipse is given by:

$$\begin{matrix}{h}^{′} = \frac{1}{2} ( {z}_{0} - b sin {ϕ}_{0} ) & ( 47 ) \\ {k}^{′} = \frac{1}{2} ( {r}_{0} + b cos {ϕ}_{0} + {R}_{0} + a ) & ( 48 )\end{matrix}$$

The tilt angle of the ellipse Φ′ is given by:

$${Φ}^{′} = {tan}^{- 1} ( \frac{{r}_{0} + b cos {ϕ}_{0} - {R}_{0} - a}{{z}_{0} - b sin {ϕ}_{0}} ) \qquad ( 49 )$$

The half length of the major axis c′ is given by:

$${c}^{′} = \frac{1}{2} \sqrt{{( {z}_{0} + b sin {ϕ}_{0} )}^{2} + {( {r}_{0} - b cos {ϕ}_{0} - {R}_{0} - a )}^{2}} + b \qquad ( 50 )$$

The half-length of the minor-axis d′ can again be computed from d′²=c′₂−l′².

The coordinate of the aperture W is computed by substituting the equation for line S″T to that of the ellipse:

$$r = ( \frac{{r}_{0} + b cos {ϕ}_{0} - {R}_{0} + a}{{z}_{0} - b sin {ϕ}_{0}} ) z + ( {R}_{0} - a ) \qquad ( 51 )$$

### C.4. Example Design 1

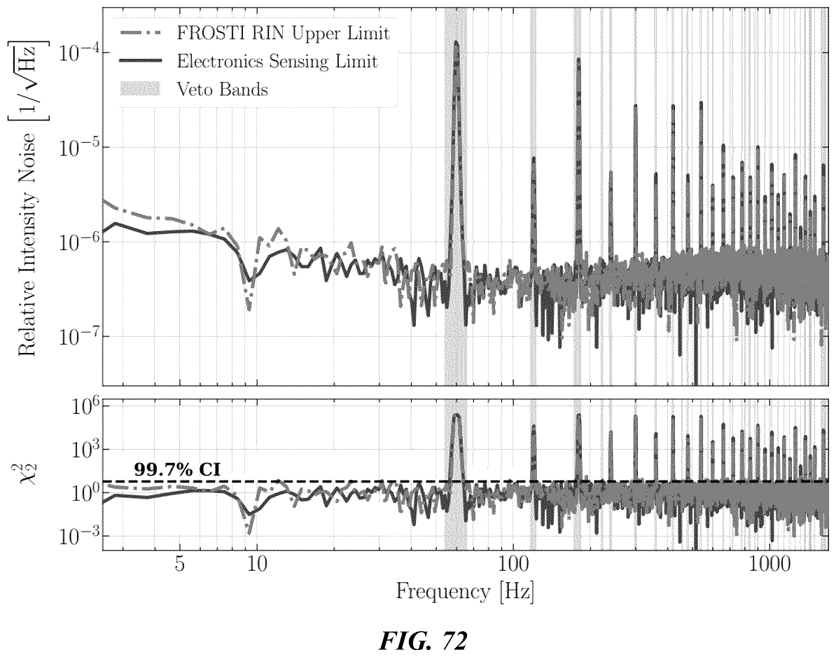

Using the procedure described above, parameters for a FROSTI prototype are listed in Table 3. The “Target” and “Source” parameters are treated as the independent parameters in this problem which, once specified, fully determine the parameters of the upper and lower elliptical reflectors. The “Target” parameters, specifying the target heating region of the test mass surface, are obtained from external FEA simulations of the thermal distortions of the test mass under high incident laser power. The “Source” parameters, specifying the geometry of the heater elements, are then chosen to satisfy practical constraints such as minimum element size and power delivery requirements. Together, the parameters in Table 3 fully define a two-dimensional azimuthal cross-section of the FROSTI optical surfaces, as illustrated in FIG. 72. This azimuthal cross-section is then revolved by 360° about the -axis. This yield the prototype geometry.

TABLE 3
Parameters defining the optical surfaces of FROSTI prototype

| | Parameter | Symbol | Value | Unit |
|---|---|---|---|---|
| Target | Half-width | a | 10 | mm |
| | Center r -coordinate | R₀ | 115 | mm |
| Source | Half-width | b | 1 | mm |
| | Center z -coordinate | z₀ | 90 | mm |
| | Center r -coordinate | r₀ | 200 | mm |
| | Tilt angle | φ₀ | 60 | deg |
| Upper Reflector | Center z -coordinate | h | 45.43 | mm |
| | Center r -coordinate | k | 152.25 | mm |
| | Tilt angle | Φ | 46.12 | deg |
| | Semi-major axis length | c | 66.32 | mm |
| | Semi-minor axis length | d | 10.06 | mm |
| | Aperture z -coordinate | z_{W′} | 48.81 | mm |
| | Aperture r -coordinate | r_{W′} | 169.90 | mm |
| Lower Reflector | Center z -coordinate | h′ | 44.57 | mm |
| | Center r -coordinate | k′ | 162.75 | mm |
| | Tilt angle | Φ′ | 40.27 | deg |
| | Semi-major axis length | c′ | 59.75 | mm |
| | Semi-minor axis length | d′ | 12.61 | mm |
| | Aperture z -coordinate | z_{W} | 70.75 | mm |
| | Aperture r -coordinate | r_{W} | 169.90 | mm |

### D.1 Experimental Results

The FROSTI prototype testing procedures are designed to confirm the following:
1. Measured surface temperature and wavefront actuation profiles on a real LIGO ETM consistent with the design targets as described previously.
2. Noise spectra that meet the stringent requirements for the LIGO A+ and A^{#} upgrades.
3. Ultra high vacuum (UHV) environment compatibility.

To accomplish the above, the FROSTI prototype has undergone two phases of testing: in-vacuum tests confirming the optical performance and UHV compatibility, followed by an in-air test measuring the relative intensity noise (RIN) of the device.

### D.1.1 Optical Performance

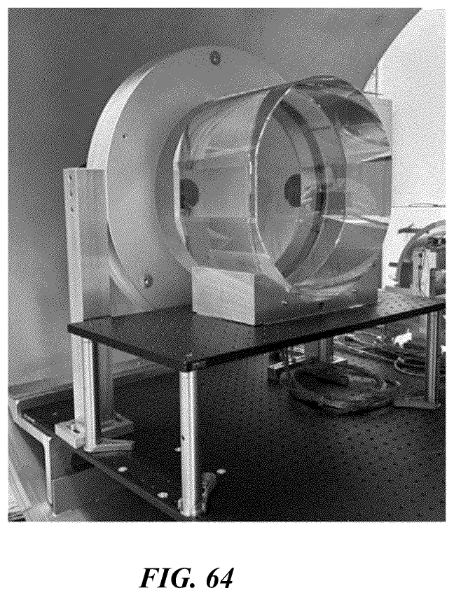

The configuration used to measure the surface temperature and wavefront actuation profiles on an ETM is shown in FIG. 42B. The FROSTI prototype is placed 5 cm in front of the highly-reflective (HR) surface of the ETM, as pictured in FIG. 64. The entire HR surface is viewed face-on through a zinc selenide viewport by a FLIR A70 thermal imaging camera. From the opposite side, a 520 nm laser probe beam, injected through another viewport, propagates through the ETM substrate and reflects from the HR surface. A Hartmann wavefront sensor measures the thermoelastic and thermorefractive effects imprinted on the probe beam as the ETM is heated. When heated from room temperature, we found that the ETM takes roughly 10 hours to reach thermal steady-state behavior, consistent with FEA modeling, and reaches an average temperature (in vacuum) of 318 K.

### D.1.1.1 Surface Temperature Variation

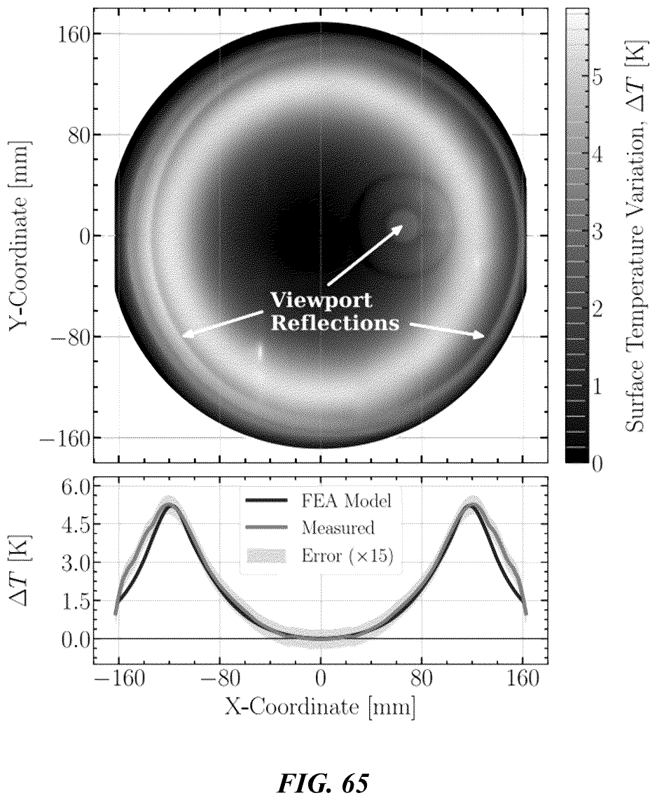

After balancing the power radiated by the eight individual heater elements and allowing the ETM to reach a thermal steady state, the surface temperature profile of the ETM was measured over the course of 105 minutes using the FLIR camera. Measurements were recorded at one-minute intervals, giving 106 samples of the surface temperature in total. These samples are averaged to obtain the surface temperature map shown in FIG. 65 (top), whose values are expressed as temperature differences relative to the center of the optic. The corresponding radial average of this temperature map is shown in FIG. 65 (bottom).

Several aberrations visible in the surface temperature map are known measurement artifacts, as annotated in FIG. 65 (top). These artifacts arise from reflections between the ETM's HR surface and the zinc selenide viewport used by the thermal imaging camera (see FIG. 42B), which directly faces the ETM and lacks an anti-reflection coating. Although the reflectivity of the LIGO HR coating has not been measured at wavelengths beyond 1064 nm, we are able to constrain its effective broadband infrared reflectivity, at a 45° angle of incidence, to be approximately 0.15 by matching the surface temperature and wavefront sensor measurements to a joint FEA model of both effects.

The FEA model assumes an irradiance profile proportional to the design profile described in Table 3 and previously, which is incident on a 40 kg ETM in vacuum. Some fraction of the incident power is reflected by the HR coating, while the remainder transmits through the coating and is absorbed in the surface layer of the fused silica substrate. The material properties of the low-OH fused silica used for LIGO's test masses, Heraeus Suprasil 3001, are listed in Table 1. The ETM is assumed to initially be at 298 K, the measured temperature of its enclosing vacuum environment. The steady-state heat transfer solution is computed, for the applied FROSTI heat flux, to obtain the resulting surface temperature and wavefront actuation maps. We find that the best-fit model most closely reproducing the FLIR and wavefront sensor measurements corresponds to 12.0 W of incident power, of which 10.2 W is absorbed. This results in a peak temperature difference of 5.21 K between the ETM's center and outer radii, which is in close agreement with the measured value of 5.26±0.03 K.

### D.1.1.2 Wavefront Actuation

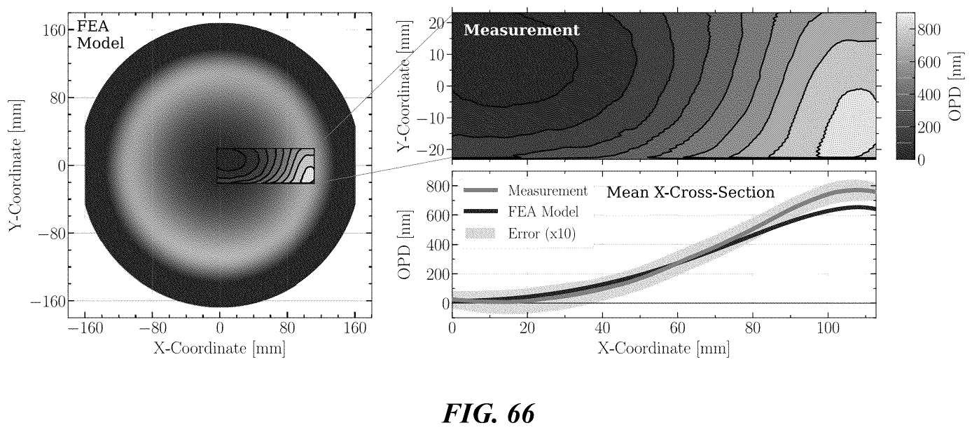

In addition to the full-surface temperature measurement, the wavefront actuation produced by the applied FROSTI heating pattern is directly measured, across a smaller region of the ETM, using a Hartmann wavefront sensor (see FIG. 42B). The measured optical path difference (OPD) is obtained by translating the 520 nm probe beam along a horizontal section of the ETM's HR surface, bounded to the left by the center of the mirror and extending rightwards to a maximum radial distance of 113 mm. The translated samples are then combined to reconstruct the total induced OPD across the measurement region, as shown in the top right panel of FIG. 66. The one-dimensional average of the measured OPD across this region is shown in the lower panel, which we find is in reasonable agreement with the best-fit FEA model described in the previous section. As shown in the bottom right panel of FIG. 66, both curves attain their maximum value at the location of the applied FROSTI irradiance, with a measured peak OPD of 771±7 nm compared to a modeled peak OPD of 654 nm. This measurement directly demonstrates the FROSTI's capability to mitigate residual wavefront distortions at the outer radii of the LIGO test masses. As the maximum rated power was supplied to each heater element during this measurement, it represents the upper limit of this prototype's actuation capability. There is no effective lower limit to its actuation range.

### D.1.2 Noise Performance

There are several pathways through which FROSTI actuators can inject noise into the interferometer. The two primary sources of noise are intensity noise, originating from power fluctuations of the applied heating profile, and backscattered light noise, due to scattered 1064 nm laser light reflecting from the FROSTI back into the main beam path. The sum of all equivalent displacement noises due to FROSTI actuators must be at least a factor of ten smaller than the design sensitivity of the LIGO A+ detectors (in units of amplitude spectral density) at all frequencies.

### D.1.2.1 Relative Intensity Noise

Relative intensity noise (RIN), due to power fluctuations of the FROSTI heating profile, produces displacement noise in the interferometer through optomechanical and photothermal couplings. Optomechanically, fluctuations in the intensity of the projected heating profile result in fluctuations in radiation pressure, which cause the test mass to recoil. The radiation pressure noise contribution from each test mass is

$$\begin{matrix}Δ {z}_{R P} ( f ) = \frac{P}{{cM ( 2 π f )}^{2}} Ξ ( f ) , \\ = ( 2.11 \times 1 {0}^{- 12} m ) {( \frac{1 Hz}{f} )}^{2} \frac{P}{1 W} Ξ ( f ) ,\end{matrix} \qquad ( 52 )$$

where M=40 kg is the mass of the test mass, P is the average power applied by the FROSTI, and Ξ(f) is the relative amplitude noise spectral density of its intensity (in units of 1/\sqrt{Hz}).

Photothermally, for an annular irradiance profile like that produced by the FROSTI, the dominant noise coupling is flexure, or “bending,” noise of the test mass. Flexure noise arises from thermoelastically-driven motion of the test mass' front surface relative to its center of gravity. The flexure noise is estimated using an FEA model of a test mass in which the FROSTI heating profile is applied with a harmonic perturbation. The flexure noise contribution from each test mass can be expressed as

$$Δ {z}_{F} ( f ) = ( 5.21 \times 1 {0}^{- 13} m ) \frac{1 Hz}{f} \frac{P}{1 W} Ξ ( f ) . \qquad ( 53 )$$

Equations (52) and (53) show that, while radiation pressure noise is dominant at the lowest frequencies (below 4 Hz), it quickly falls below the photothermal flexure noise with increasing frequency due to its 1/f² scaling. The total displacement noise contributions from the four test masses are assumed to be uncorrelated and thus add in quadrature in determining the strain sensitivity.

The FROSTI prototype's RIN is experimentally constrained using two infrared-sensitive ThorLabs PDAVJ5 photodetectors, positioned in front of the FROSTI reflector to maximize power incident on the sensors from a single heater element. Each photodetector signal is passed through a 2 kHz analog low-pass filter and sampled at 7.63 kHz by a Red Pitaya STEMlab 125-14 analog-to-digital converter (ADC). A modified periodogram method is employed to compute the power spectral densities (PSDs) of the individual photodetector signals as well as their cross-spectral density (CSD), averaged over 39 hours of steady-state observing time. Since the electronic noises of the two photodetectors are largely uncorrelated, the time-averaged CSD can resolve small correlated noise backgrounds to levels far below the noise floor of either photodetector individually. The CSD calculation procedure is described in further detail below.

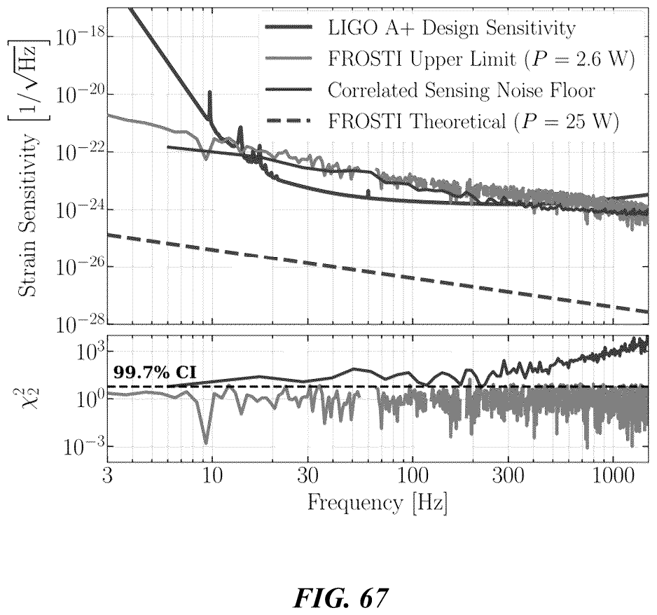

FIG. 67 shows the experimental limit placed by the CSD measurement on the RIN of the FROSTI prototype, projected into units of strain sensitivity. This measurement was performed in air with 2.6 W of delivered power. The measurement excludes the presence of coherent intensity fluctuations in the emission of the heater elements, to the indicated level of sensitivity, at 99.7% confidence. The lower panel shows a reduced chi-squared statistic which quantifies the statistical significance of the curves in the upper panel. Its construction is detailed below. Values greater than 5.9 indicate a statistically significant detection of coherent noise at 99.7% confidence, while values less than 5.9 indicate an exclusion. Also shown, for reference, is the LIGO A+ sensitivity target, the correlated electronic noise floor of the two ADC channels, and the FROSTI's theoretical intensity noise for 25 W of delivered power, corresponding to the amount of power that early modeling suggests will be needed in LIGO A^{#}. The presence of broadband correlated ADC noise imposes a systematic limit on the sensitivity achievable with this measurement apparatus. In future work, we will extend this measurement limit to lower levels by reducing the correlated sensing noise floor, through upgrades to the data acquisition infrastructure.

### D.1.2.2 Scattered Light Noise

Mounting a FROSTI actuator in front of a test mass introduces additional surfaces from which laser light scattered by the test mass can scatter back into the main interferometer beam. Relative motion of the FROSTI, which is less seismically isolated than the suspended test mass, phase modulates the backscattered laser light. This phase noise couples directly to the apparent arm length, with an amplitude spectral density given by

$$Δ {z}_{P N} ( f ) = \sqrt{\frac{ò}{2}} ξ ( f ) , \qquad ( 54 )$$

where \dot{o} is the fraction of incident laser power that backscatters and recombines with the main beam and ξ(f) is the amplitude spectral density of the relative horizontal motion between the FROSTI and the test mass (in units of m/\sqrt{Hz}). The backscattered light also beats with the main laser field to produce fluctuations of the arm cavity power. These fluctuations coherently displace both test masses through radiation pressure, with an amplitude spectral density given by

$$Δ {z}_{R P} ( f ) = \frac{4 Γ {P}_{arm}}{πλ cM} \sqrt{2 {o}^{‵}} \frac{ξ ( f )}{{f}^{2}} , \qquad ( 55 )$$

where Pₐᵣₘ is the arm cavity power, M=40 kg is the mass of the LIGO A+test masses, λ=1064 nm is the laser wavelength, and Γ=14.3 is the optical gain of the signal recycling cavity.

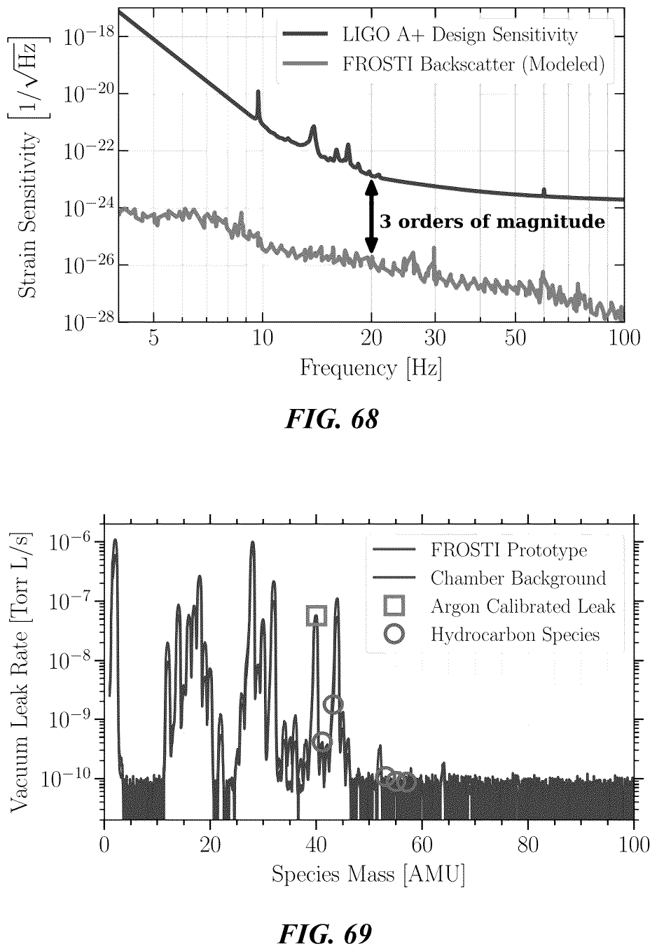

The fraction of incident laser power that backscatters from the FROSTI is estimated and it is found that ò=1.51×10⁻²³. This calculation is detailed below. We assume that the relative motion between the FROSTI and the test mass, ξ(f), is the horizontal seismic noise spectrum of LIGO's seismic-isolation platform (BSC-ISI ST2), multiplied by a safety factor of 10 to account for additional controls-driven test mass motion. Using the above displacement noise couplings [Eqs. (54) and (55)], the noise is projected into the differential arm length noise spectrum of the interferometer at nominal operating power (Pₐᵣₘ=750 kW), assuming that the backscatter noise contributions from each arm are uncorrelated and can be added in quadrature. Noise originating from scattered light traveling from the other test mass is not considered, as the FROSTI would be enclosed within an arm cavity baffle, shielding it from this stray light. FIG. 68 shows the total projected noise, in units of interferometer strain. We find that, at all frequencies, the scattered light noise lies three orders of magnitude below the target sensitivity of LIGO A+.

### D.1.3 UltraHigh Vacuum Compatability

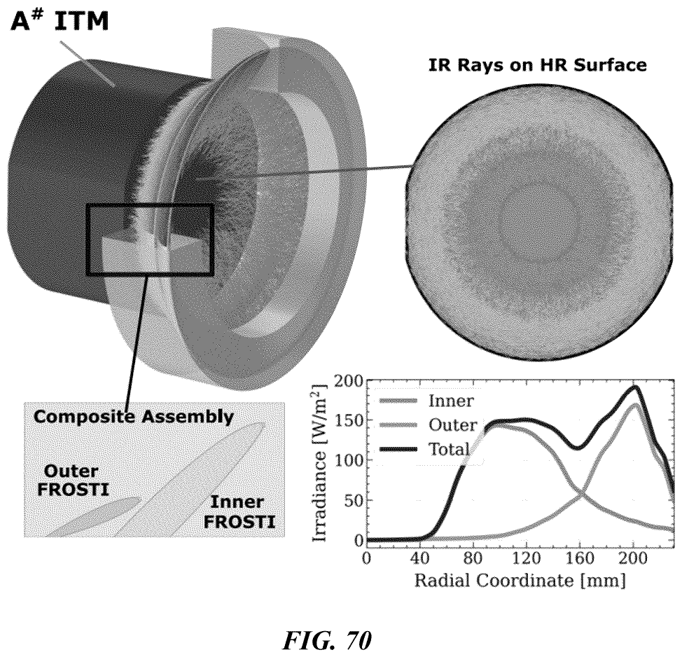

To ensure compatibility with LIGO's ultra-high vacuum (UHV) environment, the FROSTI actuator may be configured to meet stringent outgassing standards. Even trace amounts of hydrocarbons can severely damage the test masses under high laser power. Vacuum outgassing rate of the FROSTI prototype is measured, as a function of molecular species, using a residual gas analyzer (RGA) equipped with a calibrated argon leak. The argon leak releases gas into the system at a precisely known rate and can thus be used to calibrate the measured spectrum. The fully assembled prototype was installed in a large vacuum chamber and operated at maximum power (with its heater elements at roughly 625 K) for two weeks. FIG. 69 shows the final measured outgassing rate spectrum of the prototype, in comparison to a reference measurement of the empty chamber indicating the background sensitivity limit. The hydrocarbon signatures of AMUs 41, 43, 53, 55, and 57 are all consistent with LIGO's outgassing rate requirements.

### D.2 Discussion

The results demonstrate that the FROSTI prototype performs very closely to design expectations. In particular, the experimental measurements and analysis presented in Section D confirm all three of the key properties underlying the FROSTI concept:
1. The nonimaging design technique is an effective means of achieving wavefront actuation at higher spatial frequencies (20-50 m⁻¹) in gravitational-wave detectors.
2. The internal graybody radiation source is capable of achieving high intensity stability, while the reflector surfaces are expected to produce negligible backscattered light noise.
3. It is possible to fabricate FROSTI actuators from entirely ultra-high-vacuum-compatible materials, which is critical for their compatibility with gravitational-wave detectors.

### D.3 Other Design Embodiments

Applications may be expected to achieve the extreme power and squeezing targets of LIGO and Cosmic Explorer. In some embodiments, the irradiance profile shown in FIG. 70, applied to the front surface of the ITM, could provide a sufficiently accurate correction to enable the power and squeezing targets. This heating pattern could be produced by nesting multiple heater rings inside one composite assembly, as illustrated in FIG. 70 (left), with each heater ring enclosed by a separate nonimaging reflector that projects radiation onto a different radial zone of the test mass surface. This may enable the development of FROSTI actuators delivering more complex irradiance profiles, and hence more precisely targeted wavefront corrections.

Some embodiments may reduce Brownial thermal noise on mirror surfaces through improved optical coatings. Some embodiments may include larger 100-kg test masses, new improved suspensions, and a significantly higher laser power of 1.5 MW in the 4-km interferometer arms.

In order to improve strain sensitivity, embodiments may reduce the quantum noise floor which arises from the quantization of the electromagnetic field used to interrogate their positions. Ground-state fluctuations of the electromagnetic vacuum field enter the interferometer and beat with the circulating laser field. At low frequencies (below 20 Hz), amplitude-quadrature fluctuations of the optical field are the most significant, which physically displace the test masses through radiation pressure. At higher frequencies, phase-quadrature fluctuations, manifesting as “shot” noise in the interferometer's readout, account for most of the quantum noise. Quantum noise may be reduced by higher circulating laser power in the interferometer and the injection of frequency-dependent “squeezed” quantum vacuum states.

### E.1 Introduction to Relative Intensity Noise

This section details our measurement procedure for the relative intensity noise (RIN) spectrum of the FROSTI prototype

### E.1.1 Spectral Density Estimation

Two broadband photodetectors sense the emission of a single FROSTI heater element, whose signals are anti-alias filtered and read out by an analog-to-digital converter (ADC) at 7.63 kHz. Welch's modified periodogram method is used to estimate the power spectral densities (PSDs) of the photodetector signals and their cross-spectral density (CSD). The sampled time series are divided into segments of length 8192, windowed using a Hann function, and transformed to the frequency domain via the discrete Fourier transform (DFT). The chosen DFT size provides a frequency bin width of 0.93 Hz. The time series segments are overlapped by 50% to optimally preserve data de-weighted by the Hann window near its edges.

For each segment, the Fourier-transformed time series, \tilde{S}₁(f) and \tilde{S}₂(f), are combined as

$$[ \begin{matrix}{\tilde{S}}_{1}^{*} {\tilde{S}}_{1} & {\tilde{S}}_{1}^{*} {\tilde{S}}_{2} \\ {\tilde{S}}_{2}^{*} {\tilde{S}}_{1} & {\tilde{S}}_{2}^{*} {\tilde{S}}_{2}\end{matrix} ] \qquad ( 56 )$$

to construct the spectral density tensor. The diagonal elements represent the PSDs of the two signals, and the off-diagonal elements represent their CSD (the two elements differ only by a phase conjugation). The resulting spectral densities from each time series segment are then averaged over 39 hours of continuous steady-state observing time.

### E.1.2 Measurement Post-Processing

The final averaged CSD,

$$〈 {\tilde{S}}_{1}^{*} {\tilde{S}}_{2} 〉$$

in units of input-referred V²/Hz, is normalized to units of relative fluctuation power by dividing it by the average DC voltages of the two photodetectors, V₁=276 mV and V₂=215 mV. Taking the square root of the normalized CSD magnitude then yields the RIN amplitude spectral density,

$$Ξ ( f ) = \sqrt{\frac{\vert 〈 {\tilde{S}}_{1}^{*} {\tilde{S}}_{2} 〉 \vert}{{V}_{1} {V}_{2}}} \qquad ( 57 )$$

in units of 1/\sqrt{Hz}. This normalization can be performed directly in units of sensor voltage (rather than first converting to units of incident power) because the gain of the photodetectors, whose response band spans DC to 1 MHz, is frequency-independent at frequencies far below 1 MHz.

The CSD of two incoherent Gaussian noise processes is distributed as a bivariate Gaussian distribution whose variance

$$Var [ {\tilde{S}}_{1}^{*} {\tilde{S}}_{2} ] = \frac{〈 {\tilde{S}}_{1}^{*} {\tilde{S}}_{1} 〉 〈 {\tilde{S}}_{2}^{*} {\tilde{S}}_{2} 〉}{0.9 \; 47 N} \qquad ( 58 )$$

is equally split between the real and imaginary quadratures of the CSD. In the denominator, N=263,024 is the total number of measurements (spectral density tensors) averaged together and 0.947 is a window-specific correction factor, here corresponding to a Hann window used with 50% overlap of consecutive time series segments.

From the Gaussian nature of the CSD, it follows that the test statistic

$${χ}^{2} = \frac{2 {\vert 〈 {\tilde{S}}_{1}^{*} {\tilde{S}}_{2} 〉 \vert}^{2}}{Var [ {\tilde{S}}_{1}^{*} {\tilde{S}}_{2} ]} \qquad ( 59 )$$

is distributed as a chi-squared distribution with two degrees of freedom. Dividing Eq. 59 by a factor of 2 yields the reduced chi-squared statistic,

$${χ}_{2}^{2} ,$$

which is used to assess the statistical significance of measured CSD values.

### E.1.3 Frequency Bin Vetoes

FIG. 72 show the relative intensity noise limits of a reflector and dark noise background. The frequency bands surrounding 60 Hz harmonics are contaminated with strongly correlated electrical noise from the sensing-chain electronics. In FIG. 72, these peaks are clearly visible in both the measured FROSTI RIN spectrum and the measured dark noise (FROSTI-off) spectrum, which is sensitive only to electronics noise. These features are thus artifacts which can be excluded without biasing the RIN measurement.

Accordingly, frequency bin vetoes predicated on the dark noise (FROSTI-noise-insensitive) measurement. We choose a confidence interval of 99.7%, corresponding to a critical

$${χ}_{2}^{2}$$

value of 5.9, and reject frequency bins whose

$${χ}_{2}^{2}$$

value for dark noise background exceeds this threshold. The two neighboring bins on each side of a vetoed bin are additionally rejected due to spectral leakage from the DFT calculation. The bins rejected from the final data set are shaded in gray. They are removed from the final result (FIG. 67) shown in the main text.

### E.2 Backscattered Light

This section estimates the fraction of incident laser power, \dot{o}, which scatters from the test mass surface, to the FROSTI, and back into the main interferometer beam. This calculation is dependent on the specific geometry of the interior and exterior FROSTI surfaces, which can be assumed to be the geometry described in Table 3.

The rate that energy scatters back into the main beam, due to the presence of the FROSTI's reflector surfaces, is

$${P}_{scatter} = {P}_{arm} \frac{{λ}^{2}}{{r}^{2}} \int {( \frac{d p}{d {Ω}_{m s}} )}^{2} \frac{d p}{d {Ω}_{b s}} d Ω \qquad ( 60 )$$

where Pₐᵣₘ is the incident arm cavity power, λ=1064 nm is the laser wavelength, and r=0.180 m is the mean distance from the center of the test mass to the FROSTI's reflector aperture. The first term inside the integrand, dp/dΩₘₛ, represents the mirror's probability to scatter main-beam photons into a unit solid angle in the direction of Ωₘₛ. The second term, dp/dΩ_{bs}, represents the probability for photons arriving at the FROSTI's reflector aperture to be backscattered into a unit solid angle in the direction of the mirror.

The mirror-scattering probability is given by the bidirectional reflectance distribution function (BRDF) of the test mass surface, which can be approximated to be Lambertian as

$$\frac{d p}{d {Ω}_{m s}} = \frac{α cos θ}{π} \qquad ( 62 )$$

where α is estimated to be 10 ppm. The backscattering probability may be calculated from the FROSTI reflector aperture to the test mass surface numerically using a ray-tracing simulation of the full instrument, finding that dp/dΩ_{bs}=0.57.

Integrating Eq. 60 axisymmetrically over the range of angles subtended by the aperture of the FROSTI reflector, (67°-73°, relative to the main beam axis) then shows that the total amount of backscattered power which reenters the main beam is

$${P}_{scatter} = ( 1.51 \times 1 {0}^{- 23} ) {P}_{arm} \qquad ( 63 )$$

The fractional backscattering is thus ò=P_{scatter}/Pₐᵣₘ=1.51×10⁻²³. We analogously estimate the backscatter contributions from the FROSTI's nonreflective exterior surfaces, as well. However, they are found to be negligible in comparison to the backscatter from the reflector itself.

Various technical solutions adopted by preferred embodiments include the following.

1. An apparatus (e.g., apparatus 200 depicted in FIG. 2), comprising: a frame structure (202) forming a circumference around an opening (204), a receptacle (206) along the circumference, wherein the receptacle is configured to allow a secure placement of an optical element (208) such that electromagnetic waves traveling from the opening impinge upon the optical element; N heating elements (210) attached to the frame structure substantially along entirety of the circumference, where N is a positive integer; and a radiation reflector (212) disposed along the circumference of the frame.

2. The apparatus of solution 1, wherein the N heating elements and the radiation reflector are configured to radiate infrared heat towards the opening such that the optical element receives heat according to a heat intensity profile. In this document, various examples of heat intensity profiles are described. In general, one of the objectives of a heat intensity profile is to minimize a surface distortion of the lens/mirror.

3. The apparatus of any of above solutions wherein the radiation reflector comprises one or more elliptical cavities along the circumference. In particular, different structures that allow for different cavity shapes are disclosed with respect to FIGS. 5, 7, 11, 12, where examples of asymmetric elliptical cavity are shown and described.

4. The apparatus of any of above solutions wherein the frame structure corresponds to a circular ring.

5. The apparatus of any of above solutions, wherein the frame structure is substantially planar defined by a front surface and a back surface separated by a thickness, wherein the thickness is sufficient to hold the receptacle, the N heating elements and the radiation reflector. Various examples are depicted and described with respect to FIGS. 1 to 20.

6. The apparatus of any of above solutions, wherein the radiation reflector comprises a gold surface coating. In different embodiments, another element or compound with low gassing rate (e.g., in comparison with that of gold) may be used.

7. The apparatus of any of above solutions, wherein N is greater than 1, such as N=4 or 8, and wherein each heating element is coupled to a heat source.

8. The apparatus of solution 7, wherein the heat source is configured to provide equal heat energy to each heat element such that the heat intensity profile is omnidirectionally uniform. Although other heat intensity profiles that are circularly non-uniform may also be used. For example, a non-uniform heat intensity profile may be used to compensate for material defects in the optical/mirror material using to achieve least optical distortion for the laser passing through the ring cavity.

9. The apparatus of solution 3, wherein the one or more cavities include concentrically nested cavities. Here, the concentrically nested cavities may provide opportunity to use more than one ring heaters that may allow a finer control on certain radial sections of the opening of the ring heater, or may allow a balanced load distribution on the heat power source. This configuration may also provide mitigation of fault if power supplied by one power source fluctuates, by allowing another power source to compensate the heating profile. Nested cavities may comprises, for example, cavities that form concentric annular cavities, with an inner cavity having a smaller radius fitting within another cavity having a greater radius and surrounding the inner cavity. In some cases, the nested cavities may have equal radii, and may be placed stacked against each other in a direction of travel of the laser (or direction perpendicular to the opening of the ring heater). Such nested cavities may be used to provide a uniform heating profile along the third dimension of thickness of the optical material.

10. The method of any of solutions 3 to 9, wherein the one or more elliptical cavities comprise asymmetric compound elliptical reflecting cavities. Some embodiments are disclosed with reference to FIGS. 1 to 20 and performance and measurement results are described with reference to FIGS. 21 to 62.

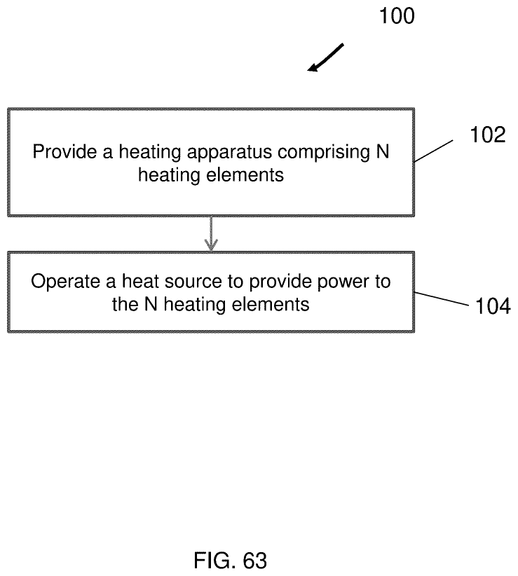

11. A method of reducing thermal distortion of an optical element (e.g., method 100 depicted in FIG. 63), comprising: providing (102) a heating apparatus comprising: a frame structure forming a circumference around an opening, wherein a receptacle along the circumference, wherein the receptacle is configured to allow a secure placement of the optical element such that electromagnetic waves traveling from the opening impinge upon the optical element; N heating elements attached to the frame structure substantially along entirety of the circumference, where N is a positive integer; and a radiation reflector disposed along the circumference of the frame; and operating (104) a heat source to supply heating energy to the N heating elements.

12. The method of solution 11, including positioning the N heating elements and the radiation reflector to radiate infrared heat towards the opening such that the optical element receives heat according to a heat intensity profile.

13. The method of any of above solutions, further including providing the radiation reflector with one or more elliptical cavities along the circumference such that at least some of the N heating elements are positioned at focal points of the one or more cavities.

14. The method of any of above solutions wherein the frame structure corresponds to a circular ring.

15. The method of any of above solutions, wherein the frame structure is substantially planar defined by a front surface and a back surface separated by a thickness, wherein the thickness is sufficient to hold the receptacle, the N heating elements and the radiation reflector.

16. The method of any of above solutions, further including: providing a gold surface coating to the radiation reflector.

17. The method of any of above solutions, wherein Nis greater than 1, and wherein each heating element is coupled to the heat source.

18. The method of solution 17, wherein the operating the heat source comprises operating the heat source to provide equal heat energy to each heat element such that the heat intensity profile is omnidirectionally uniform.

19. The method of solution 13, wherein the one or more cavities include concentrically nested cavities.

20. The method of any of solutions 13 to 19, wherein the one or more elliptical cavities comprise asymmetric compound elliptical reflecting cavities.

21. The apparatus or method of any of the above solutions, wherein the optical element is a mirror, a reflector, a lens or a splitter.

It will be appreciated by one of skill in the art that the present document discloses reflector corrective heating techniques. The disclosed techniques (1) operate with extremely low noise (high intensity stability of the heating pattern) and (2) operate in an ultra high vacuum (UHV) environment, making them suitable for existing and new applications related to meteorological, industrial and astronomical interferometry and image capture applications.

It will further be appreciated that the disclosed techniques can be used in optical systems in which a loss in quality or fidelity of optical systems may be experienced due to various operational situations such as non-uniform thermal heating of optical material upon which light being observed impinges. Such an optical loss may be compensated or mitigated using the disclosed techniques in which a versatile ring heater design is provided to allow heating the optical element according to an desired thermal profile to control an amount of surface distortion and optical loss through the system.

While this specification contains many specifics, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

The described systems, apparatus and techniques can be implemented in electronic circuitry, computer hardware, firmware, software, or in combinations of them, such as the structural means disclosed in this specification and structural equivalents thereof. This can include at least one computer-readable storage medium embodying a program operable to cause one or more data processing apparatus (e.g., a signal processing device including a programmable processor) to perform operations described. Thus, program implementations can be realized from a disclosed method, system, or apparatus, and apparatus implementations can be realized from a disclosed system, computer-readable medium, or method. Similarly, method implementations can be realized from a disclosed system, computer-readable medium, or apparatus, and system implementations can be realized from a disclosed method, computer-readable medium, or apparatus.

Only a few implementations are disclosed. However, variations and enhancements of the disclosed implementations and other implementations can be made based on what is described and illustrated in this specification.

We claim:

1. An apparatus, comprising:
a frame structure forming a circumference around an opening,
a receptacle along the circumference, wherein the receptacle is configured to allow a secure placement of an optical element such that electromagnetic waves traveling from the opening impinge upon the optical element;
N heating elements attached to the frame structure substantially along entirety of the circumference, where N is a positive integer; and
a radiation reflector disposed along the circumference of the frame.

2. The apparatus of claim 1, wherein the N heating elements and the radiation reflector are configured to radiate infrared heat towards the opening such that the optical element receives heat according to a heat intensity profile.

3. The apparatus of claim 1, wherein the radiation reflector comprises one or more elliptical cavities along the circumference.

4. The apparatus of claim 3, wherein the frame structure corresponds to a circular ring.

5. The apparatus of claim 4, wherein the frame structure is substantially planar defined by a front surface and a back surface separated by a thickness, wherein the thickness is sufficient to hold the receptacle, the N heating elements and the radiation reflector.

6. The apparatus of claim 1, wherein the radiation reflector comprises a gold surface coating.

7. The apparatus of claim 2, wherein N is greater than 1, and wherein each heating element is coupled to a heat source.

8. The apparatus of claim 7, wherein the heat source is configured to provide equal heat energy to each heat element such that the heat intensity profile is omnidirectionally uniform.

9. The apparatus of claim 3, wherein the one or more cavities include concentrically nested cavities.

10. The apparatus of claim 3, wherein the one or more elliptical cavities comprise asymmetric compound elliptical reflecting cavities.

11. A method of reducing thermal distortion of an optical element, comprising:
providing a heating apparatus comprising:
a frame structure forming a circumference around an opening, wherein
a receptacle along the circumference, wherein the receptacle is configured to allow a secure placement of the optical element such that electromagnetic waves traveling from the opening impinge upon the optical element;
N heating elements attached to the frame structure substantially along entirety of the circumference, where N is a positive integer; and
a radiation reflector disposed along the circumference of the frame; and
operating a heat source to supply heating energy to the N heating elements.

12. The method of claim 11, including positioning the N heating elements and the radiation reflector to radiate infrared heat towards the opening such that the optical element receives heat according to a heat intensity profile.

13. The method of claim 11, further including providing the radiation reflector with one or more elliptical cavities along the circumference such that at least some of the N heating elements are positioned at focal points of the one or more cavities.

14. The method of claim 11, wherein the frame structure corresponds to a circular ring.

15. The method of claim 11, wherein the frame structure is substantially planar defined by a front surface and a back surface separated by a thickness, wherein the thickness is sufficient to hold the receptacle, the N heating elements and the radiation reflector.

16. The method of claim 11, further including:
providing a gold surface coating to the radiation reflector.

17. The method of claim 12, wherein N is greater than 1, and wherein each heating element is coupled to the heat source.

18. The method of claim 17, wherein the operating the heat source comprises operating the heat source to provide equal heat energy to each heat element such that the heat intensity profile is omnidirectionally uniform.

19. The method of claim 13, wherein the one or more cavities include concentrically nested cavities.

20. The method of claim 13, wherein the one or more elliptical cavities comprise asymmetric compound elliptical reflecting cavities.
